(19) United States
(12) Patent Application Publication
(10) Pub. No.: US 2026/0117843 A1
(43) Pub. Date: Apr. 30, 2026

(54) CONVEYOR BELT FASTENER APPLICATOR

(71) Applicant: Flexible Steel Lacing Company, Downers Grove, IL (US)

(72) Inventors: Mark Steven Pettinga, Grandville, MI (US); Parker Lee Jensen, Holland, MI (US); Seth Wayne Adams, Rockford, MI (US); Joseph Kent Dickson, Walker, MI (US); Joshua James Burns, Sparta, MI (US); Erin Ashley VanderZouwen, Nunica, MI (US)

(21) Appl. No.: 19/375,674

(22) Filed: Oct. 31, 2025

Related U.S. Application Data
(60) Provisional application No. 63/714,859, filed on Oct. 31, 2024.

(51) Int. Cl. F16G 3/00; B27F 7/19

(52) U.S. Cl. CPC F16G 3/003; B27F 7/19

(57) ABSTRACT

A conveyor belt fastener applicator including a fastener nest to receive a fastener, a head operable to drive legs of a staple of the fastener, and a rotatable anvil including an initial bend portion and a final bend portion. The rotatable anvil has a first rotary position wherein the initial bend portion of the anvil is positioned below the fastener, the initial bend portion of the anvil configured to partially bend the staple legs as the staple legs are driven downwardly from apertures of a fastener lower plate by the head. The anvil is rotatable relative to the fastener nest from the first rotary position to a second rotary position. The head is configured to be operable to drive the staple legs and press the partially bent staple legs against the final bend portion of the anvil to secure the staple legs to the lower plate of the fastener.

### CROSS REFERENCE TO RELATED APPLICATION

This application claims the benefit of U.S. Provisional Patent App. No. 63/714,859, filed Oct. 31, 2024, which is hereby incorporated by reference in its entirety.

### TECHNICAL FIELD

This disclosure relates generally to tools for installing conveyor belt fasteners and, more specifically, relates to tools for securing fasteners to ends of conveyor belts for splicing the conveyor belt ends together.

### BACKGROUND

Mechanical splices are often used to join ends of a conveyor belt during installation or repair of the conveyor belt. One type of mechanical splice utilizes hinged plate belt fasteners and include a first set of fasteners that are secured to one end of the conveyor belt, a second set of fasteners that are secured to another end of the conveyor belt, and a hinge pin that is inserted through interlaced loops of the fasteners of the first and second sets of fasteners to form a hinge connection between the conveyor belt ends. The hinge connection permits the splice to pivot about the hinge pin as the splice travels around pulleys during operation of the conveyor belt.

Conveyor belt fasteners can also have different types of attachment members. For example, in one type of hinged plate belt fastener having a metallic body with an upper plate, a lower plate, and one or more loops connecting the plates, one or more preset staples are used as the attachment members with the staples having their legs press fit in apertures of either the upper or lower plate. To secure the staple hinged plate belt fastener (hereinafter “staple belt fastener”) to a conveyor belt end, a user loads the staple belt fastener into a fastener applicator, positions the conveyor belt end between the upper and lower plates of the staple belt fastener, and operates a fastener applicator tool to clench or close the upper and lower plates of the fastener body onto the conveyor belt end. Next, the fastener applicator tool is operable to drive the staple legs through apertures of the plate into which they are preset, the material of the conveyor belt end, into and through the apertures of the other plate, and bends the legs over to secure the fastener to the conveyor belt end.

Securing staple belt fasteners to a conveyor belt end is often a time consuming and difficult process as some fastener applicator tools can only simultaneously apply a limited number of staple belt fasteners to a conveyor belt end, such as two, when dozens of staple belt fasteners may be required for each conveyor belt end. Further, the operations of clenching staple belt fasteners onto a conveyor belt end, driving the staple legs, and bending the staple legs to secure the staple belt fasteners to the conveyor belt end involves a high level of precision to avoid improperly applied fasteners that require removal and replacement by a user.

### SUMMARY

In one aspect of the present disclosure, an applicator is provided for securing fasteners to a conveyor belt. The applicator includes a fastener nest to receive a fastener and a conveyor belt disposed between upper and lower plates of the fastener. The applicator has a head configured to be operable to move the fastener upper plate toward the conveyor belt and drive legs of a staple of the fastener downwardly through apertures of the fastener upper plate, through the conveyor belt, through apertures of the fastener lower plate, and downwardly from the apertures of the fastener lower plate. The applicator includes a rotatable anvil having an initial bend portion and a final bend portion. The rotatable anvil has a first rotary position wherein the initial bend portion of the anvil is positioned below the lower plate of the fastener. The initial bend portion of the anvil is configured to partially bend the staple legs as the staple legs are driven downwardly from the apertures of the fastener lower plate by the head.

The anvil is rotatable relative to the fastener nest from the first rotary position to a second rotary position wherein the final bend portion of the anvil is positioned below the partially bent staple legs. The fastener nest and anvil are configured to be movable relative to one another to permit the fastener nest and anvil to move apart and provide clearance for the anvil from the partially bent staple legs to permit the anvil to rotate from the first rotary position to the second rotary position. In one embodiment, the fastener nest moves away from the anvil while in other embodiments, the anvil moves away from the fastener nest or both the fastener nest and the anvil move to provide clearance for the anvil from the partially bent staple legs.

The fastener nest and anvil are configured to be movable relative to one another to permit the fastener nest and anvil to move together and position the partially bent staple legs of the fastener on the final bend portion of the anvil. Further, the head is configured to be operable to drive the staple legs and press the partially bent staple legs against the final bend portion of the anvil to secure the staple legs to the lower plate of the fastener. The applicator is therefore operable to clench a staple fastener onto a conveyor belt, perform a first stage of staple driving and initial bending of staple legs, and perform a second stage of final bending of the staple legs all using the same applicator. Further, the applicator has a rotatable anvil that is used for both the first stage and the second stage, with the applicator rotating the anvil to position either the anvil initial bend portion or the anvil final bend portion below the lower plate of the fastener. In this manner, the anvil rotates rather than moving fore-aft which enables the anvil to have a small footprint in the applicator. Additionally, the applicator can precisely perform two-stage staple bending which permits a tighter set of the staple because the first stage forms an initial bend radius of the staple legs and the second stage progressively bends the staple legs farther to a tight, final set against the lower plate of the fastener.

The present disclosure also provides a method of securing a fastener to a conveyor belt using an applicator. The method includes receiving the fastener in a fastener nest of the applicator and moving, via a head of the applicator, an upper plate of the fastener toward a conveyor belt disposed between the upper plate and a lower plate of the fastener. In one embodiment, the head of the applicator has a plunger that engages the upper plate of the fastener and moves the fastener upper plate downwardly against the conveyor belt.

The method includes driving, via the head of the applicator, legs of a staple of the fastener through apertures of the upper plate of the fastener, through the conveyor belt, through apertures of the lower plate, and against an initial bend portion of an anvil of the applicator positioned below the lower plate of the fastener to partially bend the legs. The method includes moving the fastener nest and anvil relative to one another to provide clearance between the anvil and the partially bent staple legs and rotating the anvil to position a final bend portion of the anvil below the bent staple legs. The method further includes moving the fastener nest and anvil relative to one another to position the partially bent staple legs on the final bend portion of the anvil and pressing, via the head of the applicator, the partially bent staple legs against the final bend portion of the anvil to secure the staple legs to the lower plate of the fastener. In this manner, the rotatable anvil permits different portions of the anvil to be used to perform initial and final bending of the staple legs in a precise manner within a compact area of the applicator.

In another aspect, the present disclosure provides a conveyor belt fastener applicator having a head and an anvil. The applicator includes an actuator configured to move the head and anvil relative to one another to secure a fastener to a conveyor belt. The fastener may be a staple fastener, rivet fastener, or other types of conveyor belt fasteners. The applicator includes a sensor to detect a position of the head and a controller operably connected to the actuator and the sensor. The controller is configured to lower the head toward the fastener, detect contact between the head and the fastener, and determine a size of the fastener based at least in part upon the position of the head when the head contacts the fastener. The controller is configured to set a height of the head that corresponds to the size of the fastener for a fastener securing operation. In this manner, the applicator is operable to autonomously adjust the height of the head to correspond to the fastener loaded into the applicator, which reduces the risk of operator error and improves splice quality.

### BRIEF DESCRIPTION OF DRAWINGS

FIG. 1A is a perspective view of a fastener applicator operable to secure an entire set of staple belt fasteners to a conveyor belt end in a single operation of the fastener applicator;

FIG. 1B is a flow chart of a method of operating the fastener applicator of FIG. 1A to secure conveyor belt fasteners to a conveyor belt end;

FIG. 2 is a perspective view of portions of a fastener nest and an anvil bed assembly of the fastener applicator of FIG. 1A, the anvil bed assembly having anvils that are rotatable to position either an initial staple leg bending portion or a final set portion of the anvils below fasteners held in the fastener nest;

FIG. 3 is a perspective view of the fastener nest of FIG. 2 showing a retainer member engaging an upper plate of a fastener received in the fastener nest;

FIG. 4 is a side elevational view of the fastener nest and anvil bed assembly of FIG. 2 showing the fastener nest raised to provide a spacing between a lower plate of the fastener and one of the anvils;

FIG. 5 is a perspective view of one of the rotatable anvils of FIG. 2 showing an upper head portion and a lower shaft portion of the anvil;

FIG. 6 is a top plan view of the head portion of the anvil of FIG. 5 showing grooves of the initial staple leg bending portion and a flat surface of the final set portion of the anvil;

FIGS. 7A-7D are side elevational views of the anvil of FIG. 5 showing a cam path of the lower shaft portion of the anvil that is engaged by an anvil drive member, the anvil drive member shifting vertically up-and-down and causing rotation of the anvil via camming engagement between the anvil drive member and the cam path during operation of the fastener applicator;

FIG. 7E is a perspective view of the anvil of FIG. 7A showing the anvil drive member moving along the cam path;

FIG. 8 is a side elevational view of the fastener nest of FIG. 2 showing a head of the fastener applicator shifting downwardly a first time and a plunger of the head clenching the upper plate of the fastener onto a conveyor belt;

FIG. 9 is a view similar to FIG. 8 showing the plunger contacting the fastener upper plate between staples of the fastener and holding the upper plate tightly against the conveyor belt;

FIG. 10 is a view similar to FIG. 8 showing a staple pusher of the head shifting downwardly to drive legs of the staples through the conveyor belt and into the grooves of the initial staple leg bend portion of the anvil to initially bend the staple legs;

FIG. 11 is a view similar to FIG. 2 showing the nest shifted upwardly to be in clearance with the anvils after the staples have been driven and initially bent;

FIG. 12 is a view similar to FIG. 11 showing the anvils rotated 90° from their position in FIG. 11;

FIG. 13 is a view similar to FIG. 11 showing the anvils rotated 180° from their position of FIG. 11 to position the flat surfaces of the final set portion of the anvils below the fasteners;

FIG. 14 is a view similar to FIG. 13 showing the fastener nest shifted downwardly to position the initially bent staple legs on the flat surfaces of the anvils;

FIG. 15 is a view similar to FIG. 10 showing the head shifted downwardly a second time to cause the plunger and staple pusher to urge the fastener upper plate and staple crowns toward the anvils and bend the staple legs tightly against the lower plates of the fasteners using the flat surfaces of the anvils;

FIG. 16 is a view similar to FIG. 11 showing the fastener nest shifted upwardly away from the anvils and the anvils having rotated 270° from the position of FIG. 11;

FIG. 17 is a plan view of one of the fasteners of FIG. 16 showing the staple leg portions of each staple bent side-by-side into pockets of a lower surface of the lower plate of the fastener body;

FIG. 18 is a perspective view of a portion of another embodiment of a fastener applicator;

FIG. 19 is a perspective, enlarged view of a fastener nest and an anvil bed assembly of the fastener applicator of FIG. 18;

FIG. 20 is a side elevational view of the fastener nest of FIG. 19 with a side plate removed to show a torsion spring that biases a retainer member of the fastener nest against an upper plate of a fastener;

FIG. 21 is a front elevational view of a head of the fastener applicator of FIG. 18 showing a staple pusher plate of a lower portion of the head and fastener flattening plungers protruding from openings of the staple pusher plate;

FIG. 22 is a cross-sectional view taken along line 22-22 in FIG. 21 showing a spring of the head that urges one of the fastener flattening plungers toward the staple pusher plate;

FIG. 23 is a top plan view of the fastener applicator of FIG. 18;

FIG. 24 is a cross-sectional view taken along line 24-24 in FIG. 23 showing a linkage of the fastener applicator that is driven by a ram of a linear actuator of the fastener applicator;

FIG. 25 is an enlarged view of a portion of FIG. 24 showing a connecting rod of the fastener nest extending through an opening of the anvil bed assembly;

FIG. 26 is a perspective view of a fastener nest assembly that includes the fastener nest of FIG. 25 and shows an upper portion of the fastener nest assembly that includes retainer members for engaging fasteners and a lower portion with rollers to be guided in cam paths;

FIG. 27 is a perspective view of a head height adjustment system for the fastener applicator of FIG. 18 that permits a user to adjust a height of a head of the fastener applicator above the anvil bed assembly;

FIG. 28 is a cross-sectional view taken along line 28-28 in FIG. 27 showing a knob of the head height adjustment system that may be shifted laterally by a user against the bias of a spring to enable turning of the knob and pinion gears connected thereto to adjust a height of the head of the fastener applicator;

FIG. 29 is a perspective view of the knob of FIG. 28 showing shortened splines of the knob that engage splines of a knob housing of the head height adjustment system when the user releases the knob;

FIG. 30 is a cross-sectional view taken along line 30-30 in FIG. 23 showing an anvil drive assembly for rotating the anvils;

FIG. 31 is an enlarged view of a portion of FIG. 30 showing the anvil drive assembly having a cam drive member that extends into a cam path of one of the anvils such that up-and-down movement of the cam drive member causes rotation of the anvil;

FIG. 32 is an enlarged view of the anvil and anvil drive assembly of FIG. 31 showing an end portion of the cam member extending into the cam path of the anvil;

FIG. 33 is a cross-sectional view taken along line 33-33 in FIG. 23 showing pins of a head assembly of the fastener applicator received in a vertical cam path and a J-shaped cam path that guide movement of the head assembly;

FIGS. 34-49 are a series of cross-sectional views of the fastener applicator of FIG. 18 showing movement of the head, nest assembly, and anvil drive assembly involved in securing a fastener to a conveyor belt end;

FIG. 50 is a perspective view of another embodiment of a fastener applicator for securing fasteners to a conveyor belt end;

FIG. 51 is a side elevational view of a belt clamp of the fastener applicator of FIG. 50;

FIG. 52 is a perspective view of the fastener applicator of FIG. 50 showing a table extension of the fastener applicator in a laterally extend position for supporting a wide conveyor belt end;

FIG. 53 is an enlarged view of a portion of an anvil bed assembly of the fastener assembly of FIG. 50 with a rotatable anvil removed to show cleaning openings of an anvil bed of the anvil bed assembly;

FIG. 54 is a perspective view of the anvil bed of FIG. 53 showing a channel extending from one lateral side of the anvil bed to the other lateral side of the anvil bed to collect debris from the cleaning openings of the anvil bed;

FIGS. 55A-55D are elevational views of one of the rotatable anvils of the fastener applicator of FIG. 50 showing a lower shaft portion of the anvil having a cam path extending around the lower shaft portion;

FIG. 56 is a side elevational view of the fastener applicator of FIG. 50 with portions removed to show a cam plate of the fastener assembly with cam paths that receive rollers of a fastener nest assembly and an anvil drive assembly of the fastener applicator;

FIG. 57 is a perspective view of the fastener nest assembly of the fastener applicator of FIG. 56;

FIG. 58 is a side elevational view of a fastener nest of the fastener nest assembly of FIG. 57 showing a retainer member having teeth that engage an upper plate of a fastener to secure the fastener in the fastener nest;

FIG. 59 is a rear perspective view of the upper portion of the fastener nest of FIG. 58 showing springs of an over-center locking mechanism of the fastener nest that are above a pivot shaft of the fastener nest;

FIG. 60 is a view similar to FIG. 59 showing an upper portion of the fastener nest pivoted downwardly and the springs pivoted to extend below the pivot shaft of fastener nest and resist unintentional opening of the fastener nest;

FIG. 61 is a perspective view of a portion of the fastener applicator of FIG. 50 showing a head height adjustment system that includes an electric motor, a drive pulley, a follower pulley, and a belt;

FIG. 62 is a flow diagram of a method of autonomously adjusting a height of a head of the fastener applicator of FIG. 50 to utilize a fastener loaded into the fastener applicator;

FIG. 63 is a perspective view of an anvil bed assembly of another embodiment of a fastener applicator;

FIG. 64 is a view similar to FIG. 63 showing fasteners positioned in the anvil bed assembly;

FIG. 65 is a top plan view of one pair of anvils of the anvil bed assembly of FIG. 63;

FIG. 66 is a top plan view of another pair of anvils of the anvil bed assembly of FIG. 63;

FIGS. 67 and 68 are side elevational views of the anvil bed assembly of FIG. 63 showing a comb of the fastener assembly lowering the fasteners onto the anvils;

FIG. 69 is a perspective view of another anvil bed assembly having an anvil bed with an upper surface that is flush with upper end portions of anvils of the anvil bed assembly;

FIG. 70 is a perspective view of another anvil bed assembly having anvils that are rotatably received in openings of an anvil bed of the anvil bed assembly;

FIGS. 71 and 72 are perspective views of an anvil bed assembly having grooves with tapered surfaces that initially bend staple legs as the staple legs are driven out of apertures of a lower plate of a fastener and plungers that shift upwardly and bend the staple legs against the lower plate;

FIG. 73 is a perspective view of a rotatable anvil having an initial staple leg bending portion with grooves to initially bend staple legs as the staple legs and a final set portion with a flat surface to perform a final bending of the staple legs;

FIG. 74 is a perspective view of a fastener applicator having a fastener nest that engages upper plates of fasteners and supports the fasteners above anvils of an anvil bed assembly; and

FIGS. 75-82 are a series of side views of the fastener applicator of

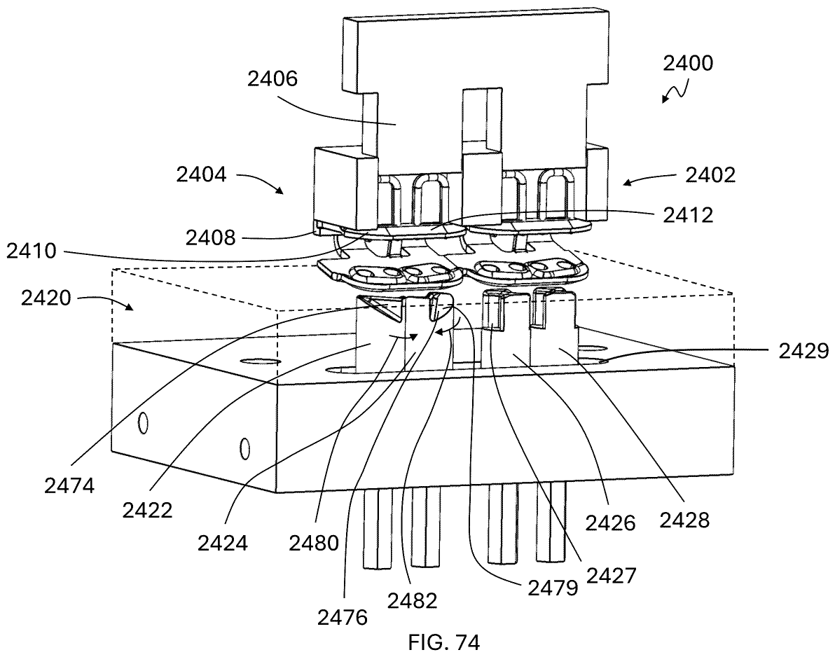

FIG. 74 showing a method of securing a fastener to a conveyor belt end using the fastener applicator of FIG. 74.

### DETAILED DESCRIPTION

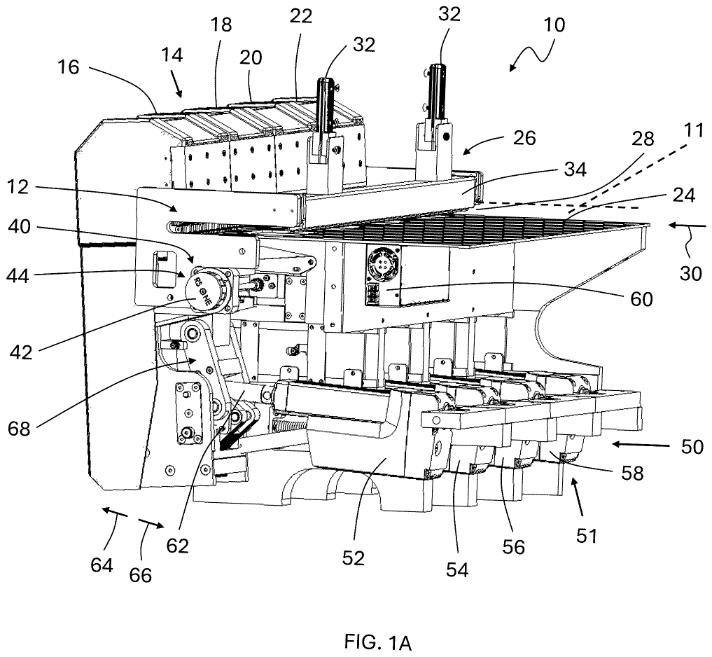

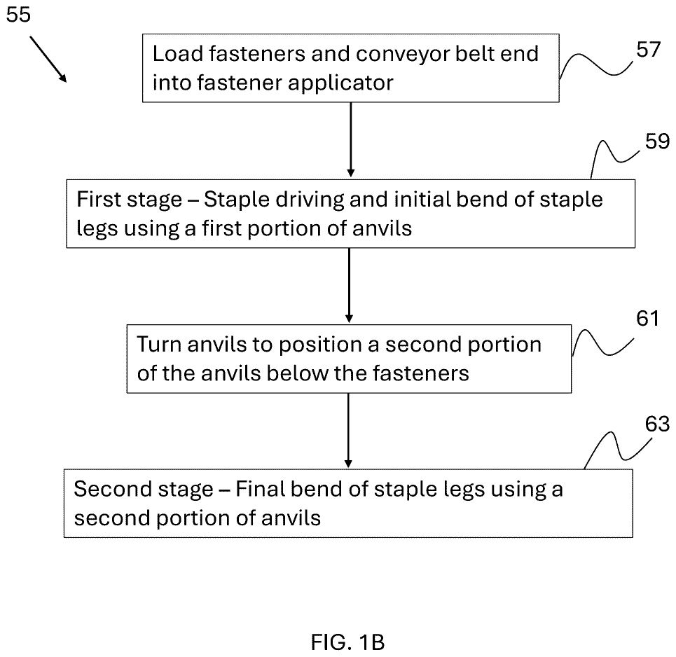

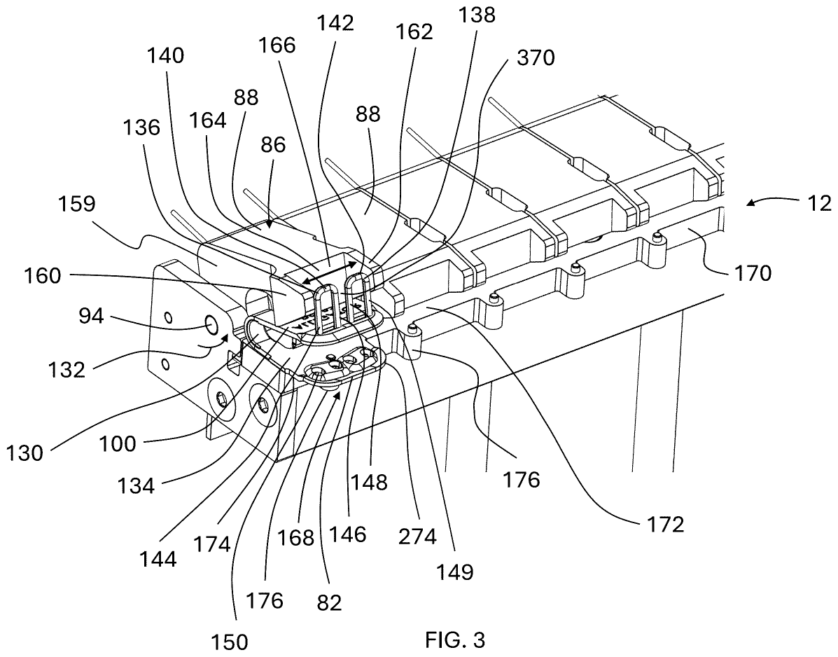

Referring to FIG. 1A, a fastener applicator 10 is shown that includes fastener nests 12 (see FIG. 3) that each receive a plurality of staple belt fasteners, a belt support 24 for supporting a conveyor belt end 11, and a clamp assembly 26 for securing the conveyor belt end 11 to the belt support 24. The fastener applicator 10 has one or more heads 14 (such as heads 16, 18, 20, 22) and an anvil bed assembly 70 that cooperate to secure all of the staple belt fasteners loaded in the fastener nests 12 to the conveyor belt end 11 in a single operation of the fastener applicator 10. The fastener applicator 10 has one or more actuators 51 (such as linear actuators 52, 54, 56, 58) that are connected to the heads 14 and the anvil bed assembly 70 via associated linkages 68. The fastener applicator 10 has a controller 60 operatively connected to the actuators 51 and a user interface 40, such as knob 42. In one embodiment, the knob 42 is a component of a head height adjustment system 44 that permits a user to adjust a height of the heads 14 above the anvil bed assembly 70 so that the heads 14 can accommodate different sized fasteners and belt thicknesses.

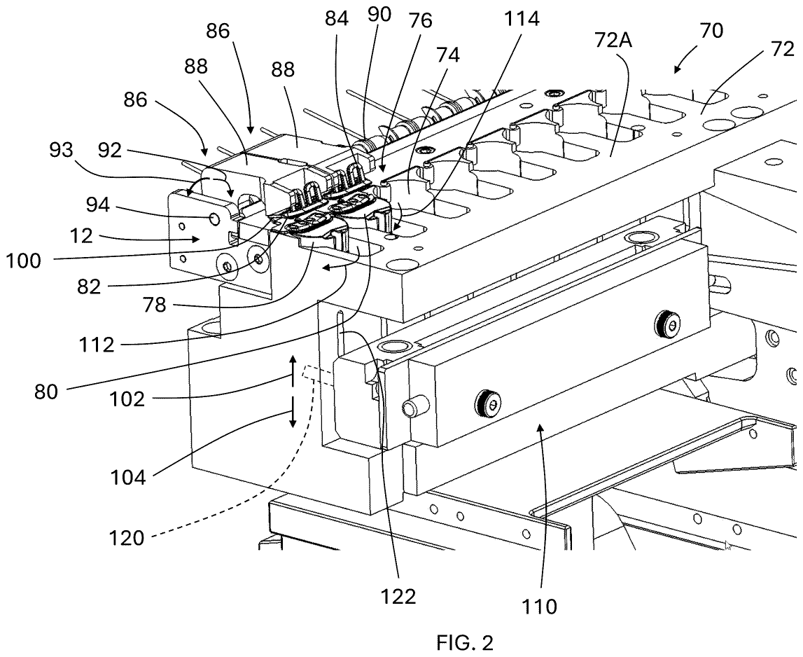

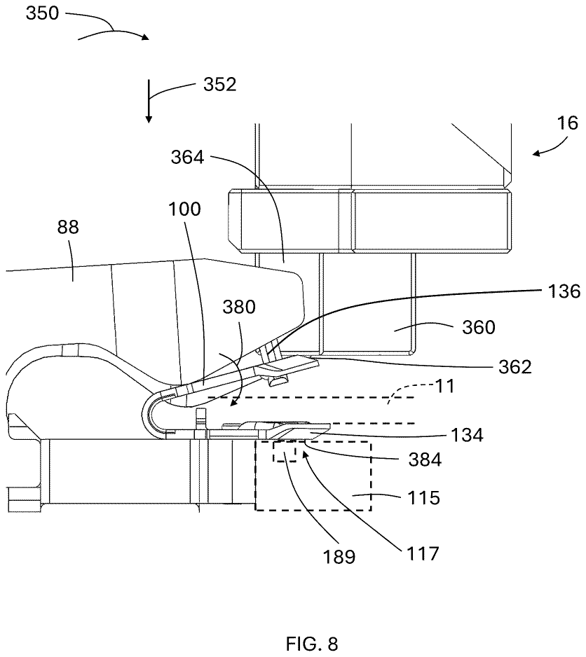

Regarding FIG. 1B, the fastener applicator 10 may be operated according to method 55 to secure fasteners to the conveyor belt end 11. At step 57, a user loads staple belt fasteners (e.g., fasteners 82, 84 in FIG. 2) into the fastener nests 12. Step 57 further includes the user advancing a conveyor belt end 11 in direction 30 (see FIG. 1A) into a gap 28 between a cross bar 34 of the clamp assembly 26 and the belt support 24. The conveyor belt end 11 is continued to be advanced in direction 30 into position between upper and lower plates 100, 134 of the fasteners as shown in FIG. 8. The user then operates clamps 32 of the clamp assembly 26 to secure the conveyor belt end 11 in position on the belt support 24.

Next, the user provides a user input to the user interface 40, such as pushing the knob 42 laterally inward, to start operation of the fastener applicator 10. The controller 60 operates all of the linear actuators 52-58 to extend and retract rams 62 of the linear actuators 52-58 and cause corresponding movement of the heads 14 and anvil bed assemblies 70 via the linkages 68 and perform steps 59, 61, 63 of the method 55. The heads 14 and anvil bed assemblies 70 cooperate to secure an entire set of the staple belt fasteners to the conveyor belt end 11 needed to form a splice with another belt end having the same number of staple belt fasteners secured thereto. The applicator 10 is able to secure the entire set of staple belt fasteners substantially simultaneously with one cycle of shifting the rams 62 in rearward direction 64 from an initial position to an extended position and then retracting the rams 62 in forward direction 66 back to the initial position. In this manner, the fastener applicator 10 is able to secure a large number, such as twenty, thirty, or more staple belt fasteners at a time to a conveyor belt end. The fastener applicator 10 thereby enables rapid conveyor belt repair which reduces conveyor belt down time. Further, the fastener applicator 10 has powered linear actuators 52-58 to drive the components of the fastener applicator 10 that perform the staple fastener clenching, staple driving, and staple bending operations.

The illustrated fastener applicator 10 has four heads 14 each with its own associated fastener nest 12, portion of the anvil bed assembly 70, linkage 68, and one of the linear actuators 52-58. In other embodiments, the fastener applicator may have fewer heads 14 and associated components if the fastener applicator is to be used to secure fasteners to narrower belts, or the fastener applicator may have additional heads 14 and associated components if the fastener applicator is to be used to secure fasteners to wider belts. In this manner, the fastener applicator 10 is modular in that fewer or additional heads 14 and associated components may be utilized so that applicator 10 can be tailored based on the width of the belt and the number staple belt fasteners to be applied thereto. Additionally, variations of the fastener applicator are also contemplated, such as a fastener applicator with one actuator 51 driving multiple heads 14 and associated components.

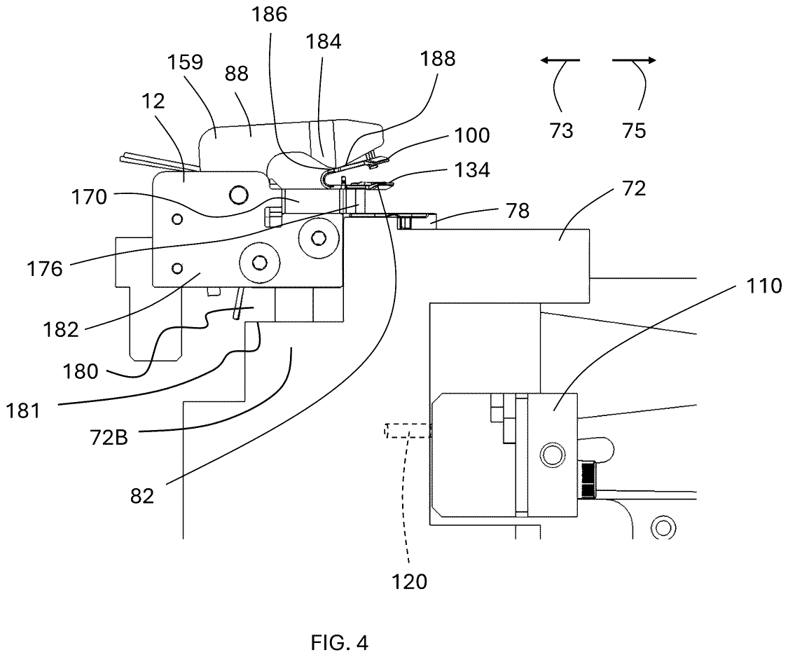

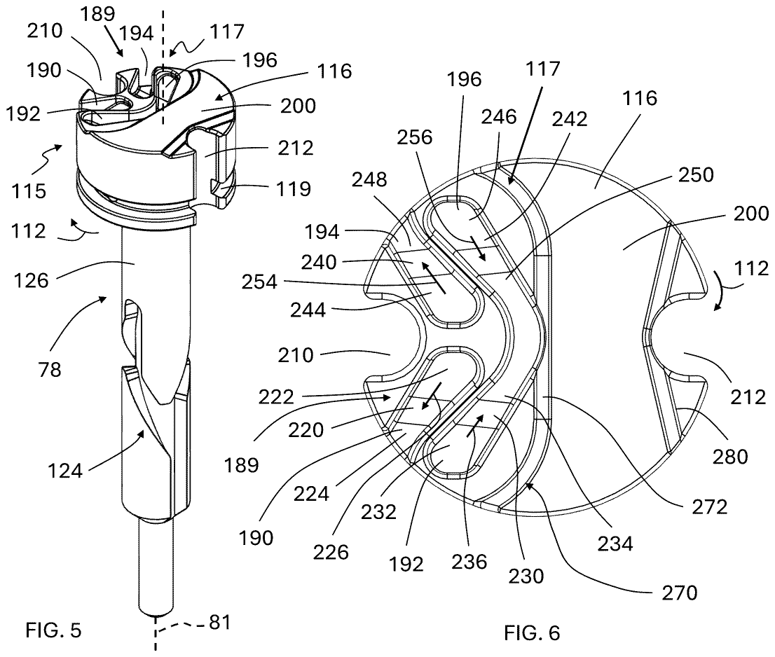

In FIG. 2, one of the fastener nests 12 and an associated portion of the anvil bed assembly 70 is shown. The anvil bed assembly 70 includes an anvil bed 72 with openings 74 and anvils 76 (such as anvils 78, 80) rotatably supported therein. The anvils 76 are constrained or limited to rotary movement in the openings 74 of the anvil bed 72. With temporary reference to FIG. 5, each anvil 76 has an annular channel 119 that receives a retainer member, such as radially inner portion of a snap-ring while a radially outer portion of the snap-ring is received in a corresponding annular channel of the anvil bed 72 that opens to the opening 74 of the anvil 76. The engagement of the snap-ring in the annular channel 119 of the anvil 76 and in the annular channel of the anvil bed 72 releasably secures the anvil 76 in the opening 74 while permitting the anvil 76 to rotate in the opening 74. In this manner, the anvils 76 are inhibited from vertical up-and-down movement and fore-aft movement in directions 73, 75 (see FIG. 4) relative to the anvil bed 72, but can rotate in the openings 74 during a fastener securing operation.

The anvil bed 72 may have a one-piece construction a width sized to accommodate all four heads 14. As shown, the anvil bed 72 has a stepped construction with an uppermost step portion 72A in which the openings 74 for the anvils 76 are formed to extend therethrough. For clarity purposes, FIG. 2 only has two anvils 78, 80 and two staple belt fasteners 82, 84 shown. The fastener nest 12 has retainers 86 for each fastener 82, 84 in the fastener nest 12. The retainers 86 each include a retainer member 88 that is pivotal in opposite pivotal directions 92, 93 about a laterally extending pivot shaft 94 of the fastener nest 12. The retainers 86 also each include a torsion spring 90 that biases the retainer member 88 of the retainer 86 in the pivotal direction 92 to engage upper plates 100 of the fasteners 82, 84. The torsion spring 90 biases the retainer member 88 to keep it engaged with rearward or outboard portions of upper plates 100 of the staple belt fasteners as the head 16 drives and clenches the upper plates 100 downwardly onto a clamped conveyor belt end. Conversely, a user may pivot the retainer member 88 in the pivotal direction 93 against the bias of the torsion spring 90 to load the fasteners 82, 84 into the fastener nest 12.

Continuing reference to FIG. 2, the anvil bed assembly 70 includes an anvil drive assembly 110 that shifts up-and-down in vertical directions 102, 104 to cause the anvils 78, 80 to spin or turn in clockwise directions 112, 114 to reposition the anvils 78, 80 below the staple belt fasteners 82, 84 during a fastener securing operation of the fastener applicator 10. With temporary reference to FIG. 5, the anvil 78 spins in direction 112 around a central axis 81 of the anvil 78. The anvil 80 spins in direction 114 similarly around a central axis of the anvil 80.

The anvil drive assembly 110 shifts up-and-down twice and rotates the anvils 78, 80 through 360° during the fastener securing operation of the fastener applicator 10 to secure the fasteners 82, 84 to the conveyor belt end 11. The fastener nest 12 likewise shifts up-and-down in vertical directions 102, 104 twice during the fastener securing operation of the fastener applicator 10 to lift the fasteners 82, 84 out of the way of the anvils 78, 80 when the anvils 78, 80 are being turned in directions 112, 114.

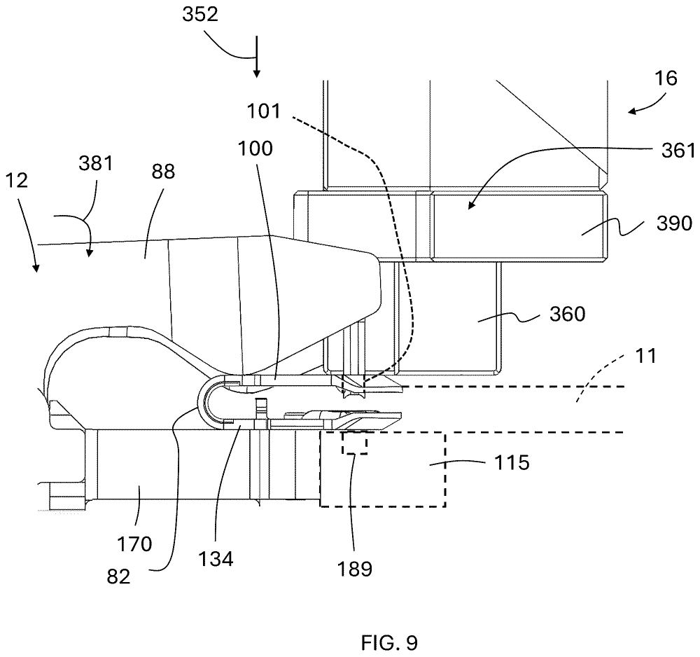

As shown in FIG. 5, the anvil 78 has an upper head portion 115 with initial staple leg bend portion 117 including grooves 189 recessed from flat surface 200 to perform an initial bend of staple legs 144, 146, 148, 149 (see FIG. 3) of staples 136, 138 of the staple belt fasteners 82, 84. The staples 136, 138 are preset in the upper plate 100 of the fastener 82, with the staple legs 144, 146 148, 149 each friction fit in a respective aperture 101 (see FIG. 9) of the upper plate 100.

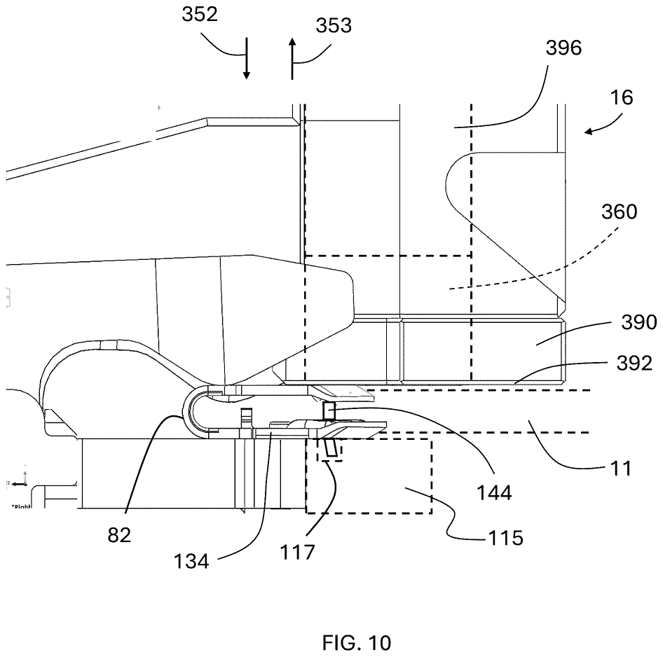

For this purpose, in step 59 of method 55, the head 16 is shifted downwardly a first or initial time to drive the staple legs through a conveyor belt (see FIGS. 9 and 10), and into the underlying grooves 189 which are configured to cause the driven staple legs to bend, as will be described further hereinafter. Step 61 of method 55 includes lifting upwardly the head 16 and fastener nest 12 in direction 102 which lifts the fasteners including the initially bent staple legs off of the anvils 78, 80. Step 61 of method 55 further includes the anvils 78, 80 turning 180° in directions 112, 114 to position a final set portion 116 of the anvil head portion 115 below the fasteners 82, 84 and their initially bent staple legs. The final set portion 116 has a flat surface 200 for bending the initially bent staple legs 144, 146, 148, 149 against lower plates 134 of the fasteners 82, 84. In step 63 of the method 55, the head 16 is shifted downwardly a second time during the fastener securing operation to perform a final clench of the fasteners 82, 84 onto the conveyor belt end 11 and perform a final bend of the initially bent staples 136, 138 of the fasteners 82, 84 against the flat surface 200 to secure the fasteners 82, 84 to the conveyor belt end. In this manner, the head portion 115 of each anvil 78, 80 has both the initial staple leg bend grooves 189 and the flat surface 200 that the staple legs 144, 146, 148, 149 are pressed against by the head 16 during the respective initial staple leg bending and final staple leg bending operations of the two-stage fastener securing operation performed by the fastener applicator 10 and provided in method 55 of FIG. 1B.

Referring to FIGS. 2 and 4, the anvil drive assembly 110 includes anvil drive members 120 in the form of pins that extend through vertically elongated slots 122 of the anvil bed 72 and engage and travel in cam paths 124 (see FIG. 5) of shaft portions 126 of the anvils 76. The cam paths 124 limit the anvils 76 to turning in predetermined increments (e.g., 180 degrees of rotation) with each up-and-down movement of the anvil drive members 72. In other words, the cam paths 124 limit the anvils 76 to a one-way, predetermined rotary motion in direction 112, 114 (see FIG. 2) in response to the up-and-down movement of the anvil drive members 120 in the cam path 124.

As discussed in greater detail below, the anvil drive assembly 110 is shifted up-and-down in directions 102, 104 twice during a fastener securing operation to cause the anvil drive members 120 to travel along the cam paths 124 and rotationally index the anvils 78, 80 to the operative positions rotated 180 degrees from each other, as described above.

FIG. 3 shows the fastener nest 12 with the fastener 82 received therein. The staple belt fastener 82 has a fastener body 130 that includes the upper plate 100, one or more loop portions 132, and the lower plate 134 interconnected to the upper plate 100 by the loop portions 132. The staples 136, 138 of fastener 82 have bights or crowns 140, 142 and legs 144, 146, 148, 149 depending therefrom. The bottom end portions of the legs 144, 146, 148, 149 are press-fit in apertures of the upper plate 100 and the legs are driven into and through apertures 150 of the lower plate 134 during a fastener securing operation.

The retainer members 88 of the nest 12 each have a main block body 159 and side ears 160, 162 with a lateral spacing 164 therebetween that extends a lateral distance 166. The lateral distance 166 is sized to fit the pair of staples 136, 138 of a single staple belt fastener therebetween. The ears 160, 162 extend forwardly from the main block body 159 and allow a user to visually center the fastener 82 at a fastener location 168 of the fastener nest 12 when the user is manually loading the fastener 82 into the fastener nest 12. As can be seen in FIG. 4, the body 159 of the retainer member 88 has a contact portion 184 with a rounded surface portion 186 and the ears 160, 162 each have a lower inclined surface portion 188 that is configured to allow the retainer member 88 to stay in contact with the fastener upper plate 100 from when the fastener is fully open with the upper plate 100 at its maximum incline relative to the horizontal lower plate 134 prior to being clenched onto the conveyor belt end 11 to when the upper plate 100 is driven down to its horizontal orientation (see, FIG. 9) after being clenched onto the conveyor belt end 111.

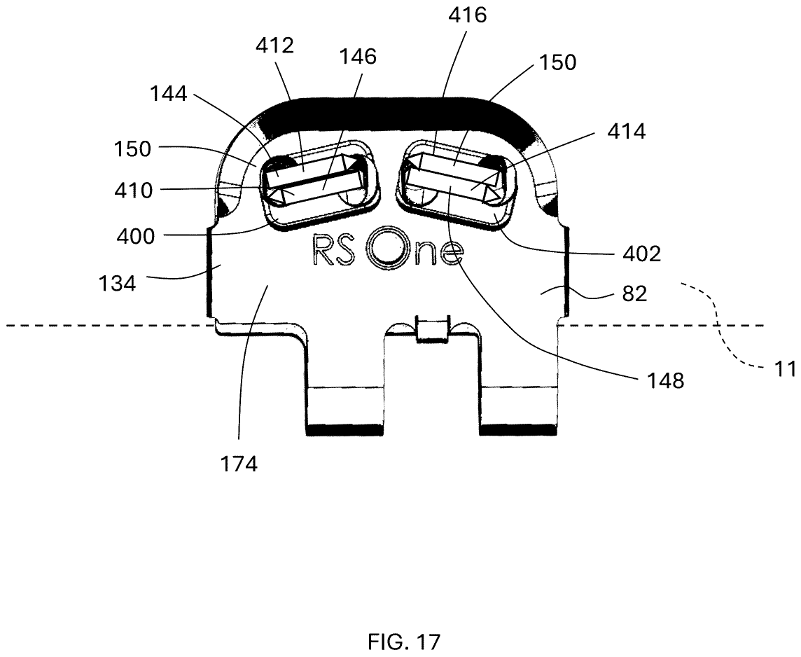

Returning to FIG. 3, the fastener nest 12 includes a lower, laterally extending support 170 with an upper support surface 172 for supporting bottom surfaces 174 (FIG. 17) of the fastener lower plates 134 thereon. The support 170 further includes a series of locating members, such as protrusions 176, that protrude forwardly in an inboard direction under each of the fastener lower plates 134 and provide an extended contact area with the bottom surface 174 of each of the fastener lower plates 134 of the staple belt fasteners received in the nest 12.

Regarding FIG. 4, the fastener nest 12 is shown in a raised position with a gap spacing 180 between a side plate 182 of the fastener nest 12 and a horizontally extending surface 181 of an intermediate level step portion 72B of the anvil bed 72 below the side plate 182. In the raised position, the support 170 raises the fastener lower plates 134 above the corresponding anvils 78. Further, with the fastener nest 12 in the raised position, the support 170 including the protrusions 176 and the fastener lower plates 134 thereon are lifted to be above the anvils 78. In this manner, the anvils 78 can rotate without interference from or contact with the protrusions 176 and the fastener lower plates 134.

Referencing FIG. 5, the grooves 189 of the initial staple leg bend portion 117 of the anvil head portion 115 include a pair of grooves 190, 192 to bend staple legs 144, 146 of staple 136 as the legs 144, 146 are driven out of the apertures 150 of the fastener lower plate 134. Similarly, the grooves 189 include a pair of grooves 194, 196 to bend the legs 148, 149 of the staple 138 as the legs 148, 149 exit the apertures 150. The grooves 190, 192 are continuous with one another and are portions of one groove. The grooves 190, 194 are each their own groove.

The grooves 190, 192 and 194, 196 are configured to perform initial bending of the staple legs 144, 146, 148, 149 of both of the staples 136, 138 in response to the first downward movement of the head 16 in the first or initial stage of the two-stage fastener securing operation. As discussed in greater detail below, the grooves 190, 192, 194, 196 have tapered surfaces 220, 230, 240, 242 with higher portions where the staples first enter the grooves 190, 192, 194, 196 and lower portions farther along the grooves 190, 192, 194, 196. The incline of the tapered surfaces 220, 230, 240, 242 is the same incline that the staple legs will be bent after the initial bending operation. Further, the flat surface 200 of the final set portion 116 is sized to support all of the initially bent staple legs 144, 146, 148, 149 positioned against the flat surface 200 as the staple legs 144, 146, 148, 149 are fully bent against the fastener lower plate 134 in response to the second downward movement of the head 16 in the second or final stage of the two-stage fastener securing operation. In this manner, the head 16 and a single one of the anvils 78 perform both of the staple driving and bending operations for both of the staples 136, 138 of the fastener 82.

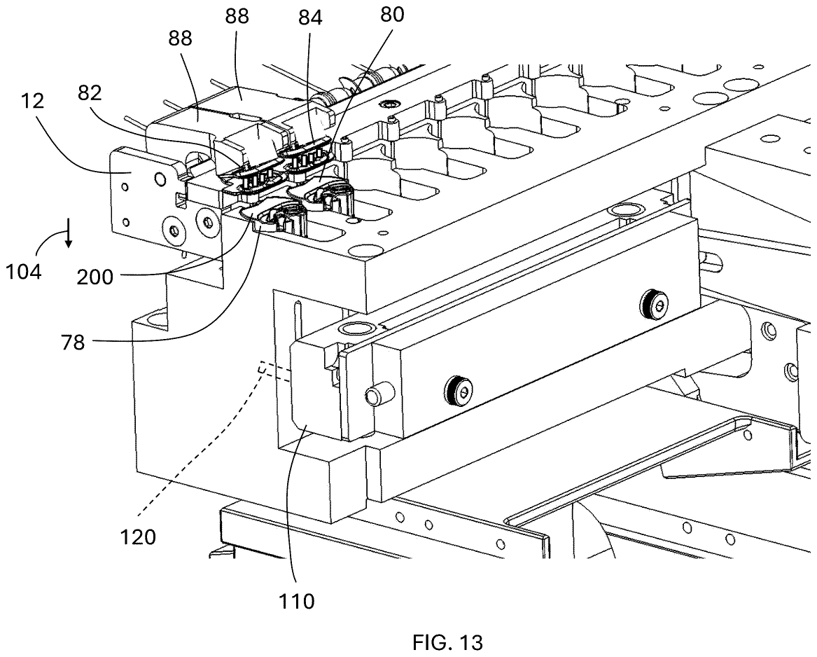

The anvil head portion 115 has an initial bend opening or channel 210 and a final set opening or channel 212, as can be seen in FIG. 6. The channels 201 and 212 can have a vertical orientation for each receiving the cylindrically configured protrusion 176 of the fastener nest 12 in different stages of the fastener securing operation. More specifically, the initial bend channel 210 receives the protrusion 176 when the anvil 78 is in an initial stage, staple leg bend rotary position (see FIG. 2). Once the fastener 82 has been clenched onto the conveyor belt end 11 and the legs of the staples 136, 138 have been driven and initially bent, the protrusion 176 is lifted up out of the initial bend channel 210 as the fastener nest 12 shifts upward in direction 102, as shown in FIG. 4. Next, the anvil 78 is rotated 180° from the initial stage, staple leg bend rotary orientation to a final stage, staple set rotary position (see FIG. 13) and the fastener nest 12 shifts downward in direction 104. The downward movement of the fastener nest 12 advances the protrusion 176 of the fastener nest 12 downward into the final set channel 212. The receipt of the protrusion 176 of the fastener nest 12 in the initial bend channel 210 or the final set channel 212 restricts the anvil 78 against rotation relative to the fastener nest 12 and head 16 and ensures precise alignment of the fastener staple legs 144, 146, 148, 149 with either the grooves 189 or the flat surface 200.

With continued reference to FIG. 6, the groove 190 has a tapered surface 220 with an upper portion 222 and a lower portion 224. When driven down out through the fastener upper plate aperture, the body of the belt and into and through the corresponding fastener lower plate aperture in the initial stage of the fastener securing operation, the staple leg 146 of staple 136 contacts the upper portion 222 and is redirected by and along the tapered surface 220 in direction 226 toward the lower portion 224. Similarly, the groove 192 has a tapered surface 230 with a raised or upper portion 232 and a lower portion 234. The other staple leg 144 of staple 136 is driven simultaneously and in a similar manner to staple leg 146 through the corresponding plate apertures and belt into contact with the upper portion 222 and is redirected by and along the tapered surface 230 in direction 236 toward the lower portion 234. Because the legs 144, 146 are bent in opposite directions 226, 236, the tapered surfaces 220, 230 of the grooves 190, 192 are tapered in opposite directions and are configured to generate an initial bend of the staple legs 144, 146 so they extend adjacent to and with opposite inclines to each other. The grooves 194, 196 likewise have tapered surfaces 240, 242 with upper portions 244, 246 and lower portions 248, 250 that are configured to bend the staple legs 148, 149 in directions 254, 256 to generate an initial bend of the staple legs 148, 149 in the same manner as grooves 190, 192.

As shown in FIGS. 5 and 6, the initial staple leg bend portion 117 includes a first recessed portion 270 configured to receive an inboard portion of the lower plate 134 of the fastener 82. The first recessed portion 270 includes a profiled surface 272 that mates with an inboard edge 274 (see FIG. 3) of the lower plate 134 when the fastener nest 12 and fastener lower plate 134 have been shifted downwardly to a lower position (see FIGS. 2 and 8). The anvil head portion 115 also includes a second recessed portion 280 spaced from the first recessed portion 270 and extending about the final set channel 212. The second recessed portion 280 provides clearance for the protrusion 176 as the fastener nest 12 lowers and the anvil 78 turns toward the final set rotary position thereof.

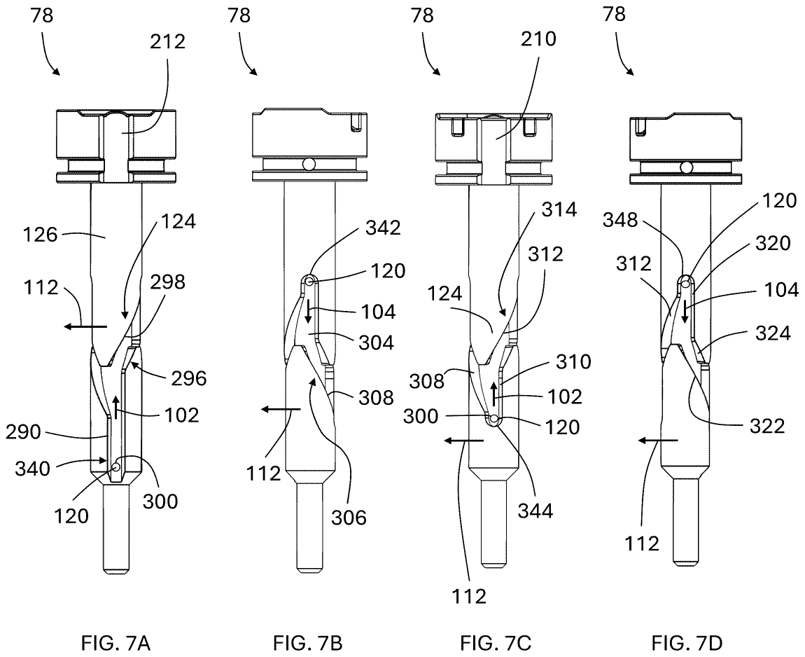

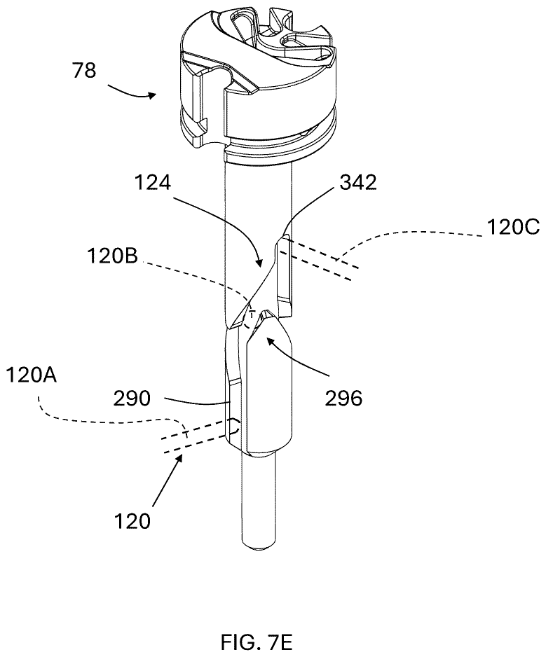

The two-stage fastener securing operation will next be described in greater detail with reference to FIGS. 7A-7D. Initially, the anvil drive member 120 of the anvil drive assembly 110 is located in a first axial portion 290 of the cam path 124 (see FIG. 7A) when the anvil 78 is in the initial staple leg bend rotary position of FIG. 2. As shown in FIGS. 2 and 8, when the fastener 82 is initially loaded into the fastener nest 12, the lower plate 134 of the fastener 82 is supported on the recessed portion 270 of the initial staple leg bend portion 117 of the anvil head portion 115. Further, the grooves 189 of the anvil head portion 115 are disposed below the apertures 150 of the lower plate 134.

To clench the upper plate 100 of the fastener 82 onto the conveyor belt end 11, the head 16 is pivoted forward in direction 350 and shifted downwardly in direction 352 to drive a fastener flattening plunger 360 of the head 16 into driving engagement with an upper surface 362 of the upper plate 100 of the fastener 82, as shown in FIGS. 8 and 9. The flattening plunger 360 has a forward, narrow portion 364 that fits into a space 370 (see FIG. 3) between the staples 136, 138. Continuing reference to FIGS. 8 and 9, shifting of the head 16 in direction 352 causes the fastener flattening plunger 360 to pivot the upper plate 100 downward in direction 380 and clench the fastener upper plate 100 onto the conveyor belt end 11 in flush engagement therewith. The retainer member 88 pivots in direction 381 with pivoting of the fastener upper plate 100 onto the conveyor belt end 11. The contact portion 184 of the retainer member 88 remains tightly engaged with the fastener upper plate 100 despite the changing orientation of the fastener upper plate 100 as it is driven downwardly which keeps the fastener lower plate 134 firmly engaged with the support 170 of the fastener nest 12.

Referencing FIGS. 9 and 10, the plunger 360 has a linear slide connection 361 with a staple pusher 390 of the head 16 to allow for relative vertical movement between the plunger 360 and staple pusher 390. Once the plunger 360 has clenched the fastener upper plate 100 onto the conveyor belt end 11, the head 16 continues to shift downward in direction 352 and shift the staple pusher 390 in direction 352 via the linear slide connection 361. The staple pusher 390 has a driving surface 392 that engages the crowns 140, 142 of the staples 136, 138 and drives the staples 136, 138 downward in direction 352. The plunger 360 slides upward relative to the staple pusher 390 into an interior 396 of the head 16 to facilitate the lowering of the staple pusher 390 while the plunger 360 remains engaged against the fastener upper plate 100. As shown in FIG. 10, the staple pusher 390 has shifted fully downward in direction 352 and has driven the staple legs 144, 146, 148, 149 through the apertures 150 of the lower plate 134 of the fastener 82 and into the grooves 189 of the anvil head portion 115. The driving of the staple legs 144, 146, 148, 149 into the grooves 189 to engage tips of the staple legs 144, 146, 148, 149 with the tapered surfaces 220, 230, 240, 242. Continued downward shifting of the staple pusher 390 with the staple leg tips engaged against the tapered surfaces causes an initial bending of the staple legs 144, 146, 148, 149. Once the head 16 has clenched the upper plate 100 of the fastener 82 onto the conveyor belt end 11 and has driven and initially bent the legs 144, 144, 146, 148 of the staples 136, 138, the head 16 is lifted upward in direction 353 and disengages the plunger 360 and staple pusher 390 from the upper plate 100 and staples 136, 138.

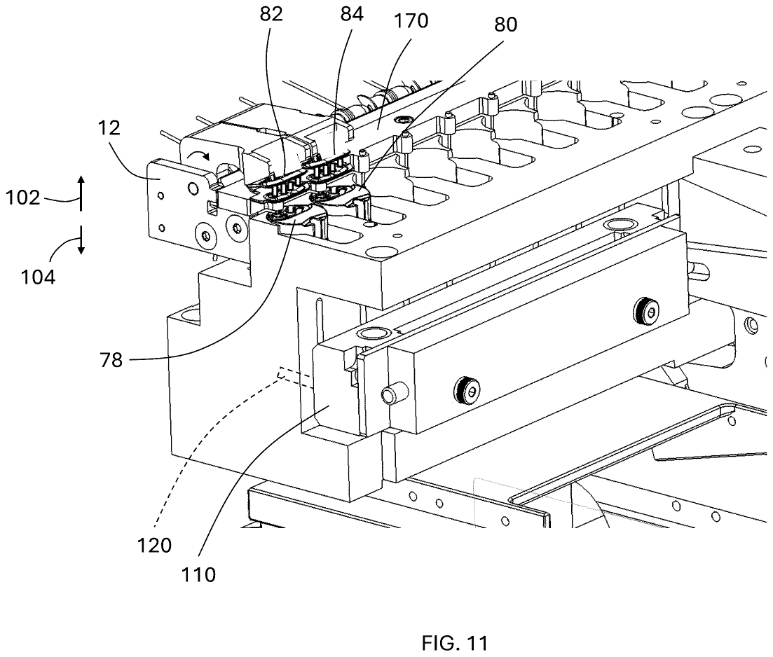

After completion of the first stage of the fastener securing operation as described above, the fastener nest 12 is shifted upward a first time in direction 102 to raise the protrusion 176 of the fastener nest support 170, the fastener 82, and the conveyor belt end 11 having the fastener 82 thereon above the anvil 78 to initiate the second stage of the fastener securing operation and provide clearance for rotation of the anvil 78, as shown in FIGS. 2 and 11. The anvil drive member 120 or pin is still in the first axial portion 290 of the cam path 124 as shown in FIG. 7A when the fastener nest 12 shifts upward the first time in direction 102.

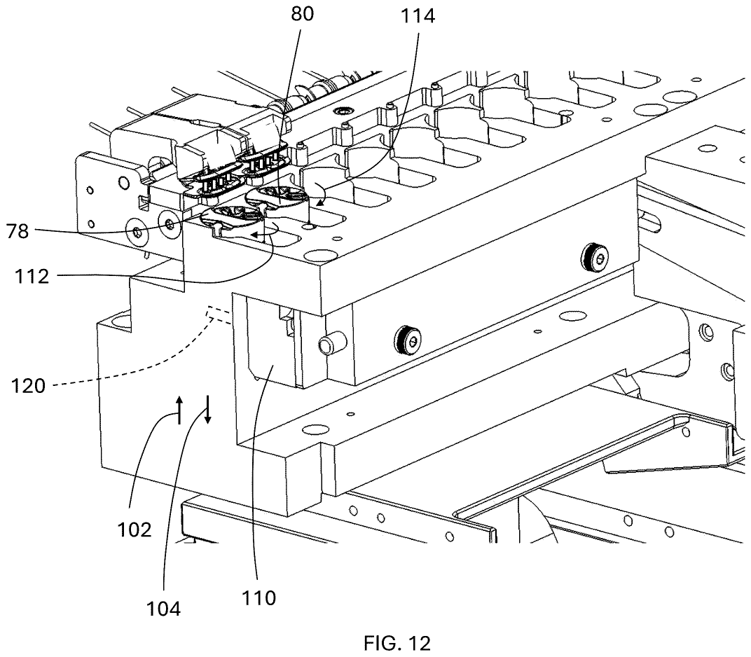

As shown in FIGS. 11 and 12, the anvil drive assembly 110 is shifted upward a first time in direction 102 after the fastener nest 12 has been raised to the position shown in FIG. 11. The upward shifting of the anvil drive assembly 110 causes the anvil drive member 120 to travel from its lowermost position in the first lower end portion 340 of the cam path 124 in direction 102 up along the first lower axial portion 290, into and up along a first upper helical portion 296 of the cam path 124, and into a first upper end 342 of the cam path 124 of the anvil 78 as shown in FIGS. 7A and 7B. As the anvil drive member 120 travels through the first helical portion 296, a curved outer surface 300 of the anvil drive member 120 cammingly engages a first cam surface 298 which causes the anvil 78 to rotate or turn clockwise 90° in the direction 112 to a first intermediate rotary position, as shown in FIGS. 7B and 12. When the anvil drive member 120 is in the first upper end 342 of the cam path 124, the fastener nest 12 and the anvil drive assembly 110 are in the raised positions thereof, as shown in FIG. 12.

FIG. 7E shows the anvil drive member 120 moving from position 120A, to position 120B, to position 120C, which matches the movement of the anvil drive member 120 as shown in FIGS. 7A and 7B. In the position 120A, the anvil drive member 120 is in the first lower axial portion 290 of the cam path 124. In position 120B, the anvil drive member 120 is in the helical portion 296. In position 120C, the anvil drive member 120 is in the first upper end 342 of the cam path 124. The anvil drive member 120 moves continuously and smoothly along the cam path 124 from the first lower axial portion 290 up to the first upper end 342.

In FIG. 7E, the anvil 78 is shown stationary while the anvil drive member 120 rotates about the anvil 78 to illustrate the relative helical movement of the anvil drive member 120 and the anvil 78 as the anvil drive member 120 travels along the cam path 124. However, during actual operation of the fastener applicator 10, the anvil 78 rotates in the opening 74 of the anvil bed 72 and the anvil drive member 120 shifts up-and-down in the slot 122 (see FIG. 2) of the anvil bed 72.

While the fastener nest 12 remains in the raised position in FIG. 12, the anvil drive assembly 110 is shifted downwardly a first time in direction 104 to the lowered position shown in FIG. 13. The downward shifting of the anvil drive assembly 110 in direction 104 between the positions of FIGS. 12 and 13 causes the anvil drive member 120 to travel down along a second upper axial portion 304 of the cam path 124 which is generally axially higher than the first lower axial cam path portion 290, into and down along a second lower helical portion 306 which is generally axially lower than the first upper helical cam path portion 296, and into a second lower end portion 344 which is axially higher than the first lower end portion 340, as shown in FIGS. 7B and 7C. The anvil drive member 120 cammingly engages a second cam surface 308 as the anvil drive member 120 travels down along the second helical portion 306. The camming engagement between the anvil drive member 120 and the second cam surface 308 causes the anvil 78 to turn or rotate an additional 90° clockwise in the direction 112 to the position shown in FIGS. 7C and 13. With the anvil drive member 120 in the second lower end portion 344 of the cam path 124, the anvil 78 is in the final set rotary position with the flat surface 200 positioned to perform final bending of the staple legs 144, 146, 148, 149.

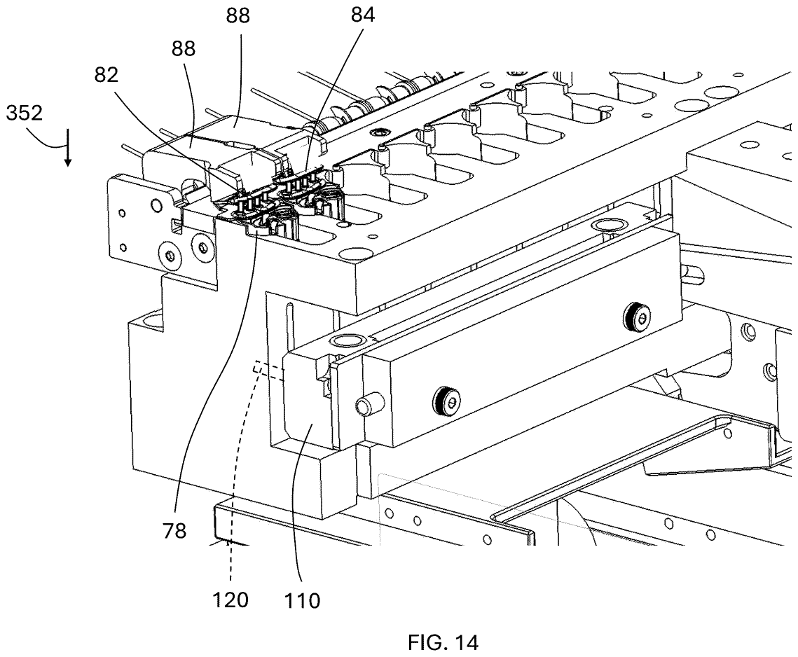

The fastener nest 12 is shifted downward a first time in direction 104 from its raised position in FIG. 13 to its lowered position in FIG. 14. The shifting of the fastener nest 12 in direction 104 advances the fastener nest protrusion 176 into the final set channel 212 (see FIG. 6) of the anvil 78 and brings the initially bent staple legs 144, 146, 148, 149 into engagement against the flat surface 200 of the anvil 78.

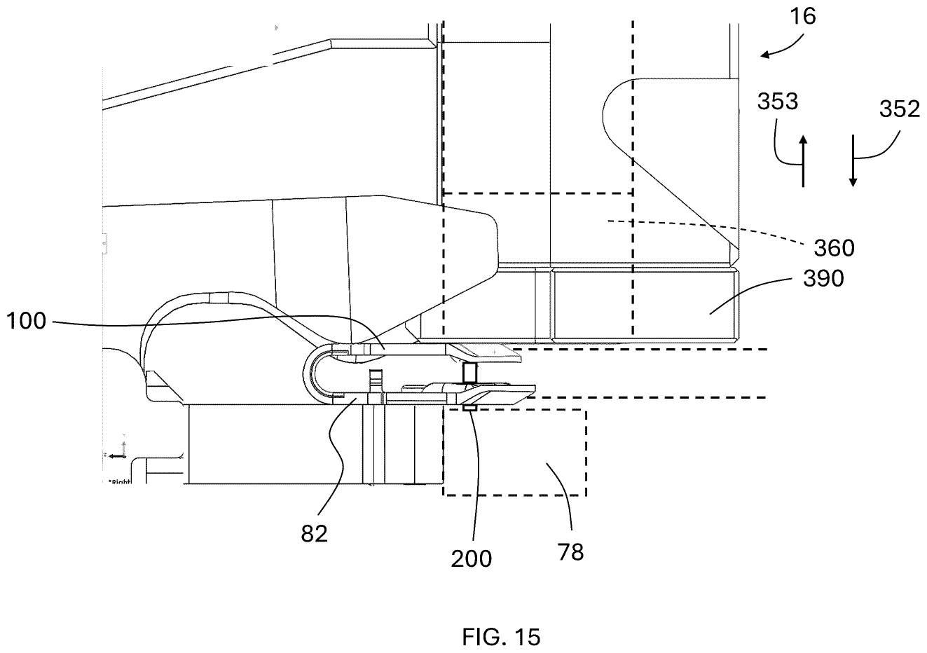

Next, the head 16 is operated to perform final bending of the legs 144, 146, 148, 149 against the flat surface 200 of the anvil 78 in the second stage of the fastener securing operation. For this, the head 16 is shifted downwardly a second time in direction 352, as shown in FIG. 15. The staple flattening plunger 360 engages the fastener upper plate 100 and the staple pusher 390 continues shifting downward in direction 352 relative to the plunger 360 via the slide connection 361 therebetween until the staple pusher 390 engages the crowns 140, 142 of the staples 136, 138. With the plunger 360 remaining engaged with the fastener upper plate 100 and the staple pusher 390 now engaged with the staple crowns 140, 142, the head 16 is urged further in direction 352 so the plunger 360 tightly presses the tips or ends of the staple legs 144, 146, 148, 149 against the flat surface 200 of the anvil 78 to bend the leading end portions 410, 412 and 414, 416 up into overlying pockets 400, 402 of the lower plate 134 of the fastener 82, the result of which is shown in FIG. 17.

Referring to FIG. 15, after the head 16 performs final bending of the legs 144, 146, 148, 149, the head 16 is shifted upwardly in direction 353 away from the conveyor belt end 11 and the fastener 82 secured thereto. The fastener nest 12 is then shifted upwardly a second time in direction 102 to position the fastener nest protrusion 176, fastener 82, and conveyor belt end 11 in clearance with the anvil 78. The fastener nest 12, anvils 78, 80, and anvil drive assembly 110 have positions similar to the positions shown in FIG. 13.

Next, the anvil drive assembly 110 is shifted upward a second time in direction 102. Referencing FIGS. 7C and 7D, the second upward shifting of the anvil drive assembly 110 in direction 102 causes the anvil drive member 120 to travel from the second lower end portion 344 of the cam path 124, into and up along a third helical portion 314, into and up along a fourth axial portion 320, and into a second upper end 348. The third helical portion 314 is generally at the same axial position along the shaft portion 126 as the first helical portion 296, but on an opposite side of the shaft portion 126. Likewise, the second upper end 348 is at generally at the same axial position along the shaft portion 126 as the first upper end 342 but on an opposite side of the shaft portion 126.

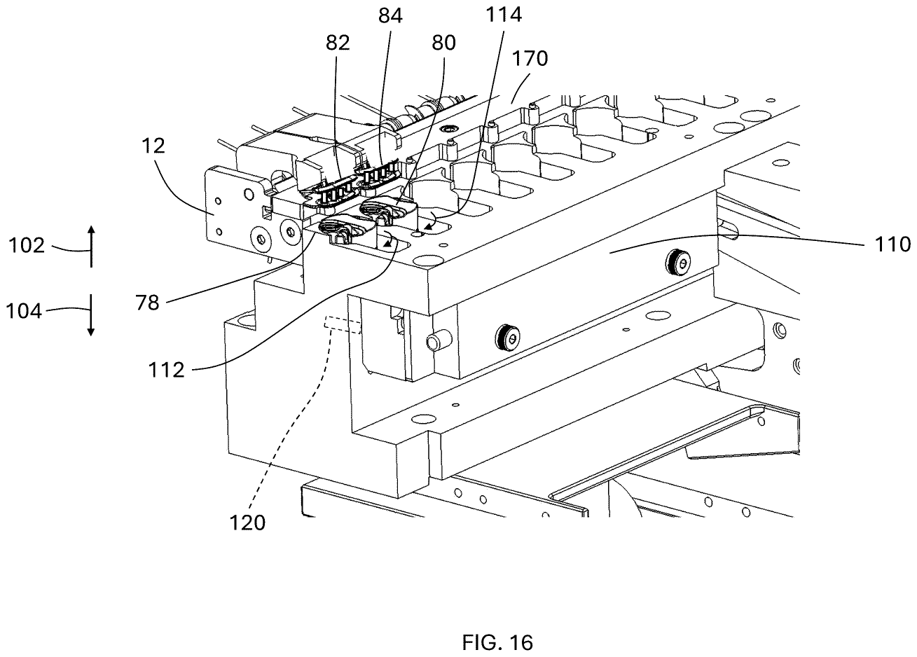

The anvil drive member 120 cammingly engages a third cam surface 312 as the anvil drive member 120 travels along the third helical portion 314. The camming engagement between the anvil drive member 120 and the third cam surface 312 causes the anvil 78 to rotate or turn 90° clockwise in direction 112 from the final set rotary position of FIGS. 7C and 13 to a second intermediate rotary position as shown in FIGS. 7D and 16.

When the anvil drive member 120 is in the second upper end 348 of the cam path 124, the fastener nest 12 and the anvil drive assembly 110 are in the raised positions shown in FIG. 16. While the fastener nest 12 remains in the raised position of FIG. 16, the anvil drive assembly 110 is shifted downwardly a second time in direction 104 which causes the anvil drive member 120 to travel into and down along the fourth axial portion 320, into and down along a fourth helical portion 324, and into and down along the first axial portion 290 before returning to the first lower end portion 340. The anvil drive member 120 cammingly engages a fourth cam surface 322 as the anvil drive member 120 travels along the fourth helical portion 324. The engagement between the anvil drive member 120 and the fourth rotary cam surface 322 causes the anvil 78 to rotate or turn clockwise 90° in the direction 112 to the initial staple leg bend rotary position of FIGS. 2 and 7A. Once the anvil 78 has returned to the initial staple leg bend rotary position, the fastener nest 12 is lowered for a second time in direction 104 back to its initial lowered position, as shown in FIG. 2. The conveyor belt end 11 with fasteners 82, 84 secured thereto may then be removed from the fastener applicator 10.

In this manner, the two sequential up-and down movements of the anvil drive assembly 110 in directions 102, 104 cause the anvil 78 to rotate or turn 180° in direction 112 with each up-and-down movement of the anvil drive assembly 110 via the engagement between the anvil drive member 120 and cam path 124. The two up-and-down movements of the fastener nest 12 in directions 102, 104 are coordinated with the up-and-down movements of the anvil drive assembly 110 to keep the fastener nest 12, fastener 82, and conveyor belt end 11 from contacting the anvil 78 as the anvil 78 rotates 360° in direction 112 from the initial staple leg bend rotary position, to the final set rotary position, and to the initial staple leg bend rotary position again.

FIG. 17 shows the configuration of the fastener 82 once it has been secured to the conveyor belt end 11. As shown, the bottom plate 134 has recesses or pockets 400, 402 that open to the staple leg receiving apertures 150 in the lower plate 134. The leading end portion 410 of the staple leg 146 has been bent over into the pocket 400 and the leading end portion 412 of the staple leg 144 has been bent over into the pocket 400 and extends parallel and in an opposite direction to the adjacent leading end portion 410. Likewise, in a similar manner the leading end portion 414 of the staple leg 148 and the leading end portion 416 of the staple leg 149 have been bent over into the pocket 402. The leading end portions 410, 412, 414, 416 are generally flush with or raised only slightly above from the bottom surface 174 of the lower plate 134 in the pockets 400, 402 to limit interference with rollers, cleaners, or other conveyor structures as the conveyor belt including the splice having the fasteners 82 travel thereover.

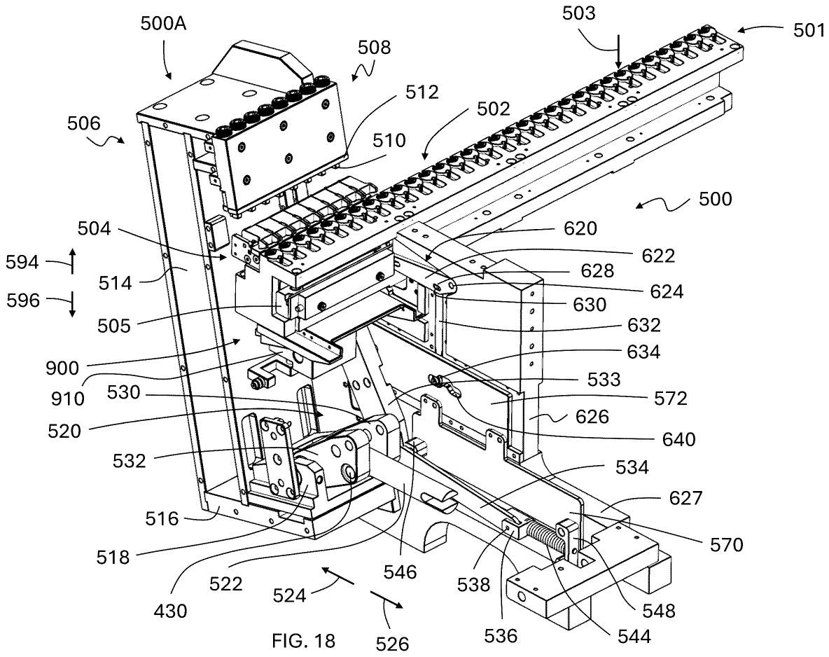

Regarding FIG. 18, a portion 500A of a fastener applicator 500 is provided that is similar in many respects to the fastener applicator 10 discussed above. The fastener applicator 10 may utilize components discussed below with respect to the fastener applicator 500 and vice versa. In this regard, the fastener applicator 10 has components similar to the components of the fastener applicator 500 discussed below to effect movement of the components of the fastener applicator 10, such as the up/down movement of the fastener nest 12 and anvil drive assembly 110, movement of the head 16, and rotation of the anvils 78, 80.

The fastener applicator 500 includes an anvil assembly 502 and four portions 500A that operate with the anvil assembly 502. Only one of the portions 500A is shown for clarity purposes. It will be appreciated that any number of portions 500A may be utilized and the anvil assembly 502 sized appropriately. For example, one embodiment of the fastener applicator 500 may include one portion 500A while another embodiment of the fastener applicator 500 may include eight portions 500A. The number of portions 500A may be selected based upon the width of conveyor belts that will typically be repaired or installed using the fastener applicator 500.

The portion 500A includes a fastener nest 504, an anvil drive assembly 505, and a head assembly 506. The anvil assembly 502 includes an anvil bed 501 with anvils 503 rotatably supported in openings of the anvil bed 501. The head assembly 506 is movable relative to the anvil assembly 502 and the fastener nest 504 to perform fastener clenching, staple driving and staple leg initial bending, and staple leg final bending operations. The head assembly 506 includes a head 508 with fastener flattening plungers 510 and a staple pusher 512. The head assembly 506 further includes one or more walls 514, a base plate 516, and mounts 518. The mounts 518 are connected to a linkage 520. The linkage 520 is driven by movement of ram 522 of an actuator that shifts the ram 522 in directions 524, 526 to operate the components of the fastener applicator 500 and secure fasteners to a conveyor belt end.

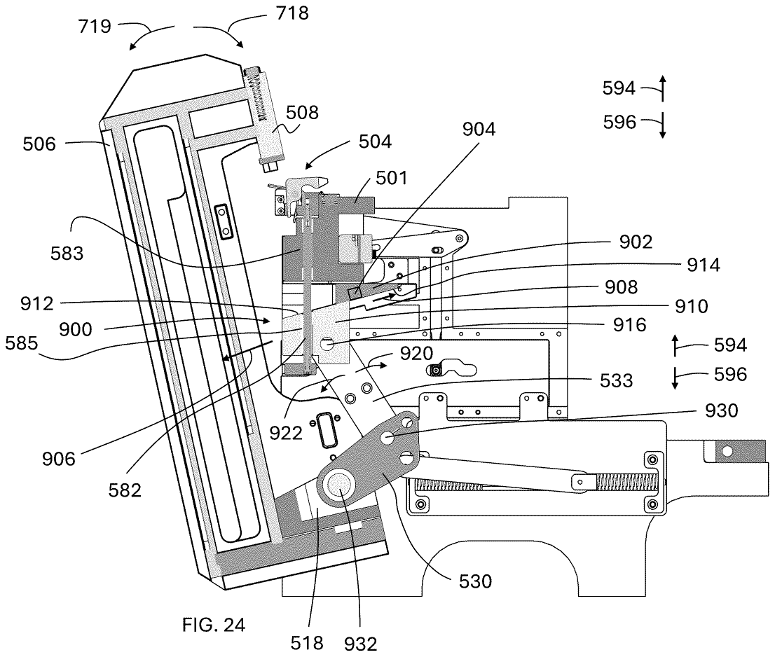

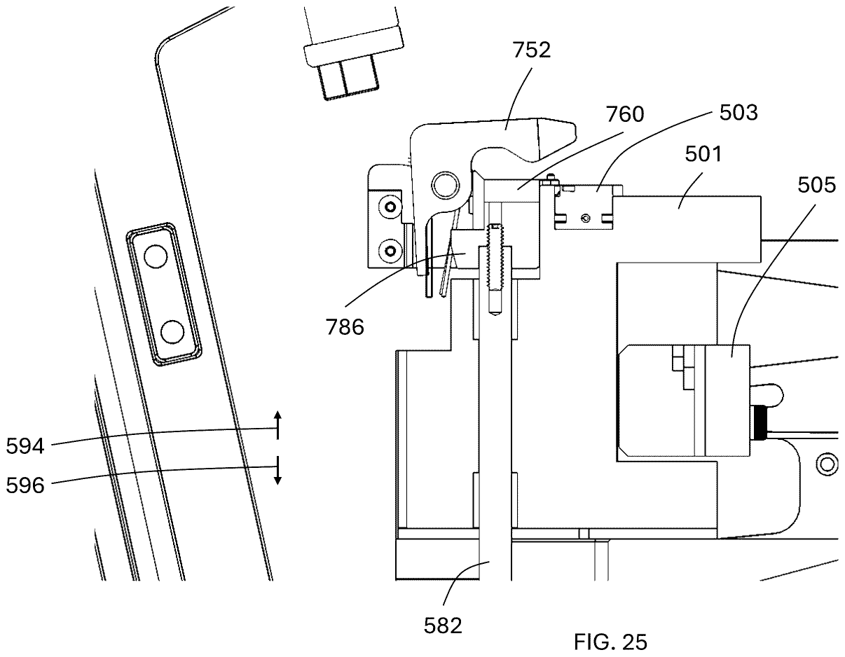

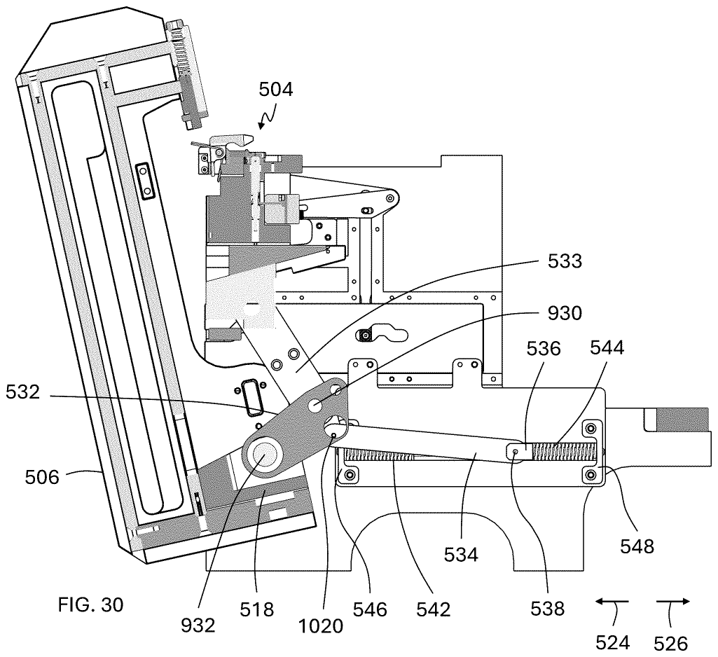

The linkage 520 includes links 530, 532 pivotally connected to the mounts 518 and the ram 522. The linkage 520 further includes a link 533 that is pivotally connected to the link 530, a pivot block 910 (see FIG. 24), and a trolley link 534. Regarding FIG. 30, the link 533 is also pivotally connected to the trolley link 534 at a pivot connection 1020. One link 533 is shown for clarity purposes, but a similar link may likewise be pivotally connected to the link 532 and the pivot block 910.

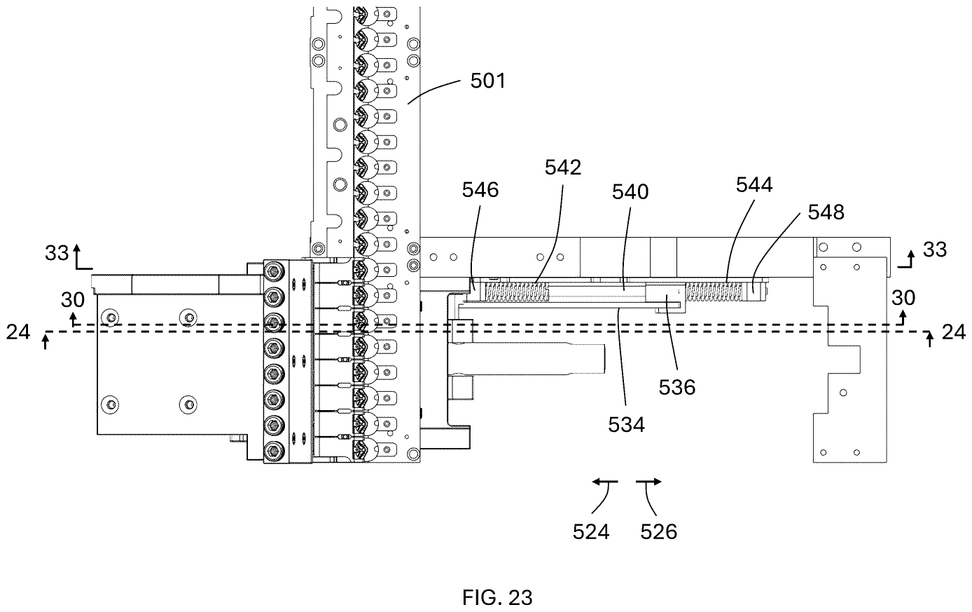

Shifting of the ram 522 in direction 524 pivots the links 530, 532, 533 and shifts the trolley link 534 in direction 524. The trolley link 534 is connected to a trolley 536 via pivot connection 538. The trolley 536 is shiftable along a shaft 540 (see FIG. 23) having springs 542, 544 extending thereabout at opposite ends of the shaft 540. Further, the ends of the shaft 540 are supported by spring stops 546, 548. As shown in FIG. 23, the shifting of the trolley link 534 in direction 524 engages the trolley 536 with the spring 542. Conversely, shifting of the trolley link 534 in direction 526 engages the trolley 536 with the spring 544. The springs 542, 544 have a distance therebetween along the shaft 540 that is sufficiently large to permit the trolley 536 to shift along the shaft 540 for a predetermined distance without contacting either spring 542, 544 for a predetermined distance. As discussed in greater detail below, the movement of the trolley 536 along the shaft 540 when the trolley 536 is not contacting either spring 542, 544 corresponds to a dwell period for components of the fastener applicator 500 that are controlled by a spring plate 570 (see FIG. 18).

Regarding FIG. 18, the spring stops 546, 548 are mounted to a spring plate 570. The spring plate 570 is fixed to a cam plate 572. When the trolley 536 shifts in direction 524 and contacts the spring 542, further shifting of the trolley 536 in direction 524 urges the spring plate 570 and cam plate 572 in direction 524. Conversely, when the trolley 536 is shifted in direction 526 into engagement with the spring 544, the movement of the trolley 536 in direction 526 while engaging the spring 544 urges the spring plate 570 and the cam plate 572 in direction 526.

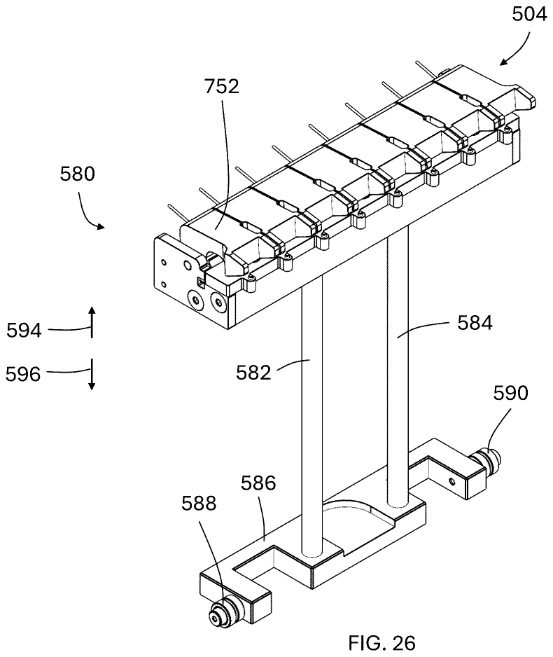

The shifting of the cam plate 572 in directions 524, 526 causes lifting and lowering of the fastener nest 504 and the anvil drive assembly 505. Regarding FIGS. 18 and 26, the fastener applicator 500 includes a fastener nest assembly 580 with the fastener nest 504, connecting rods 582, 584, and a guided lower portion 586. The connecting rods 582, 584 extend through openings 583, 585 (see FIG. 24) in the anvil bed 501 and a pivot block 910. The guided lower portion has rollers 588, 590 that facilitate linear, up-and-down movement of the fastener nest assembly 580 in directions 594, 596.

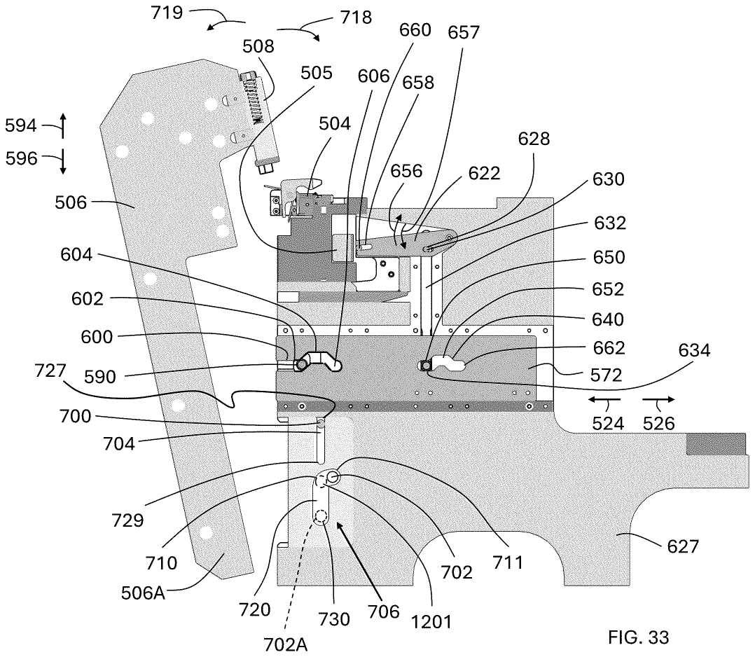

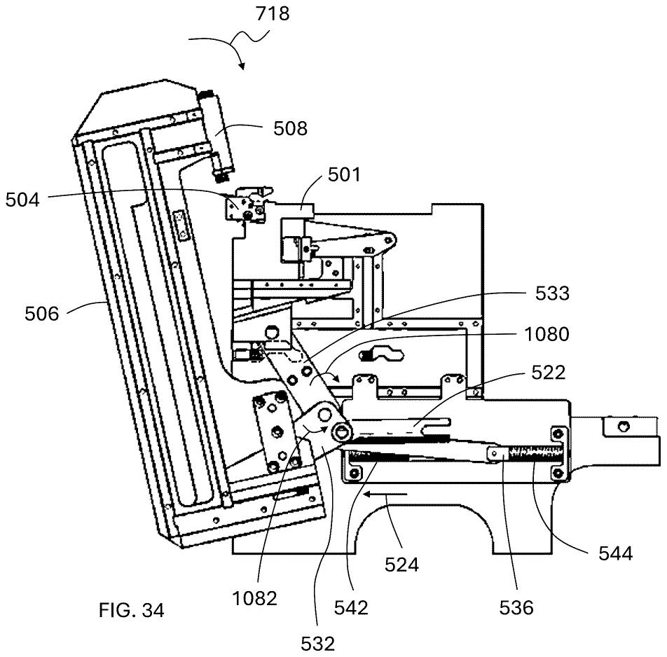

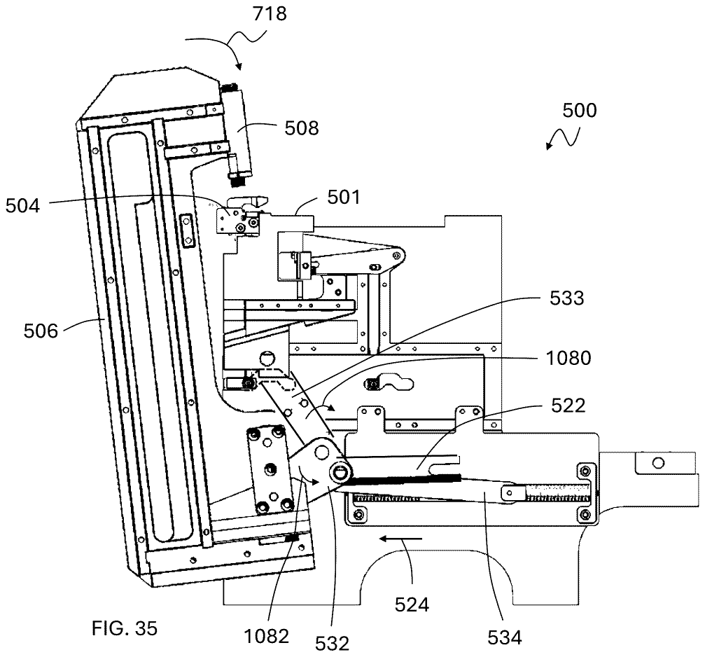

Regarding FIG. 33, the roller 590 is received in a nest assembly cam path 600 of the cam plate 572. The roller 588 is likewise received in an identical cam path of another cam plate that is moved in unison with the cam plate 572. The other cam plate is not shown for clarity purposes.

The nest assembly cam path 600 has an initial idle portion 602, a lifting portion 604, and an intermediate idle portion 606. The profile of the nest assembly cam path 600 causes the roller 590 and fastener nest assembly 580 to shift upward in direction 594 as the roller 590 shifts from the initial idle portion 602 to the lifting portion 604 when the cam plate 572 is shifted in direction 524 by the trolley 536 engaging the spring 542. Continued shifting of the cam plate 572 in direction 524 causes the roller 590 to travel from the lifting portion 604 to the intermediate idle portion 606. The movement of the roller 590 from the lifting portion 604 to the intermediate idle portion 606 causes the nest assembly 580 to shift downward in direction 596.

Once the roller 590 has reached the intermediate idle portion 606, the cam plate 572 is shifted backward in direction 526. The movement of the roller 590 from the intermediate idle portion 606 to the lifting portion 604 again shifts the fastener nest assembly 580 upward in direction 594. Continued shifting of the cam plate 572 in direction 526 causes the roller 590 to travel from the lifting portion 604 back to the initial idle portion 602 at the end of a fastener securing operation. In this manner, the cam plate 572 is shifted in direction 524 first and then in direction 526 during a fastener securing operation which produces the two up-and-down movements of the fastener nest 504 that correspond to the first up-and-down movement of FIGS. 2, 11, and 14 and the second up-and-down movement of FIGS. 14, 16, and 2.

Regarding FIG. 18, the fastener applicator 500 has a lift assembly 620 including a rocker 622 with a pivot connection 624 to a support structure, such as a support wall 626, of the fastener applicator 500. The rocker 622 has an elongated slot 628 that receives a pin 630 of a rocker rod 632. The rocker rod 632 has a follower or rocker roller 634 rotatably connected to an opposite end rocker rod 632. The rocker roller 634 is received in a rocker cam path 640.

Regarding FIG. 33, the rocker cam path 640 has an initial idle portion 650 where the rocker roller 634 is positioned at the start of a fastener securing operation. When the ram 522 is driven in direction 524, the cam plate 572 is likewise shifted in direction 524 once the trolley 536 engages the spring 542 and continues shifting in direction 524. The shifting of the cam plate 572 in direction 524 moves the rocker roller 634 into a lifting portion 652 of the rocker cam path 640 that causes the rocker roller 634 and rocker rod 632 connected thereto to shift upward in direction 594 and pivot the rocker 622 in direction 656. The rocker 622 has a slot 658 thereof that receives a pin 660 of the anvil drive assembly 505. The pivoting of the rocker 622 in direction 656 causes the anvil drive assembly 505 to shift upwardly in direction 594.

Continued shifting of the cam plate 572 in direction 524 causes the rocker roller 634 to move from the lifting portion 652 into an intermediate idle portion 662 of the rocker cam path 640. Movement of the rocker roller 634 from the lifting portion 652 to the intermediate idle portion 662 causes the rocker roller 634 and rocker rod 632 connected thereto to shift downward in direction 596, causes the rocker 622 to pivot downward in direction 657, and causes the anvil drive assembly 505 to shift downward in direction 596. The rocker roller 634 is in the intermediate idle portion 662 approximately halfway through a fastener securing operation.

Next, the ram 522 is shifted in direction 526 which causes the cam plate 572 to shift in direction 526 once the trolley 536 engages the spring 544. The shifting of the cam plate 572 in direction 526 shifts the rocker roller 634 from the intermediate idle portion 662 to the lifting portion 652 of the rocker cam path 640. The movement of the rocker roller 634 from the intermediate idle portion 662 to the lifting portion 652 causes the rocker roller 634 and rocker rod 632 connected thereto to once again shift upward in direction 592, causes the rocker 622 to pivot upward in direction 656, and causes the anvil drive assembly 505 to shift upward in direction 594.

As the cam plate 572 is driven back in direction 526 by the trolley 536 shifting in direction 526, the rocker roller 634 moves from the lifting portion 652 back to the initial idle portion 650 of the rocker cam path 640. The movement of the rocker roller 634 from the lifting portion 652 to the initial idle portion 650 shifts the rocker roller 634 and rocker rod 632 connected thereto downward in direction 596, pivots the rocker 622 downward in direction 657, and shifts the anvil drive assembly 505 back down in direction 592. The rocker roller 634 is in the initial idle portion 650 at the conclusion of the fastener securing operation. In this manner, the cam plate 572 is shifted in direction 524 and then in direction 526 during a fastener securing operation which produces the two up-and-down movements of the anvil drive assembly 505 that correspond to the first up-and-down movement of FIGS. 11, 12, and 13 and the second up-and-down movement of FIGS. 14, 16, and 2.

Regarding FIG. 33, the head assembly 506 includes pins 700, 702 that travel, respectively, in a straight guide slot 704 and a J-shaped guide slot 706 of the support wall 626 of the base 627. The head assembly 506 is shown in an initial, inclined orientation at the beginning of a fastener securing operation in FIG. 33. The inclined orientation of the head assembly 506 moves the head assembly 506 out of the way so that a user may load fasteners and a conveyor belt end into the fastener applicator 500. At the beginning of a fastener securing operation, the pin 702 is at an initial end portion 711 of the J-shaped guide slot 706.

When the ram 522 is initially shifted in direction 524 (see FIG. 18), the links 530, 532 urge a lower portion 506A of the head assembly 506 in direction 524 and cause the pin 702 to engage a curved surface 710 of the J-shaped guide slot 706 that pivots the head assembly 506 in a direction 718 to bring the head 508 into position above the fasteners received in the fastener nest 504. The continued shifting of the ram 522 in direction 524 causes the links 532, 530 to pivot counterclockwise in direction 1082 (see FIGS. 34-38). However, the pin 702 is constrained to vertical movement along a straight portion 720 of the J-shaped guide slot 706 such that the pin 702 and head assembly 506 shift downwardly in direction 596 as the ram 522 continues to shift axially in direction 524. Thus, the movement of the pin 702 along the J-shaped guide slot 706 away from the initial end portion 711 of the J-shaped guide slot 706 causes pivoting of the head assembly in direction 596 followed by downward shifting of the head assembly 506 in direction 596. Further, the pin 700 shifts downward in direction 596 away from an initial end portion 727 toward an intermediate end portion 729 of the straight guide slot 704. The engagement of the pin 700 and straight guide slot 704 provide a second, vertically shiftable pivot point for the head assembly 506 to facilitate pivoting and vertical shifting of the head assembly 506.

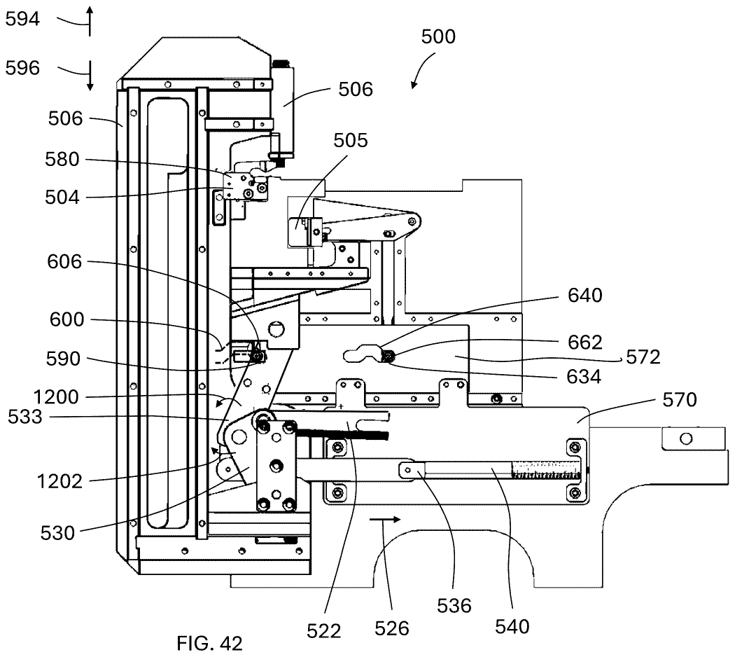

When the ram 522 is fully extended in direction 524 at a halfway point of a fastener securing operation, the pin 702 is at an intermediate end portion 730 of the J-shaped guide slot 706 as shown by reference numeral 702A and the pin 700 is at the intermediate end portion 729 of the straight guide slot 704. At the halfway point of the fastener securing operation, the roller 590 of the fastener nest assembly 580 is in the intermediate idle portion 606 of the nest assembly cam path 600 and the rocker roller 634 is in the idle portion 662 of the rocker cam path 640 as shown in FIG. 42.

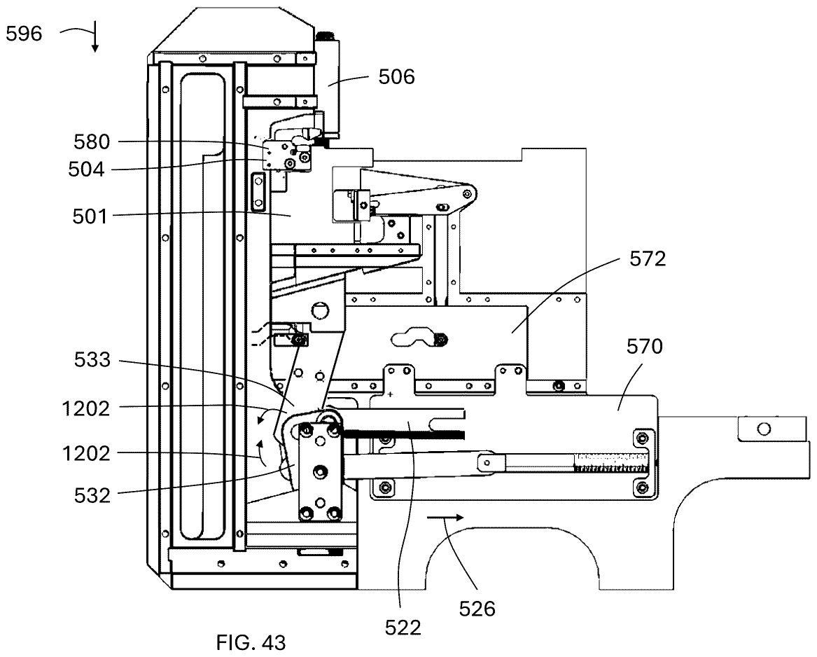

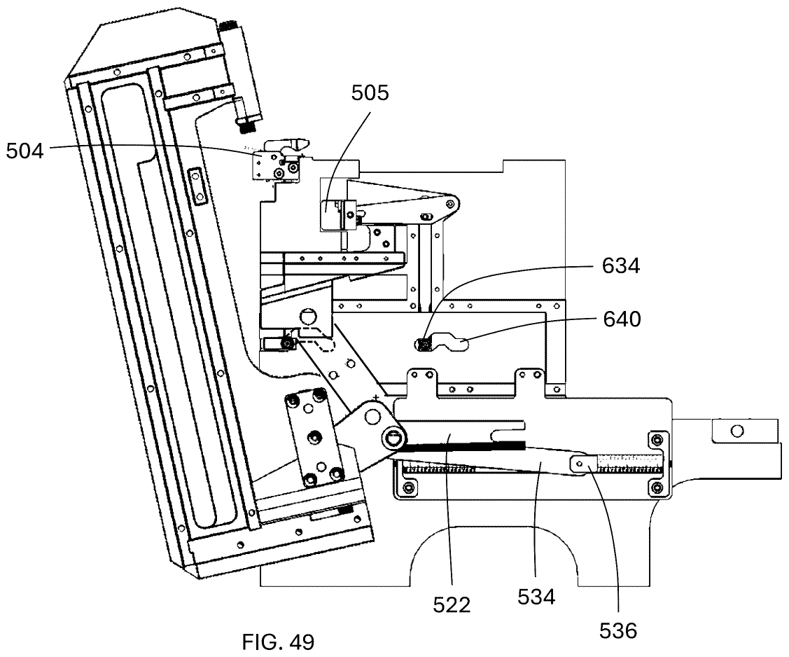

The ram 522 then shifts backward in direction 526 and causes the pin 702 to shift upward in direction 594 away from the intermediate end portion 730 of the J-shaped guide slot 706. The continued shifting of the ram 522 in direction 526 causes the links 532, 530 to pivot clockwise in direction 1202 (see FIGS. 43-47) and move the head assembly 506 so that the pin 702 engages the curved surface 710 and causes the head assembly 506 to pivot backward in direction 719 to the initial inclined orientation of the head assembly 506. When the ram 522 has traveled in direction 526 back to the initial position thereof (see FIG. 49), the pin 702 is positioned in the initial portion 711 of the J-shaped guide slot 706. With the pin 702 in the initial portion 711 of the J-shaped guide slot 706 and the pin 700 at the top of the straight guide slot 704, the head assembly 506 is has the backward inclined orientation of FIG. 35 and provides clearance for a user to unload the conveyor belt end at the end of the fastener securing operation.

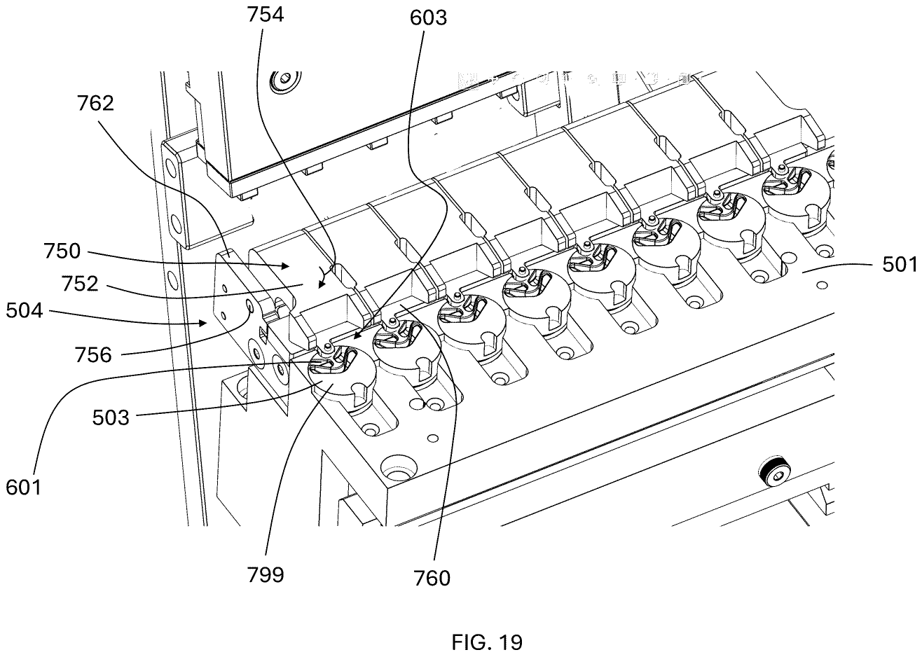

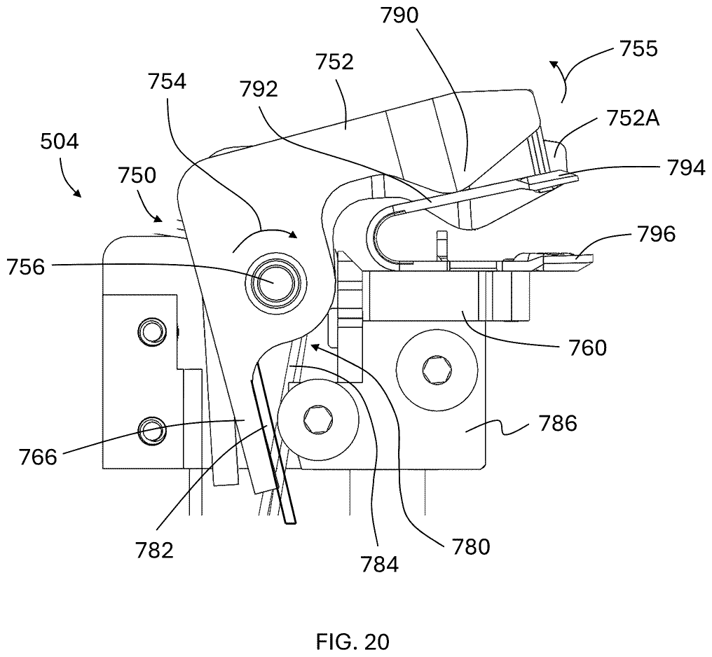

Regarding FIG. 19, the fastener nest 504 is similar to the fastener nest 12 discussed and includes fastener retainers 750 having retainer members 752 that are biased by torsion springs 780 (see FIG. 20) in direction 754 about a support shaft 756. The retainer members 752 are configured to engage and maintain fasteners in position on a fastener support 760 of the fastener nest 504 during fastener clenching, staple driving, and final bending of the legs of the staples.

Regarding FIG. 20, a portion of the fastener nest 504 is shown with a side plate 762 (see FIG. 19) removed to show a leg portion 766 of the retainer member 752 extending downward below the support shaft 756. The fastener retainer 750 includes the torsion spring 780 with a first tang 782 engaged with the leg portion 766 of the retainer member 752 and a second tang 784 engaged with an intermediate support 786 of the fastener nest 504. The support shaft 756 extends through aligned openings of the retainer member 752 and an opening of the torsion spring 780 formed by coils of the torsion spring 780. The coils of the torsion spring 780 urge the tangs 782, 784 apart and resiliently bias the retainer member 752 in direction 754 about the support shaft 756. The retainer member 752 has a contact portion 790 engaged with an upper plate 792 of a fastener 794 while a lower plate 796 of the fastener 794 is seated on the fastener support 760. As shown in FIG. 20, the retainer member 752 is pivoted upward in direction 755 from an initial position due to the presence of the fastener 794 in the fastener nest 504. By contrast, the adjacent retainer member 752A is not pivoted in upward direction 755 because there is no fastener in the fastener location associated with the retainer member 752A.

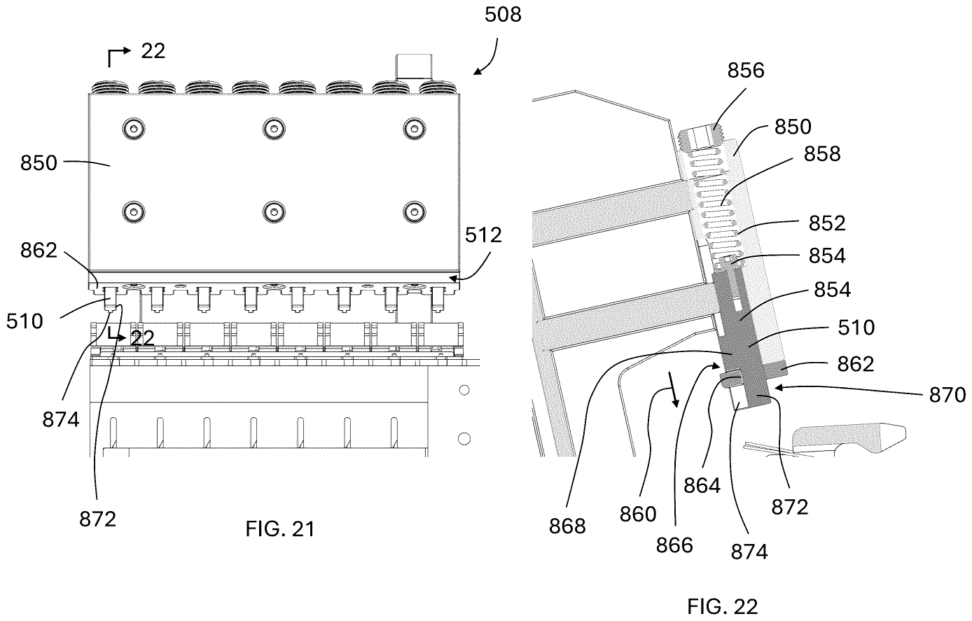

Regarding FIGS. 21 and 22, the head 508 includes a plunger block 850 having one or more openings, such as interiors 852, that receive upper portions 854 of the fastener flattening plungers 510. The head 508 further includes compression nuts 856 that have male threads engaged with female threads of the plunger block 850 and may be tightened or loosened to adjust a compression of a helical spring 858 in the interior 852. The head 508 includes a helical spring 858 for each of the fastener flattening plungers 510 to resiliently urge the plungers 510 in direction 860. The helical springs 858 each provide sufficient force to clench the upper plate 792 of a fastener 794 onto a conveyor belt end upon downward movement of the head 508 in direction 596. Further, the helical springs 858 permit the plungers 510 to shift upward into the plunger block 850 during staple driving and flattening operations of the head 508.

With reference to FIGS. 21 and 22, the staple pusher 512 includes a staple pusher plate 862 having openings 864 therein. The staple pusher plate 862 has a stop 866 that engages a portion 868 of the plunger 510 to limit movement of the plunger 510 in direction 860. The plunger 510 has a lower portion 870 protruding outward from the opening 864 to engage a fastener. The lower portion 870 includes a wider inboard portion 872 to engage a fastener upper plate inboard of staples of the fastener and a narrow outboard portion 874 to fit between the staples of the fastener 794 and engage the fastener upper plate 792.

Regarding FIGS. 18 and 24, the fastener applicator 500 includes a head height adjustment system 900 that is operable to adjust a distance of the head 508 above the anvil bed 501 and accommodate thicker or thinner conveyor belts and associated taller or shorter fasteners. More specifically, regarding FIG. 24, the head height adjustment system 900 includes a wedge block 902 with a rack 904 that is driven by a pinion gear to cause the wedge block 902 to shift in directions 906, 908. Shifting the wedge block 902 in direction 908 configures the fastener applicator 500 to utilize smaller or shorter fasteners while shifting the wedge block 902 in direction 906 configures the fastener applicator 500 to utilize larger or taller fasteners.

More specifically, the head height adjustment system 900 includes the pivot block 910 with an inclined surface 912 engaged with an inclined surface 914 of the wedge block 902. The shifting of the wedge block 902 in direction 906 shifts the pivot block 910 upward in direction 594. The pivot block 910 has a pivot connection 916 with the link 533 such that shifting of the pivot block 910 in direction 594 pivots the link 533 in direction 920. Conversely, shifting the wedge block 902 in direction 908 shifts the pivot block 910 downward in direction 596 and pivots the link 533 in direction 922. The link 533 has a pivot connection 930 with the links 530, 532.

The link 530 has a pivot connection 932 with one of the mounts 518 of the head assembly 506. Shifting the wedge block 902 in direction 908 shifts the pivot block 910 downward in direction 596, pivots the link 533 in direction 922, and pivots the head assembly 506 forward or clockwise in direction 718 about pin 700 (see FIG. 33). The forward pivoting of the head assembly 506 in direction 718 positions the pivot connection 932 at a lower resting position and enables the head assembly 506 to reach a lower final position during operation of the fastener applicator 10.

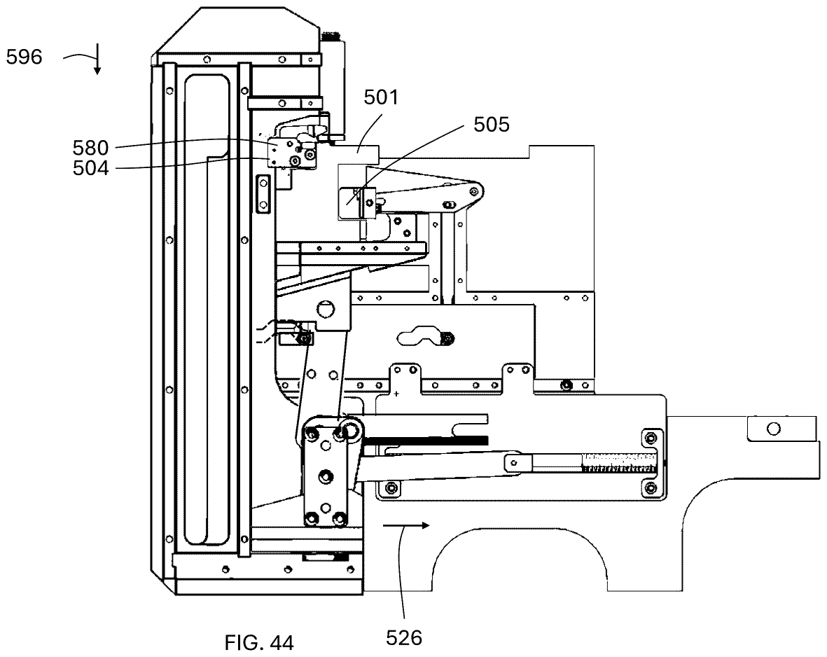

Conversely, shifting the wedge block 902 in direction 906 shifts the pivot block 910 upward in direction 594, pivots the link 533 in direction 920, and pivots the head assembly 506 backward or counterclockwise in direction 719 about the pin 700. The rearward pivoting of the head assembly 506 in direction 719 positions the pivot connection 932 at a higher resting position and causes the head assembly 506 to have a higher final position (see FIG. 44) during operation of the fastener applicator 10. In this manner, the head 508 may be set at a higher or lower height above the anvil bed 501 at the start of a fastener securing operation via operation of the head height adjustment system 900.

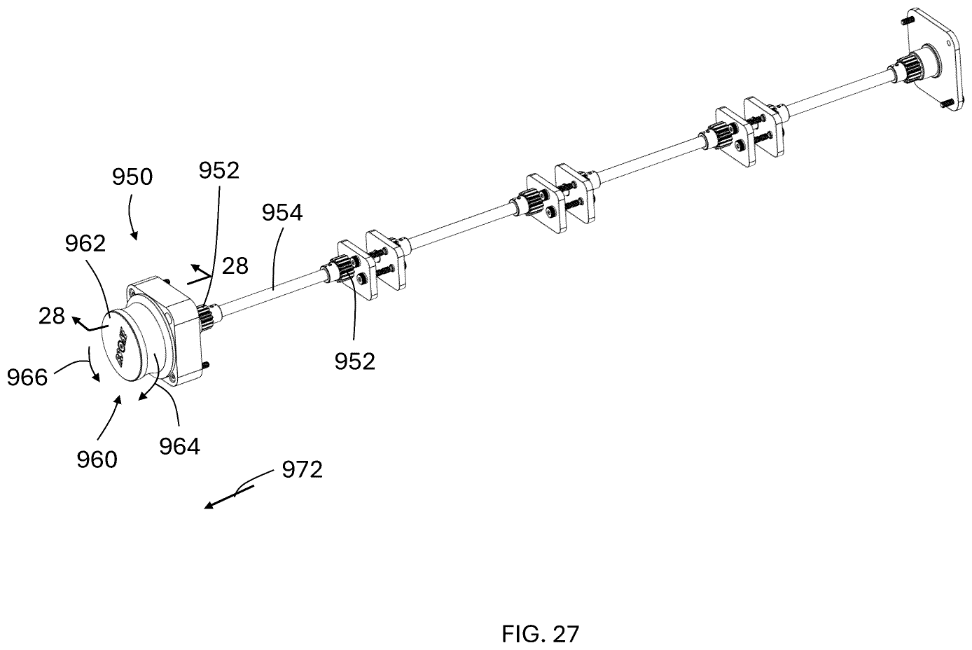

Regarding FIG. 27, in one embodiment, the head height adjustment system 900 includes a head height drive 950. The head height drive 950 has pinion gears 952 to engage the rack 904 and shift the wedge block 902 in directions 906, 908 in response to rotation of the pinion gears 952. The pinion gears 952 have connected shafts 954. Each portion 500A (see FIG. 18) of the fastener applicator 500 may be associated one shaft 954 and two pinion gears 952 that engage racks 904 at opposite sides of the wedge block 902 of the portion 500A.

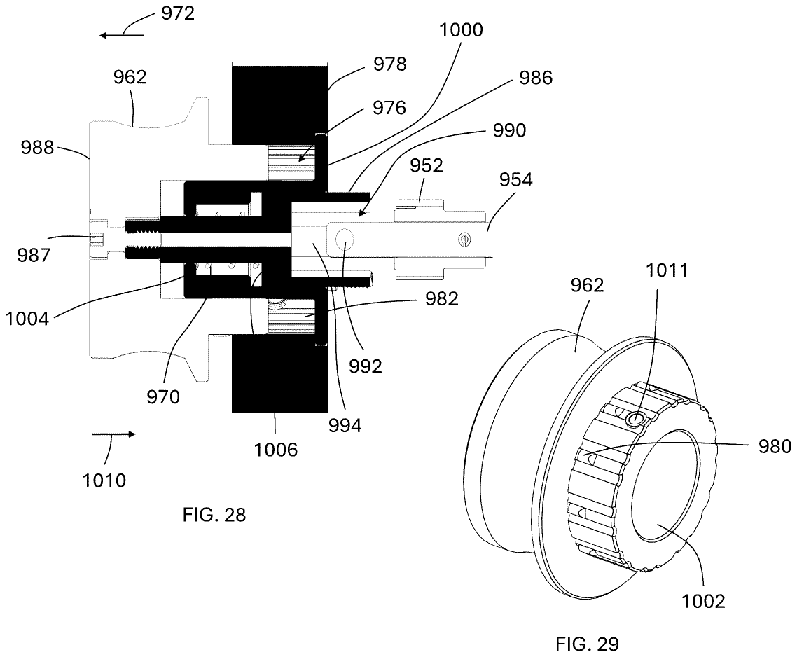

Regarding FIGS. 27 and 28, the head height drive 950 has a user interface 960, such as a knob 962, that a user manipulates to operate the height of the head 508. The knob 962 is connected to the shafts 954 such that turning of the knob 962 in directions 966, 964 causes corresponding turning of the shafts 954 in directions 966, 964. To inhibit unintentional turning of the knob 962 and shafts 954, the head height drive 950 includes a knob housing 978 having a spline connection 976 with the knob 962 formed by meshed splines 980 of the knob 962 and splines 982 of the knob housing 978. The head height drive 950 has a spring 970 that biases the knob 962 in direction 1010 to keep splines 980, 982 engaged. The engaged splines 980, 982 inhibit turning of the knob 962 and shafts 954 in directions 966, 964.

When a user wants to adjust a height of the head 508, the user shifts the knob 962 laterally outward in direction 972 against the bias of the spring 970. Shifting the knob 962 in direction 972 causes the splines 980 of the knob 962 to shift axially out of engagement with the longer splines 982 of the knob housing 978. While the user holds the knob 962 in the laterally outwardly shifted position, the user may turn the knob 962 and cause corresponding rotation of the shafts 954 and pinion gears 952. Once the user has set the head 508 to the desired height, the user releases the knob 962 and permits the spring 970 to return the knob 962 in direction 1010. The return shifting of the knob 962 in direction 1010 re-engages the splines 980, 982 and inhibits unintentional adjustment to the height of the head 508.

Regarding FIG. 28, the knob 962 is secured to a knob drive member 986 via mating portions, such as a hex socket and projection, and a fastener 987. The knob drive member 986 has a slide connection 990 with the shaft 954, such as a pin 992 of the shaft 954 that extends perpendicular to a length of the shaft 954 and into an elongated slot 994 of the knob drive member 986. The elongated slot 994 can slide in directions 972, 1010 along the pin 992 when the knob 962 and knob drive member 986 fixed thereto are shifted in directions 972, 1010. Further, the engagement between the elongated slot 994 and pin 992 enables turning of the knob 962 and knob drive member 986 in directions 964, 966 when the knob 962 has been shifted to the laterally outward position (and disengages the splines 980, 982) to cause corresponding rotation of the shafts 954 and pinion gears 952.

The knob housing 978 includes a knob support 1000 that extends in a central opening 1002 of the knob 962. The spring 970 engages a spring seat surface 1004 of the knob support 1000 and a spring seat surface 1006 of the knob drive member 986. The spring 970 resiliently urges the knob drive member 986 and knob 962 fixed thereto in direction 1010. In the absence of a user pulling the knob 962 axially outward in direction 972, the spring 970 will return the knob 962 and knob drive member 986 fixed thereto in direction 1010 and engage the splines 980 of the knob 962 with the splines 982 of the knob housing 978. Regarding FIG. 29, the knob 962 has a detent 1011, such as a spring-biased ball, for contacting the splines 982 of the knob housing 978 during turning of the knob 962 and providing tactile feedback to the user. For example, the user may feel the detent 1011 clicking past a given number of splines 982 as the user turns the knob 962 in direction 964 or 966 that corresponds to a vertical distance the head 508 has been shifted up or down.

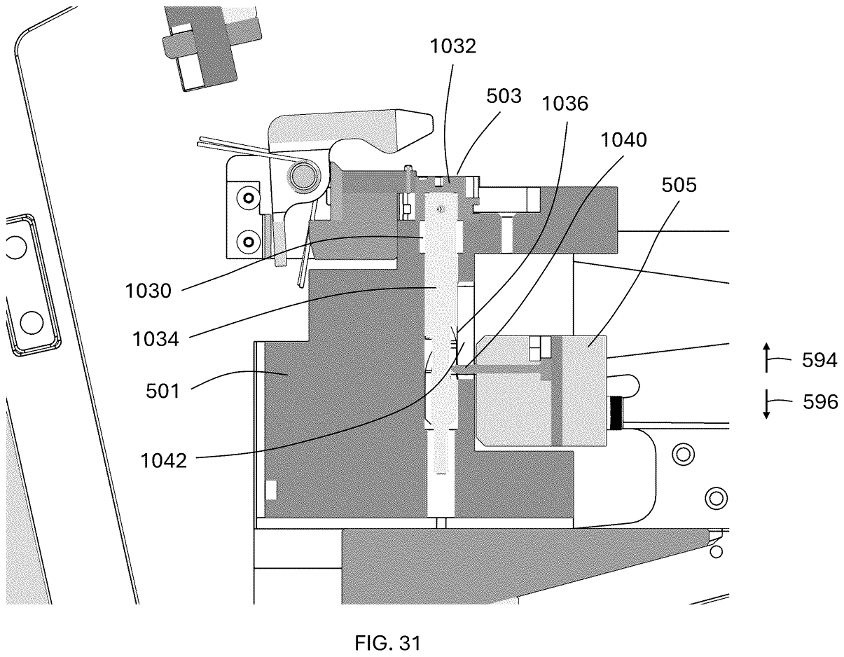

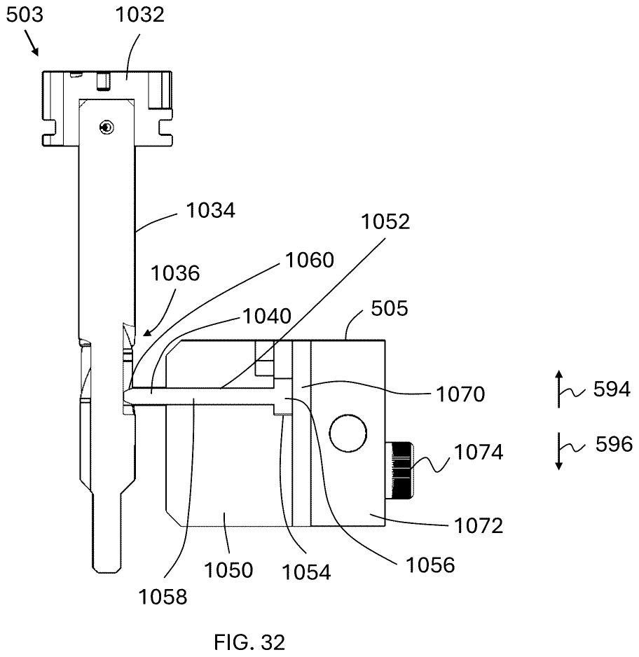

Regarding FIGS. 31 and 32, the anvil 503 is supported for rotation in an opening 1030 of the anvil bed 501. The anvil 503 has a head portion 1032 and a shaft portion 1034 connected thereto. The shaft portion 1034 has a cam path 1036 that is the similar to the cam path 124 discussed above. The anvil drive assembly 505 has a cam drive member 1040 that extends through a slot 1042 of the anvil bed 501 and into engagement with the cam path 1036 of the anvil 503. Up-and-down movement of the anvil drive assembly 505 and cam drive member 1040 thereof in directions 594, 596 causes rotary movement of the anvil 503 in a manner similar to the anvil drive assembly 110 and anvils 80 discussed above.

Regarding FIG. 32, the anvil drive assembly 505 includes a guide 1050 with an opening 1052 that receives a portion of the cam drive member 1040. In one embodiment, the cam drive member 1040 is a machine screw and the opening 1052 has female threads to engage a shank portion 1058 of the cam drive member 1040 and a countersink 1054 to receive a head portion 1056 of the cam drive member 1040. The cam drive member 1040 has an end portion 1060 positioned in the cam path 1036. In one embodiment, the end portion 1060 has a frustoconical outer surface for contacting surfaces of the cam path 1036. The anvil drive assembly 505 further has a clamp plate 1070 and a clamp body 1072 that fix the cam drive member 1040 in the guide 1050 such as by being clamped by a machine screw 1074.

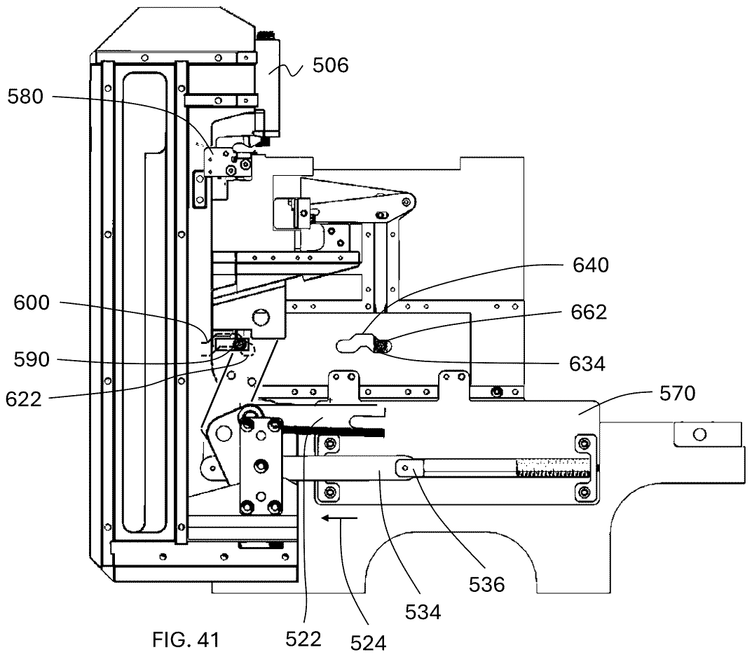

With respect to FIGS. 34 through 49, a method of operating the fastener applicator 500 to apply a fastener to a conveyor belt end is shown. For clarity purposes, the fastener and conveyor belt end are not shown in to provide a clearer depiction of the movement of the components of the fastener applicator 500. Further, although one fastener will be discussed, the fastener applicator 500 is operable to secure all of the fasteners loaded in the fastener nest 504 to the conveyor belt end at once in a manner similar to the fastener applicator 10.

Regarding FIG. 34, the fastener applicator 500 is shown in an initial configuration with the head assembly 506 pivoted backward in an initial, inclined position. A user loads a fastener in the fastener nest 504, with the retainer member 752 contacting the upper plate of the fastener, and positions a conveyor belt end between the upper and lower plates of the fastener in the fastener nest 504. The user secures the conveyor belt end to the fastener applicator 500, such as via clamp assemblies like the clamp assemblies 26 discussed above.

The method begins with the linear actuator of the fastener applicator 500 shifting the ram 522 in direction 524 which pivots the links 530, 532 and the link 533 apart in directions 1080, 1082. The pivoting of the links 530, 532 apart from the link 533 in directions 1080, 1082 pivots the head assembly 506 in direction 718.

As the ram 522 shifts from its initial retracted position in direction 524, the ram 522 causes the trolley link 534 and trolley 536 connected thereto to also shift in direction 524 away from the spring 544 as shown in FIGS. 34-37.

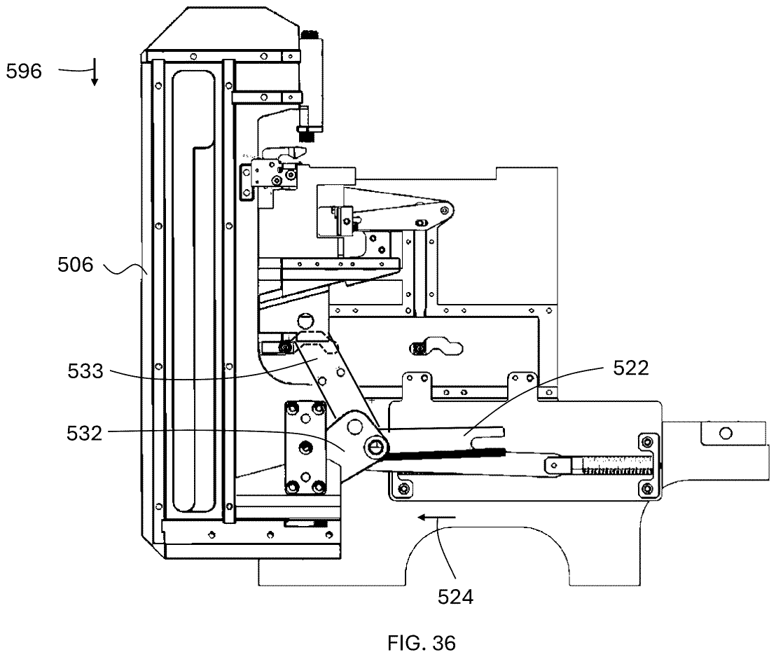

Regarding FIG. 36, the ram 522 has shifted in direction 524 sufficiently far that the links 530, 532 and link 533 have moved the head assembly 506 so that the pin 702 (see FIG. 33) has shifted into the straight portion 720 of the J-shaped guide slot 706 and caused the head assembly 506 to fully pivot in direction 718 to the upright position of FIG. 36.

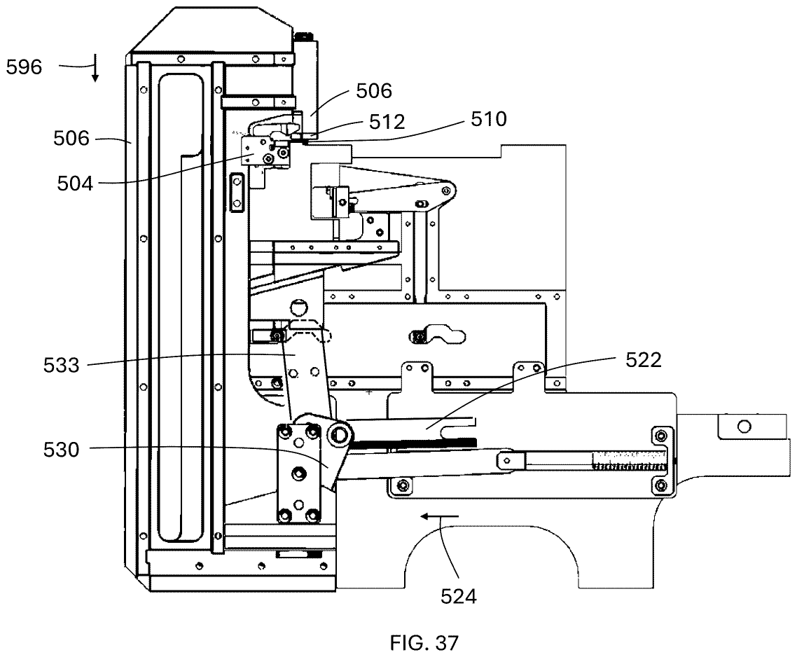

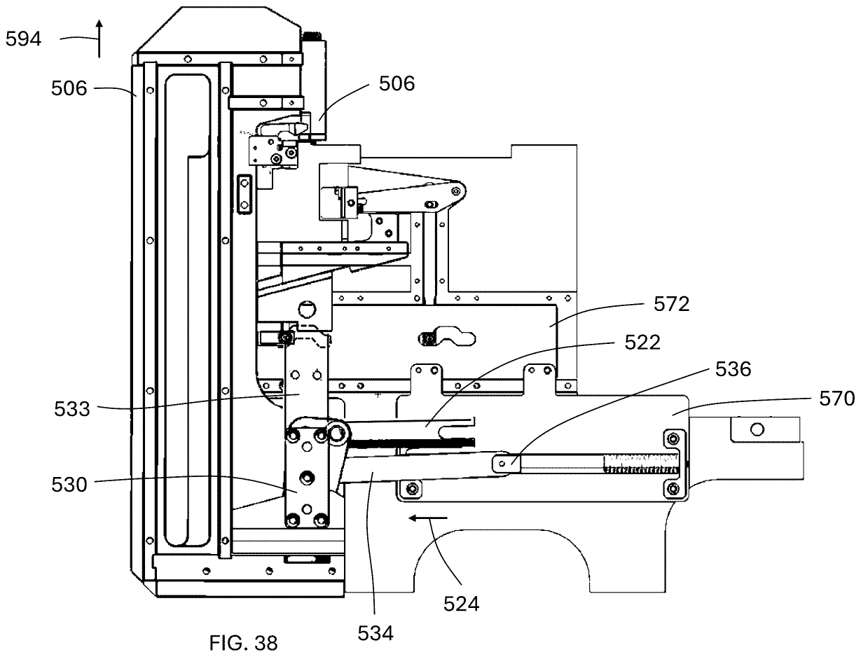

Regarding FIGS. 37 and 38, the ram 522 continues to shift in direction 524 and causes the links 530, 532 and 533 to shift to a more vertical orientation and causes the pin 702 of the head assembly 506 to shift toward the intermediate end portion 730 (see FIG. 33) of the J-shaped guide slot 706. In this manner, the straightening of the links 530, 532, and link 533 shifts the head assembly 506 downward in direction 596 to the position of FIG. 38 wherein the plungers 510 engage the upper plate of the fastener in the fastener nest 504 (see FIG. 19) and clench the upper plate onto the conveyor belt end. The shifting of the head assembly 506 downward in direction 596 also engages the staple pusher plate 862 with the staples of the fastener and drives the staple legs through the conveyor belt, through apertures in the lower plate of the fastener, and causes the staple legs to engage and be bent by grooves 601 (see FIG. 19) of a staple leg initial bend portion 603 of the anvil 503.

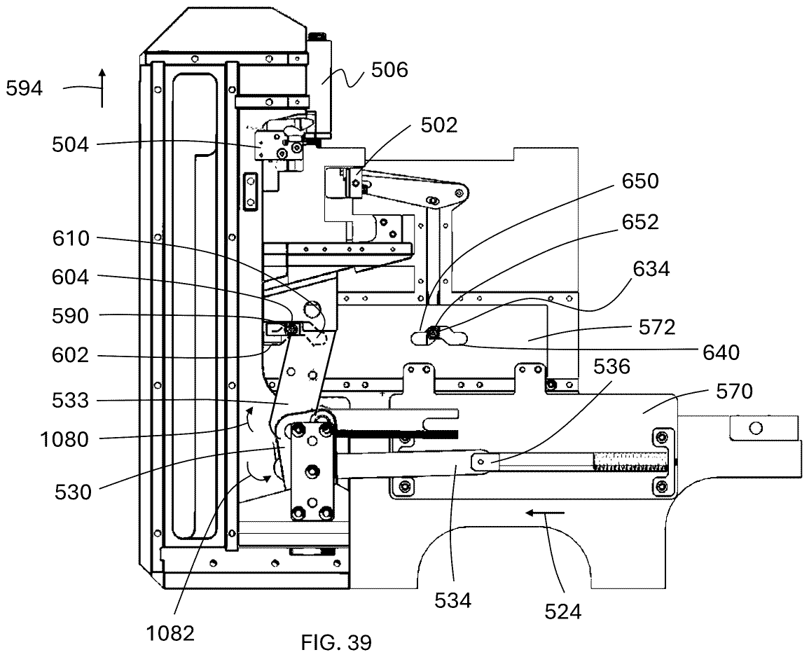

Regarding FIGS. 38 and 39, the ram 522 is driven farther in direction 524 and causes the links 530, 532 and link 533 to pivot in directions 1080, 1082 toward one another. The pivoting of the links 530, 532 and link 533 together in directions 1080, 1082 moves the head assembly 506 so that the pin 702 thereof shifts from the intermediate end portion 730 (see FIG. 33) up along the straight portion 720 of the J-shaped guide slot 706 and the pin 700 shifts upward from the intermediate end portion 729 of the straight guide slot 704. The shifting of the pins 700, 702 along the straight guide slot 704 and the straight portion 720 of the J-shaped guide slot 706 transfer the movement of the links 530, 532 and link 533 into upward shifting of the head assembly 506 in direction 594. The links 530, 532 and link 533 are configured so that pin 702 remains in the straight portion 720 of the J-shaped guide slot 706 when the ram 522 shifts in direction 524 throughout the positions of FIGS. 36-42 and when the ram 522 shifts in direction 526 throughout the positions of FIGS. 42-47. In this manner, the head assembly 506 is constrained to vertical movement in directions 594, 596 in FIGS. 36-47.

As shown by FIGS. 38 and 39, the trolley link 534 has been shifted in direction 524 sufficiently far that the trolley 536 now engages the spring 542 (see FIG. 30) and causes the spring plate 570 and cam plate 572 fixed thereto to shift in direction 524.

The shifting of the spring plate 570 and cam plate 572 in direction 524 causes the roller 590 of the nest assembly 580 to shift from the initial idle portion 602 to the lifting portion 604 of the nest assembly cam path 600 as shown in FIG. 39. This causes the nest assembly 580 to shift upward in direction 594 and position the fastener in the nest assembly 502 and the fastener support 760 above and in clearance with the anvil 503 to permit rotation thereof. The shifting of the cam plate 572 in direction 594 from the position of FIG. 38 to the position of FIG. 39 also shifts the rocker roller 634 from the initial idle portion 650 to the lifting portion 652 of the rocker cam path 640. This causes the rocker rod 632 to shift upwardly, causes the rocker 623 to pivot upwardly, and shifts the anvil drive assembly 505 upward in direction 594.

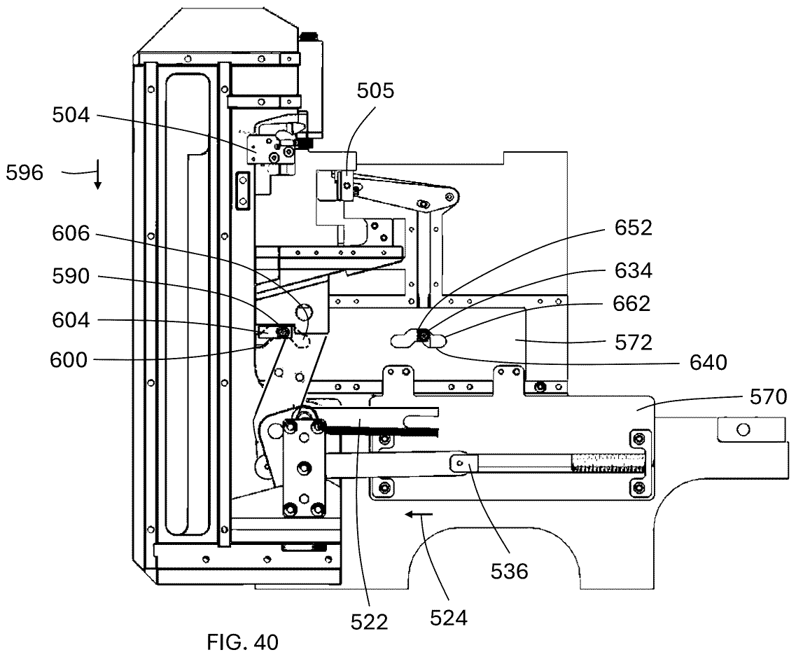

Regarding FIGS. 40-42, the ram 522 continues to shift in direction 524 and causes the trolley 536 to continue urging the spring 542, spring plate 570, and cam plate 572 in direction 524. The rollers 590, 634 shift from the lifting portions 604, 652 to the intermediate idle portions 606, 662 of the respective nest assembly cam path 600 and the rocker cam path 640. This causes the fastener nest assembly 580 and anvil drive assembly 505 to shift downward in direction 596. The anvil drive assembly 505 completes the movement downward in direction 596 before the head of the nest assembly 580 to permit the anvil drive assembly 505 to complete the turning of the anvil 503 180° from the initial bend position to the final set rotary position. When the anvil 503 is in the final set rotary position, the anvil 503 has a final bend portion with a flat surface 799 (see FIG. 19) positioned under the lower plate of the fastener for final bending of the staple legs.

Regarding FIG. 42, the fastener apparatus 500 is shown halfway through the fastener securing operation with the ram 522 shown in a fully extended position. In the configuration of FIG. 42, the fastener apparatus 500 has clenched the fastener onto the conveyor belt end, driven the staple legs through the conveyor belt, and initially bent the staple legs against the lower plate of the fastener. Further, the fastener nest 504 has been lowered in FIG. 42 to position the initially bent staple legs of the fastener against the flat surface 799 (see FIG. 19) of the anvil 503.

Regarding FIGS. 42-45, the ram 522 is next shifted back toward a retracted position in direction 526. The movement of the ram 522 in direction 526 pivots the links 530, 532 and link 533 in directions 1200, 1202, moves the head assembly 506 back downward in direction 596, and causes the head 508 to engage the fastener staples and perform the final set operation including bending the staple legs against the flat surface 799 of the anvil 503.

The shifting of the ram 522 in direction 526 causes the trolley 536 to disengage from the spring 542 and shift along the guide shaft 540. The spring plate 570 and cam plate 572 are idle as the trolley 536 moves in direction 526 away from the spring 542 and before the trolley 536 contacts the spring 544 at the other end of the shaft 540.

Shifting of the ram 522 in direction 526 in FIGS. 42-45 pivots the links 530, 532 and link 533 in directions 1200, 1202 and moves the head assembly 506 downward in direction 596 to perform a final set operation wherein the head 508 performs final bending of the staple legs against the flat surface 799 of the anvil 503. In FIG. 44, the head 508 has traveled fully downward in direction 596 and has completed the final bending of the fastener staple legs.

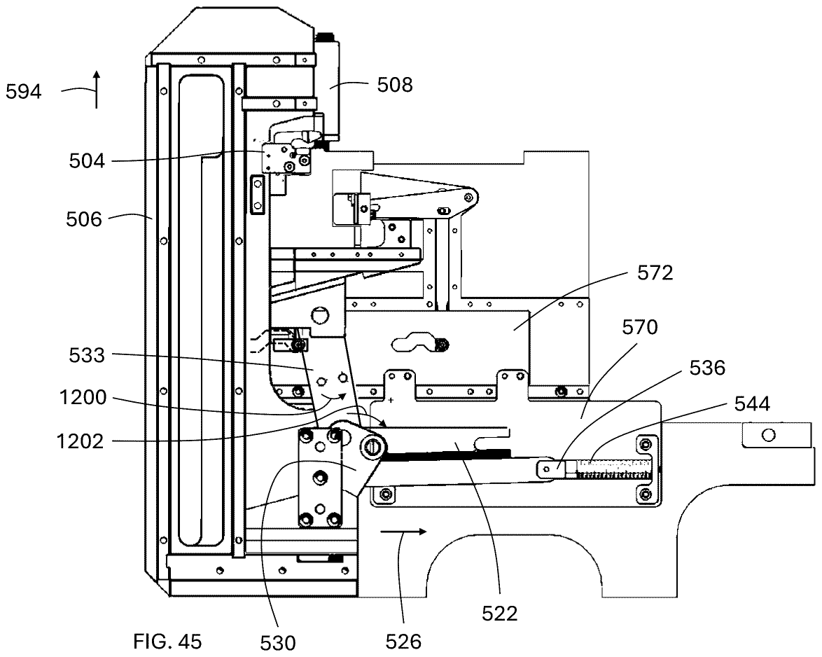

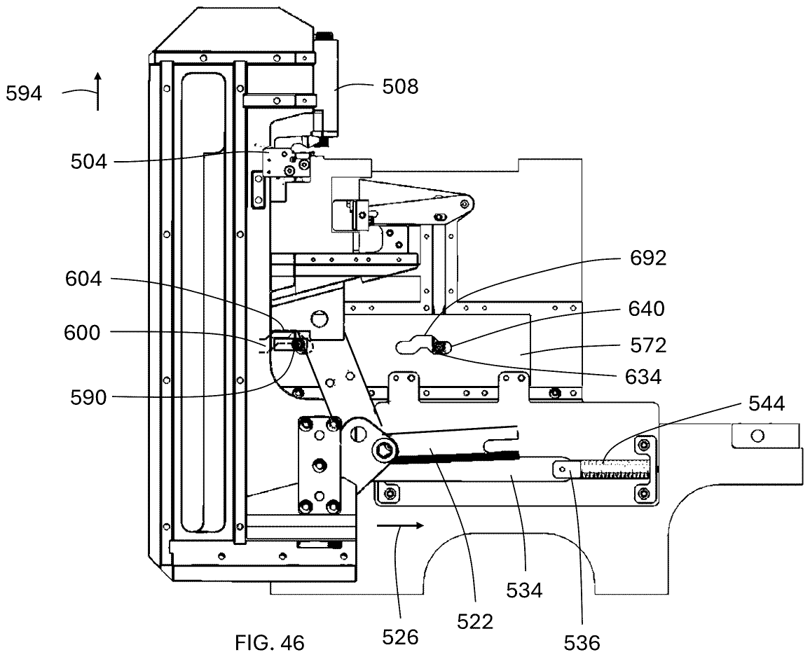

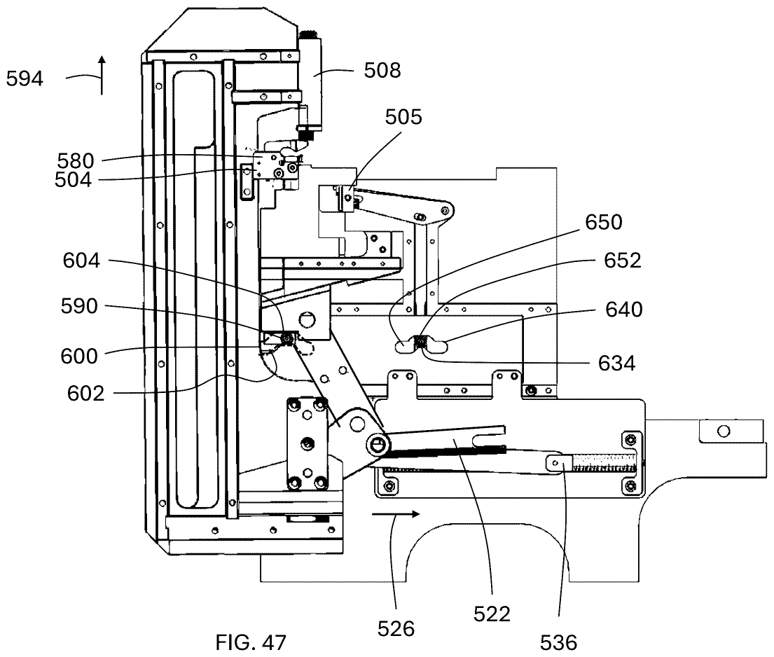

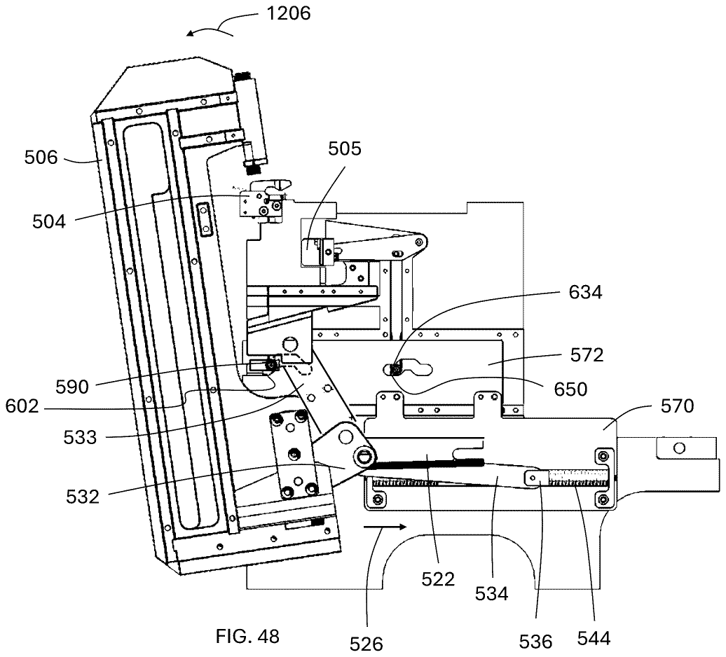

Regarding FIGS. 45 and 46, the ram 522 is shifted farther in direction 526 to cause the head 508 to shift upwardly in direction 594 and cause the trolley 536 to engage the spring 544 and shift the spring plate 570 and cam plate 572 in direction 526. The shifting of the cam plate 572 in direction 526 causes the rollers 590, 634 to shift into the lifting portions 604, 652 of the nest assembly cam path 600 and the rocker cam path 640. This causes the nest assembly 580 and the anvil drive assembly 505 to shift upwardly in direction 594 as shown in FIGS. 46-47. The nest assembly 580 is raised in FIGS. 45-47 as the head 508 raises. Further, the anvil drive assembly 505 is raised in FIGS. 46-47 after the nest assembly 580 has been raised to avoid contact between the nest assembly 580 (and fastener received therein) and the rotation of the anvils 503 caused by the raising of the anvil drive assembly 505.

Regarding FIGS. 47-49, the ram 522 continues to shift in direction 526 and pivot the links 530, 532 and link 533 to move the head assembly 506. Regarding FIGS. 47 and 48, movement of the head assembly 560 causes the pin 702 to slide along the curved surface 710 of the J-shaped guide slot 706. This causes the head assembly 506 to pivot in direction 1206 back to its initial, inclined position that permits access to the fastener nest 504 and enables a user to unload the conveyor belt end and fastener secured thereto from the fastener applicator 500.

Regarding FIGS. 47-49, the shifting of the ram 522 in direction 526 tightly engages the trolley 536 with the spring 544 and continues to shift the spring plate 570 and cam plate 572 in direction 526. This causes the rollers 590, 634 to shift from the lifting portions 604, 652 to the initial idle portions 602, 650 of the nest assembly cam path 600 and the rocker cam path 640. In this manner, the fastener nest 504 and anvil drive assembly 505 are lowered back to the initial positions thereof. As noted above, the second up-and-down movement of the anvil drive assembly 505 of FIGS. 46-48 causes the anvils 503 to rotate 180° and return to the initial staple leg bend positions thereof.

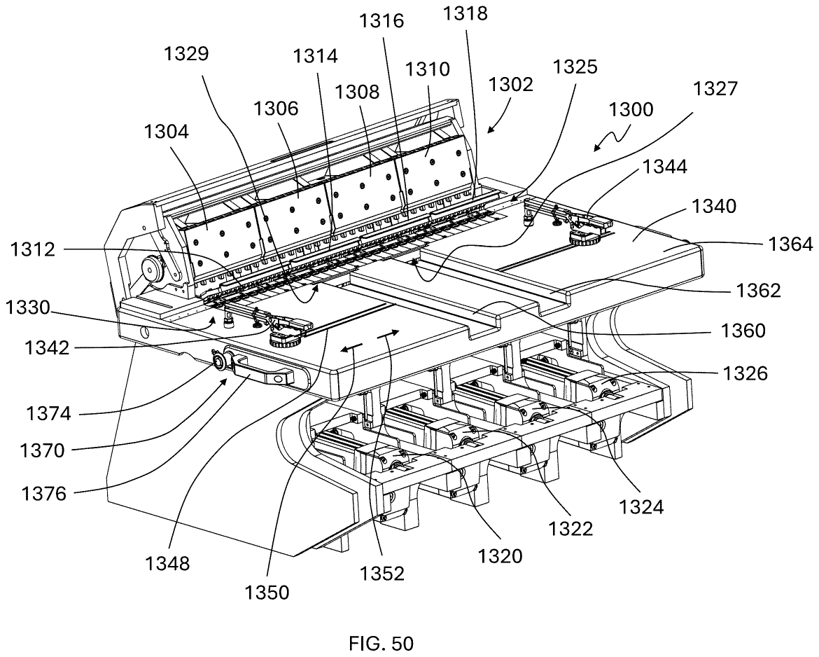

Regarding FIG. 50, a fastener applicator 1300 is provided that is similar in many respects to the fastener applicator 10 discussed above such that differences will be highlighted. The fastener applicator 1300 has an applicator head 1302 that includes heads 1304, 1306, 1308, 1310. The fastener applicator 1300 further includes anvil bed assemblies 1325, 1327, 1329, 1330 and fastener nests 1312, 1314, 1316, 1318 that cooperate with the heads 1304, 1306, 1308, 1310 to simultaneously secure all of the fasteners loaded into the fastener applicator 1300 to a conveyor belt end. The fastener applicator 1300 has actuators 1320, 1322, 1324, 1326 that are operated to cause movement of the heads 1304-1310, anvil bed assemblies 1325-1330, and fastener nests 1312-1318 during a fastener securing operation. The head 1304, fastener nest 1312, and anvil bed assembly 1330 will be discussed below but the other heads, fastener nests, and anvil bed assemblies are similar. The fastener applicator 1300 is modular in that the number of heads, anvil bed assemblies, fastener nests, and associated components of the fastener applicator 1300 may be selected to correspond to a given conveyor belt width.

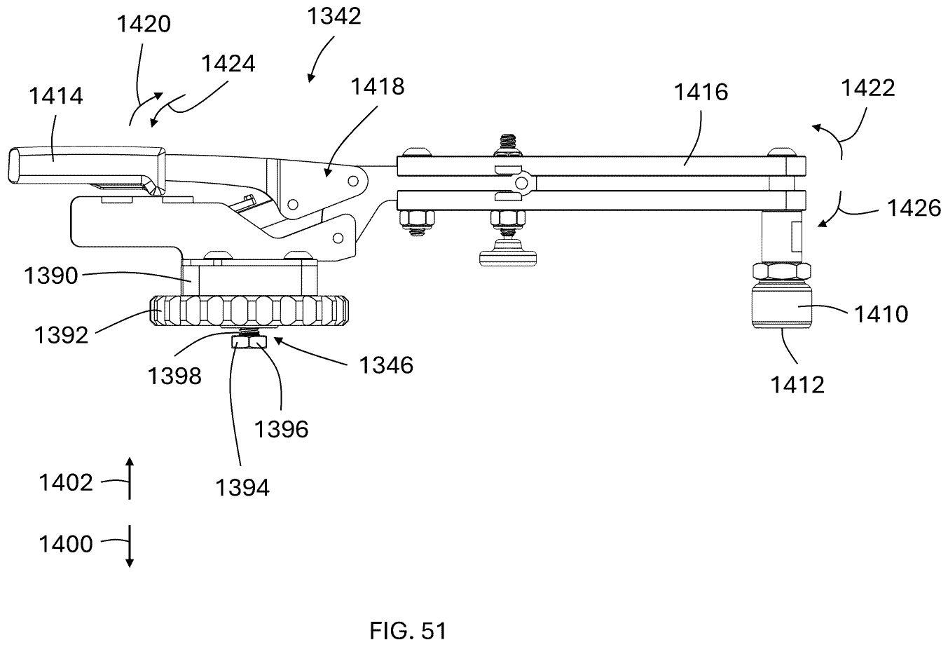

The fastener applicator 1300 has a conveyor belt support such as a table 1340 to support the conveyor belt end and belt clamps 1342, 1344 to secure the conveyor belt end to the table 1340. The belt clamps 1342, 1344 have mounting portions 1346 (see FIG. 51) received in T-slots 1348 of the table 1340 that permit the belt clamps 1342, 1344 to be shifted in directions 1350, 1352 to accommodate belts of varying widths.

Some conveyor belts have a guide on the underside of the belt to engage correspondingly shaped features on rollers (e.g., V-shaped recesses) and guide the belt along its path. To accommodate the guides of these belts, the table 1340 has channels 1360, 1362 that permit a user to position the guide of the belt in either one of the channels 1360, 1362. In this manner, the conveyor belt end may be positioned on an upper surface 1364 of the table 1340 while the guide of the belt extends into one of the channels 1360, 1362.

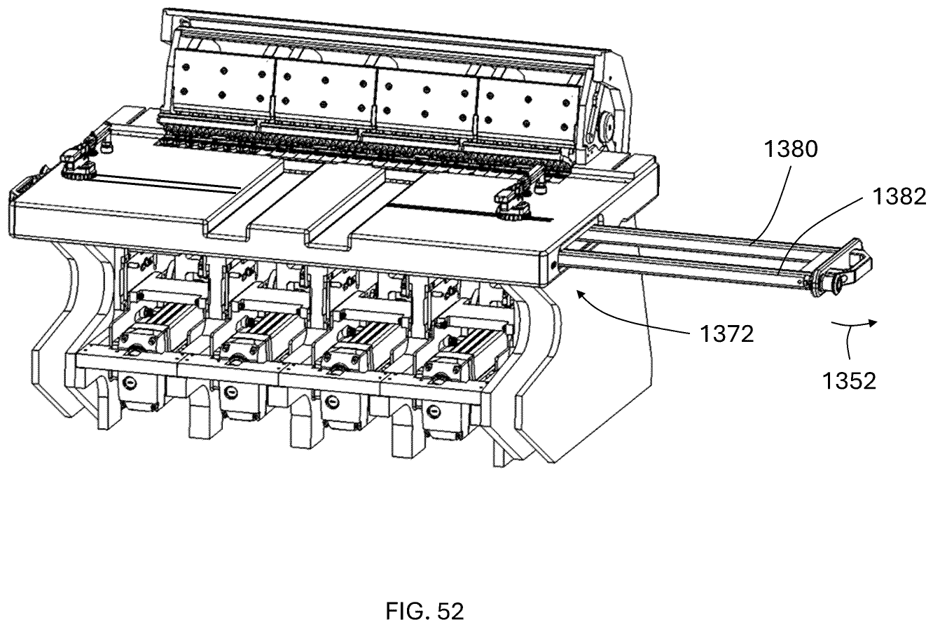

For belts that are wider than the table 1340, the fastener applicator 1300 has table extensions 1370, 1372 (see FIGS. 50, 52) on opposite lateral sides of the table 1340. Each of the table extensions 1370, 1372 includes a button 1374 that is pressed to disengage a locking mechanism and a handle 1376 that is pulled to shift the table extensions 1370, 1372 laterally outward in directions 1350, 1352. Regarding FIG. 52, the table extensions 1370, 1372 each have elongate support members 1380, 1382 for supporting the underside of a conveyor belt end.

Regarding FIG. 51, the belt clamp 1342 has a base 1390 with a knob 1392 rotatable relative to the base 1390 and a bolt 1394. The bolt 1394 has a head 1396 for being received in a wide portion of the T-slot 1348 and a shank 1398 for being received in a narrow portion of the T-slot 1348. The knob 1392 may be turned in a loosening direction to shift the bolt 1394 downwardly in direction 1400 or turned in a tightening direction to shift the bolt upwardly in direction 1402. Once the user has positioned the belt clamp 1342 at a desired location along the T-slot 1348, the user turns the knob 1392 in a tightening direction to shift the bolt head 1396 upward in direction 1402 to clamp the bolt head 1396 tightly against a surface of the T-slot 1348. Conversely, to change a position of the belt clamp 1342, the user turns the knob 1392 in a loosening direction to release the bolt head 1396 from engagement with surface of the T-slot 1348.

The belt clamp 1342 has a clamp member 1410 with a clamping surface 1412 for engaging the conveyor belt end. The belt clamp 1342 has a handle 1414, an arm 1416 supporting the clamp member 1410, and a linkage 1418 to transfer movement of the handle 1414 to movement of the arm 1416. Specifically, the belt clamp 1342 may be opened or released by pivoting a handle 1414 in direction 1420 which causes the arm 1416 and clamp member 1410 attached thereto to pivot upward in direction 1422 away from the table 1340 to provide clearance for a user to position a conveyor belt on the table 1340. The user may then lock the belt clamp 1342 by pivoting the handle 1414 in direction 1424, which causes the arm 1416 and clamp member 1410 secured thereto to pivot downwardly in direction 1426 and clamp the conveyor belt end between the clamp member 1410 and table 1340.

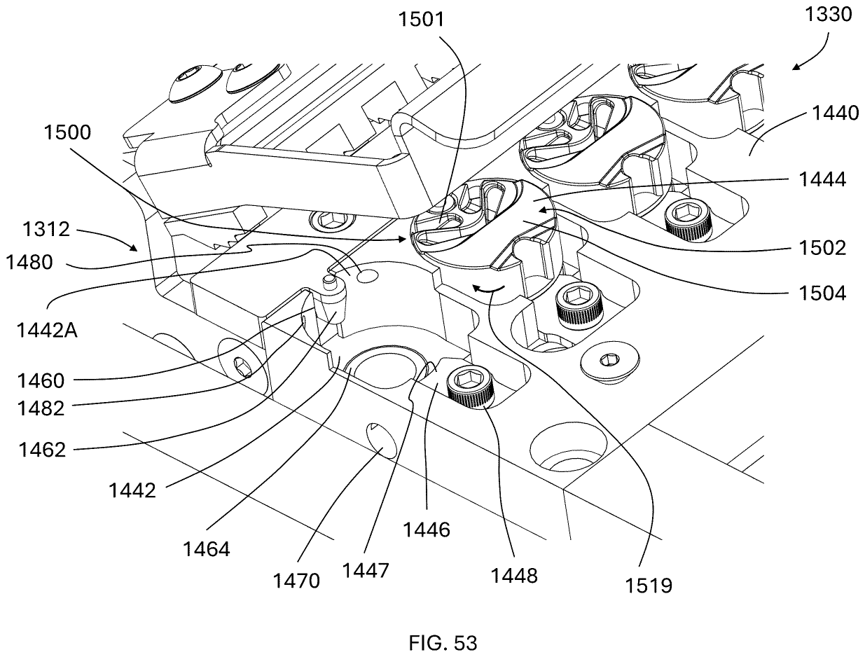

Regarding FIG. 53, the anvil bed assembly 1330 includes an anvil bed 1440 having openings 1442 that receive anvils 1444 and anvil holders 1446 secured in the openings 1442 via screws 1448. The anvils 1444 each have an initial staple leg bending portion 1500 with grooves 1501 to initially bend the staple legs as the staple legs are driven through the conveyor belt and lower apertures of the fastener and a final set portion 1502 with a flat surface 1504 for performing final bending of the staple legs. In FIG. 53, the anvil 1444 of opening 1442A is removed to show the associated anvil holder 1446 projecting radially inward from the screw 1448.

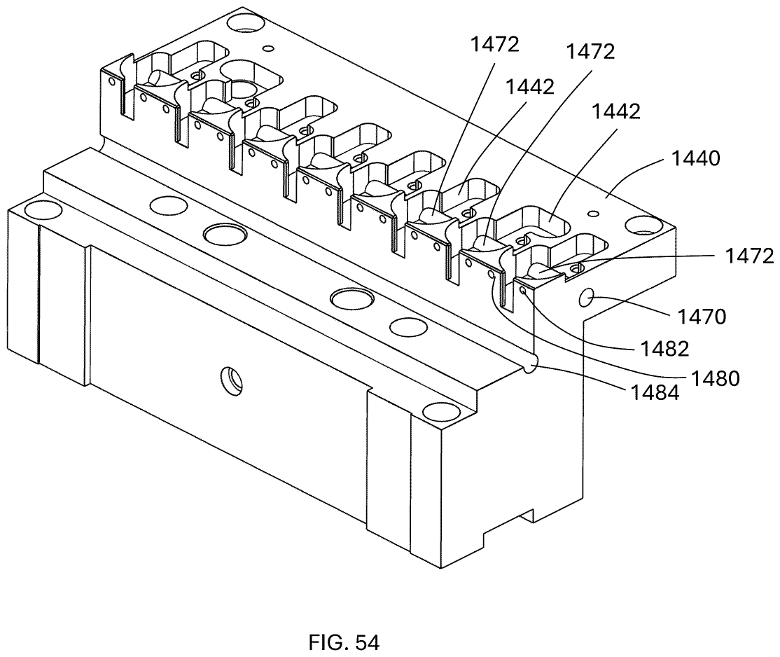

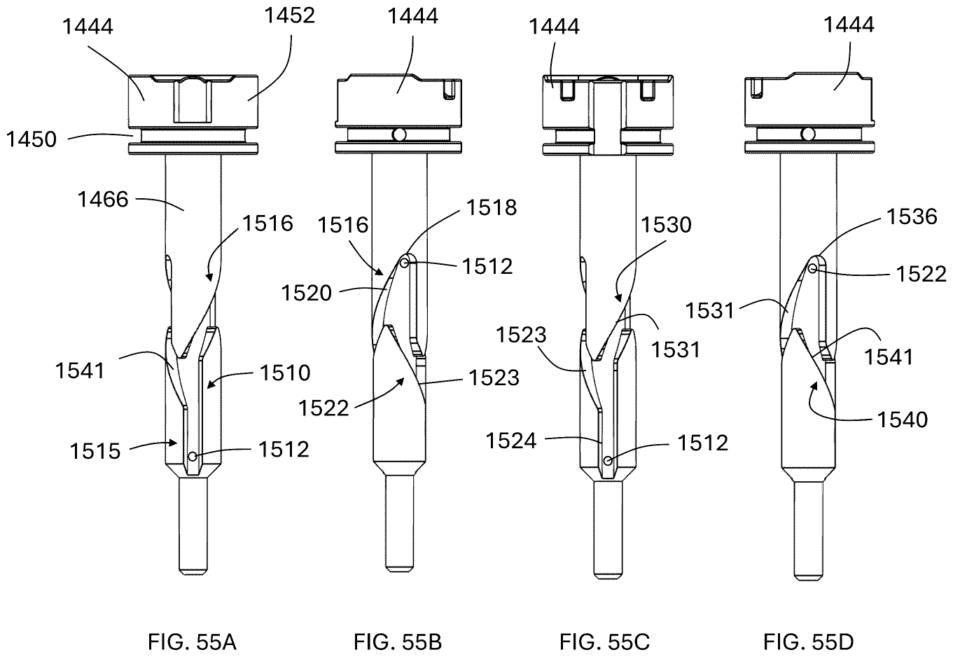

The anvil holders 1446 each have an arcuate portion 1447 that extends into an annular channel 1450 (see FIG. 55A) of a head portion 1452 of a respective anvil 1444. The anvil bed 1440 has a slot 1460 that receives a protrusion 1462 of the fastener nest 1312 and has a bushing 1464 that rotatably supports a shaft portion 1466 (see FIG. 55A) of the associated anvil 1444. The anvil bed 1440 has an air inlet opening 1470 that opens to a channel 1472 (see FIG. 54) extending laterally throughout the anvil bed 1440. A user may direct air from a compressed air source into the air inlet opening 1470 and through the channel 1472 to provide airflow into all of the openings 1442 of the anvil bed 1440. Further, the anvil bed 1440 includes openings 1480, 1482 on opposite sides of the openings 1442 from the channel 1472. The airflow from the channel 1472 travels around the anvils 1444 in the openings 1442 and carries debris (e.g., dirt, metallic particles, belt pieces) out of the openings 1442, through the openings 1480, 1482, and into a debris receiving channel 1484 (see FIG. 54). The debris receiving channel 1484 may be cleaned using a roller brush or compressed air as some examples. In this manner, the anvil bed 1440 facilitates removal of debris from the openings 1442 that could adversely affect turning of the anvils 1444 in the openings 1442.

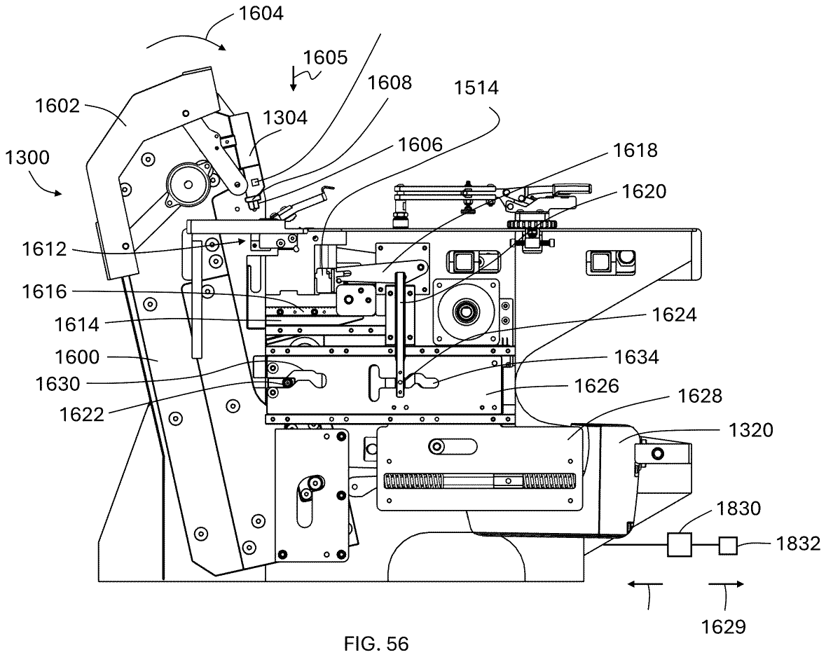

Regarding FIGS. 55A-55D, the shaft portion 1466 of the anvil 1444 has a cam path 1510 that receives a cam drive member 1512 of an anvil drive assembly 1514 (see FIG. 56). The cam path 1510 is configured to cause rotation of the anvil 1444 in response to the up-and-down movements of the cam drive member 1512 that occur during the fastener securing operation of the fastener applicator 1300.

Regarding FIGS. 55A and 55B, the cam path 1510 has a first lower end portion 1515 where the cam drive member 1512 starts, a first helical portion 1516, and a first upper end portion 1518. The cam drive member 1512 travels from the first lower end portion 1515 to the first upper end portion 1518 in response to an upward movement of the anvil drive assembly 1514. The upwardly moving cam drive member 1512 engages a first rotary cam surface 1520 of the first helical portion 1516 and causes the anvil 1444 to turn 90° in direction 1519 (see FIG. 53).

Regarding FIGS. 55B and 55C, the cam path 1510 has a second helical portion 1522 and a second lower end portion 1524. As the anvil drive assembly 1514 shifts downwardly, the cam drive member 1512 travels from the first upper end portion 1518, through the second helical portion 1522, and into the second lower end portion 1524. The cam drive member 1512 engages a second rotary cam surface 1523 of the second helical portion 1522 as the cam drive member 1512 travels through the second helical portion 1522 and causes the anvil 1444 to turn 90° in direction 1519. Regarding FIG. 55C, the cam drive member 1512 is at the second lower end portion 1524 of the cam path 1510 when the fastener applicator 1300 is generally halfway through a fastener securing operation.

In response to the anvil drive assembly 1514 moving upwardly a second time during the fastener securing operation, the cam drive member 1512 travels from the second end portion 1524, through a third helical portion 1530, and into a second upper end portion 1536 of the cam path 1510. As the cam drive member 1512 travels through the third helical portion 1530, the cam drive member 1512 engages a third rotary cam surface 1531 of the third helical portion 1530 and causes the anvil 1444 to turn 90° in direction 1519.

As the anvil drive assembly 1514 shifts downwardly for a second time during the fastener securing operation, the cam drive member 1512 travels from the second upper end portion 1536, through a fourth helical portion 1540, and returns to the first lower end portion 1515. The cam drive member 1512 engages a fourth rotary cam surface 1541 of the fourth helical portion 1540 and causes the anvil 1444 to turn 90° in direction 1519. The camming engagement between the cam drive member 1512 and the fourth rotary cam surface 1541 returns the anvil 1444 to the initial staple bend rotary position of FIG. 53.

Regarding FIG. 56, the fastener applicator 1300 has a movable head assembly 1600 that includes the head 1304 and a hood 1602 that is pivotal from an open position of FIG. 56 to a closed position in direction 1604 to inhibit a user from interfering with a fastener securing operation.

The head 1304 includes a plunger 1606 to clench an upper plate of a fastener onto a conveyor belt end, a staple pusher 1608 to drive staples of the fastener through the conveyor belt, and a sensor 1610 to detect the plunger 1606 contacting the fastener as will be described below.

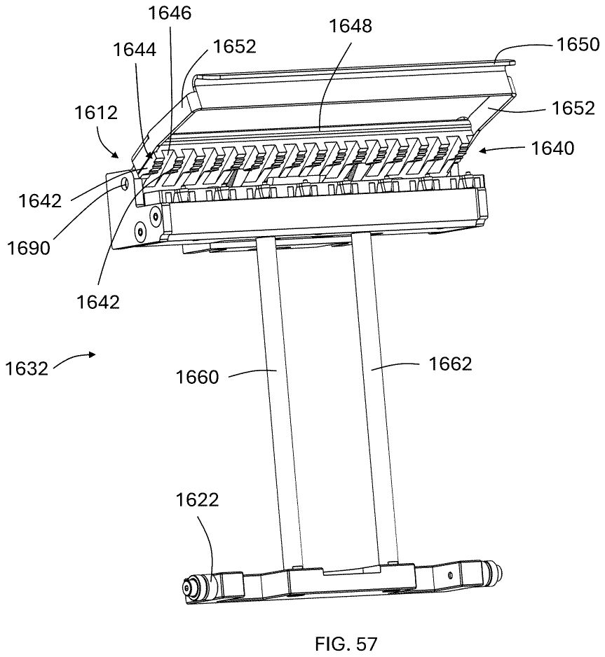

The fastener applicator 1300 includes linkages and other components similar to the fastener applicator 10 discussed above, including a fastener nest 1612, a wedge block 1614 with a rack 1616, a rocker 1618, a shaft 1620, rollers 1622, 1624 that ride in cam paths 1630, 1634 of a cam plate 1626, and a spring plate 1628. The nest assembly cam path 1630 receives the roller 1622 of the nest assembly 1632 (see FIG. 57) and the rocker assembly cam path 1634 receives the rocker roller 1624. The cam plate 1626 and spring plate 1628 are shifted in directions 1627, 1629 to cause corresponding movement of the fastener nest 1612, anvil drive assembly 1514 in a manner similar to the approach discussed above with respect to the fastener applicator 500.

Regarding FIG. 57, the nest assembly 1632 includes the fastener nest 1612 with a fastener retainer 1640 for securing fasteners therein. The fastener retainer 1640 includes retainer members 1642 having teeth 1644 to engage differently sized fasteners as discussed in greater detail below. The retainer members 1642 have lateral spacings 1646 therebetween. The retainer members 1642 are mounted to an upper member 1648 that is fixed to a handle 1650 with arm portions 1652. The assembly of the upper member 1648, retainer members 1642, and handle 1650 are pivotal about a shaft 1690 of the fastener nest 1612. In this manner, the fastener nest 1612 is different from the fastener nest 12 discussed above because the retainer members 1642 move together rather than independently like the retainer members 88.

The nest assembly 1632 includes connecting rods 1660, 1662 that facilitate lifting and lowering of the fastener nest 1612 as the roller 1622 travels along the nest assembly cam path 1630 of the cam plate 1626.

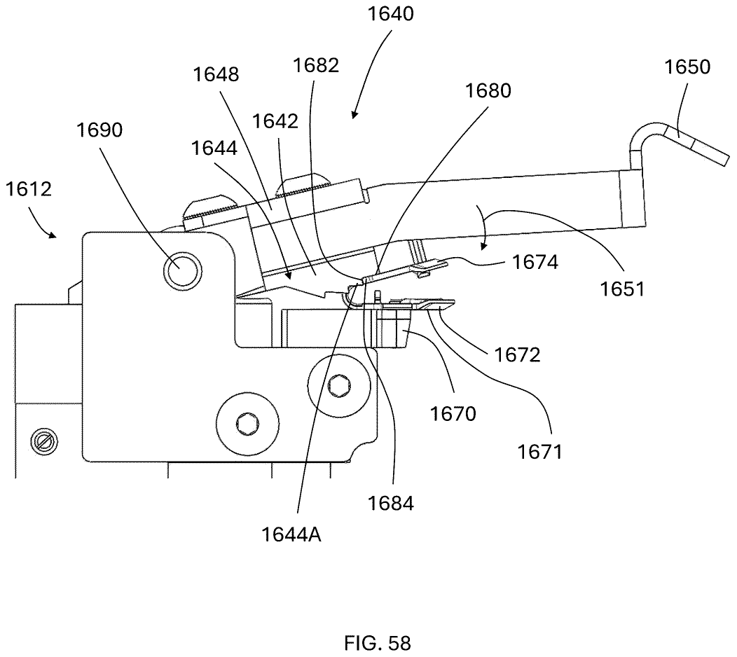

Regarding FIG. 58, the fastener nest 1612 includes a fastener support 1670 for supporting a lower plate 1671 of a fastener 1672. The handle 1650 is shown pivoted downwardly to the closed position so that the retainer member 1642 engages an upper plate 1674 of the fastener 1672. Specifically, the retainer member 1642 has a lower surface 1680 engaged with an upper surface of the upper plate 1674 and a tooth 1644A with an outboard surface 1682 engaged with an outboard end 1684 of the upper plate 1674. Because the retainer member 1642 can pivot with the upper member 1648 about the pivot shaft 1690 of the fastener nest 1612, the surfaces 1680, 1682 of the retainer member 1642 remain engaged with the upper plate 1674 as the upper plate 1674 pivots onto the conveyor belt end during the fastener clenching operation of the head 1304 (see, e.g., FIGS. 8 and 9).

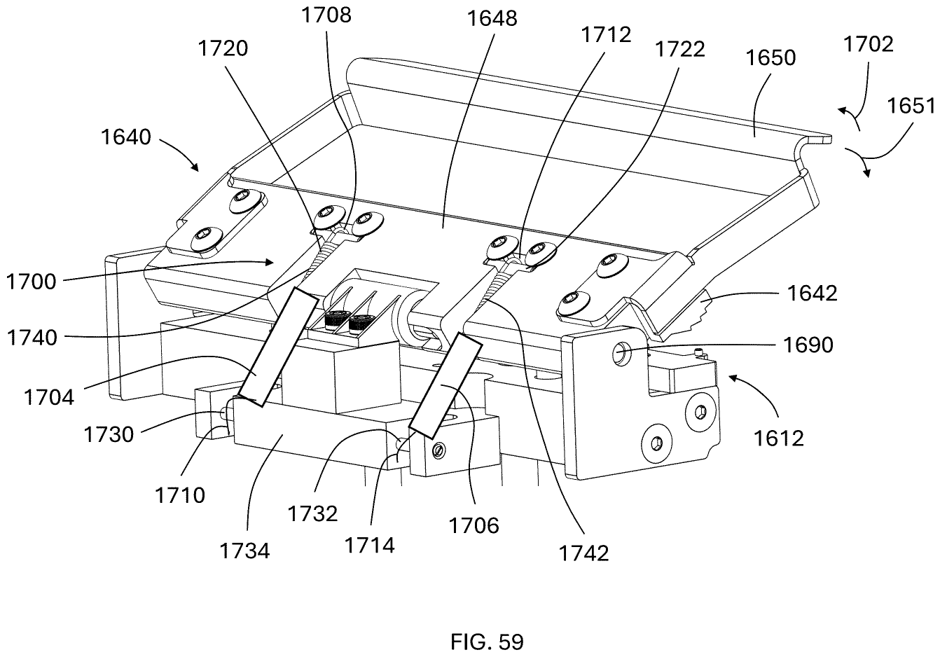

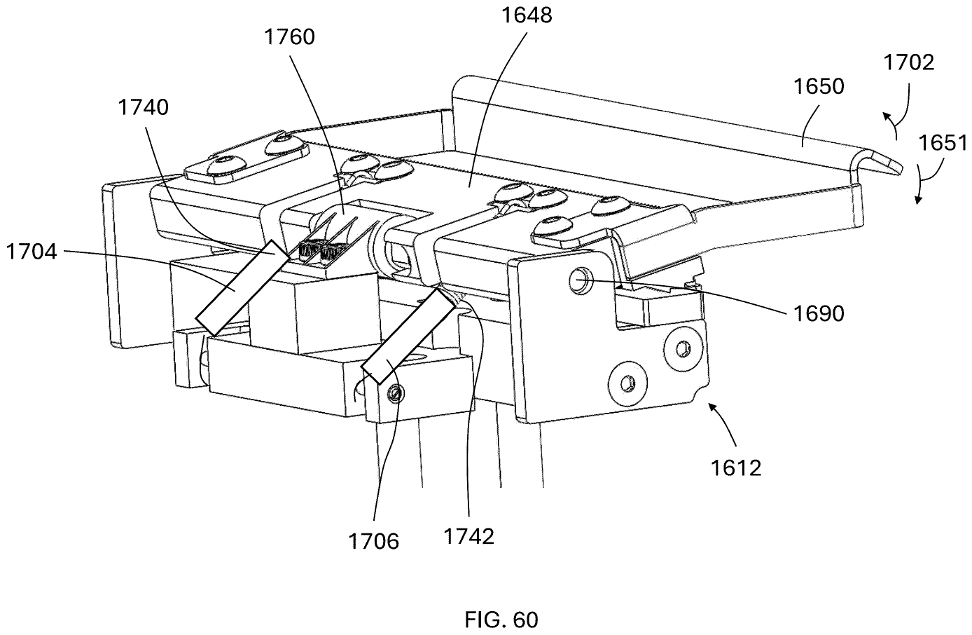

Regarding FIGS. 59 and 60, the fastener retainer 1640 has an over-center locking mechanism 1700 that keeps the retainer members 1642 engaged with the fasteners 1672 and resists pivoting of the handle 1650 in direction 1702. More specifically, the over center locking mechanism 1700 includes one or more biasing members, such as helical springs 1704, 1706, having upper end portions 1708, 1710 secured to upper anchor portions, such as pins 1720, 1722, of the upper member 1648 and lower end portions 1712, 1714 secured to lower anchor portions, such as pins 1730, 1732, of a rear portion 1734 of the fastener nest 1612.

The helical springs 1704, 1706 have intermediate portions 1740, 1742 above the pivot shaft 1690 when the upper member 1648, handle 1650, and retainer members 1642 are in the upper, open position of FIG. 59. However, once the handle 1650 is pivoted downwardly in direction 1651 to engage the retainer 1640 with the fasteners in the fastener nest 1612, the intermediate portions 1740, 1742 shift below the pivot shaft 1690. In this manner, the helical springs 1704, 1706 apply a bias force to the upper member 1648 to the right of the pivot shaft 1690 as shown in FIG. 60 which resists the upper member 1648, retainer members 1642, and handle 1650 pivoting upward in direction 1702. The fastener nest 1612 has a damper 1760 that slows rotational movement of the upper member 1648, retainer members 1642, and handle 1650 in directions 1651, 1702 to keep the retainer 1640 from snapping open or closed.

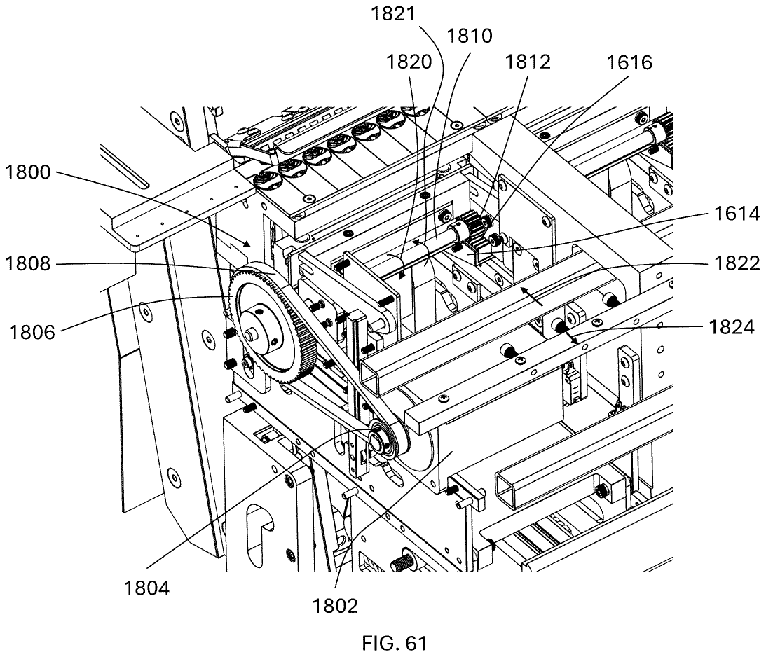

Regarding FIG. 61, the fastener applicator 1300 includes a belt height adjustment system 1800 with an electric motor 1802, such as a stepper motor, a drive pulley 1804, a follower pulley 1806, and a belt 1808. Rotation of the follower pulley 1806 causes rotation of a shaft 1810 having pinions 1812 thereon that are engaged with the racks 1616 of the wedge block 1614. In this manner, the electric motor 1802 may rotate the drive pulley 1804 in a first direction to cause movement of the belt 1808 and rotation of the follower pulley 1806, shaft 1810, and pinions 1812 in direction 1820. Rotation of the pinions 1812 in direction 1820 causes shifting of the wedge block 1614 in direction 1822. Conversely, rotation of the drive pulley 1804 in an opposite direction causes rotation of the pinions 1812 in direction 1821 and shifting of the wedge block 1614 in direction 1824.

In one embodiment, the fastener applicator 1300 has a controller 1830 (see FIG. 56) that controls operation of the actuators 1320, 1322, 1324, 1326 and receives data from the sensor 1610. The controller 1830 is also operatively connected to the motor 1802 to adjust the height of the heads 1304-1310. The controller 1830 includes a non-transitory computer readable medium, such as RAM, ROM, etc. to store computer-readable instructions and a processor, such as one or more microprocessors, to execute the instructions stored in the memory and control operation of the fastener applicator 1300. The fastener applicator 1300 further includes a user interface 1832, such as a switch, a button, a knob, a keyboard, and/or a touchscreen as some examples, to receive a user input that initiates operation of the fastener applicator 1300.

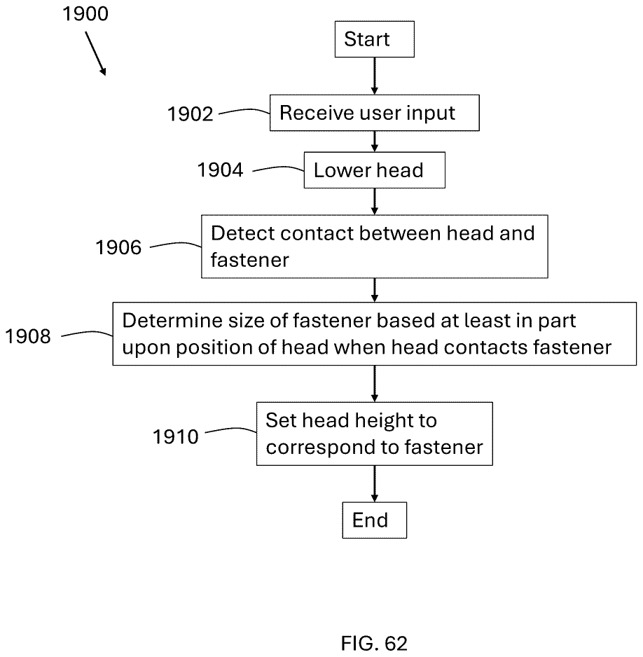

Regarding FIG. 62, in one embodiment, the controller 1830 performs a method 1900 to autonomously set up or configure the fastener applicator 1300 to utilize the fasteners that have been loaded into the fastener applicator 1300. Specifically, the controller 1830 may utilize the method 1900 to autonomously adjust a height of the head 1304 to accommodate taller or shorter fasteners that are used with thicker or thinner conveyor belts.

Regarding FIG. 62, the method 1900 includes step 1902 wherein the fastener applicator 1300 receives a user input at the user interface 1832 to initiate the method 1900. The user interface 1832 may be a start button, for example, of the fastener applicator 1300. The user input received at step 1902 indicates that the user has loaded one or more fasteners into the fastener applicator 1300, has positioned a conveyor belt end between the upper and lower plates of the fasteners, and secured the conveyor belt end to the table 1340 via clamps 1342, 1344.

Next, the controller 1830 at step 1904 pivots the head 1304 forward into position above the fasteners loaded in the fastener nest 1612 and lowers the head in direction 1605 (see FIG. 56) to move the plungers 1606 toward the fasteners in the fastener nest 1612.

At step 1906, the controller 1830 detects a contact between the head 1304 and one or more of the fasteners in the fastener nest 1612. The controller 1830 may detect the contact by way of the sensor 1610 detecting the one or more of the plungers 1606 shifting upwardly in response to the plunger 1606 contacting the upper plate of a fastener.

In another approach, the step 1906 involves the controller 1830 monitoring the force exerted by one or more of the actuators 1320-1326 as the actuators 1320-1326 move the heads 1304-1310 downward in direction 1605. The controller 1830 determines one or more of the heads 1304-1310 have contacted the fasteners in response to the force exerted by the corresponding one or more the actuators 1320-1326 suddenly increasing beyond a threshold value.

At step 1908, the controller 1830 determines a size of the fastener that was loaded in the fastener nest based at least in part upon a position of the head 1304 when the head 1304 contacted the fastener(s). For example, the controller 1830 may utilize a lookup table or other data structure to associate a position of the head 1304 upon contacting the fastener with a particular sized fastener. For example, for shorter fasteners used with thinner belts, the head 1304 will have a lower vertical position than for taller fasteners used with thicker belts.

At step 1910, the controller 1830 adjusts the height of the head 1304 to correspond to the size of the fasteners received in the fastener nest 1612. The controller 1830 operates the motor 1802 to cause movement of the wedge block 1614 in direction 1822 or 1824 as discussed above.

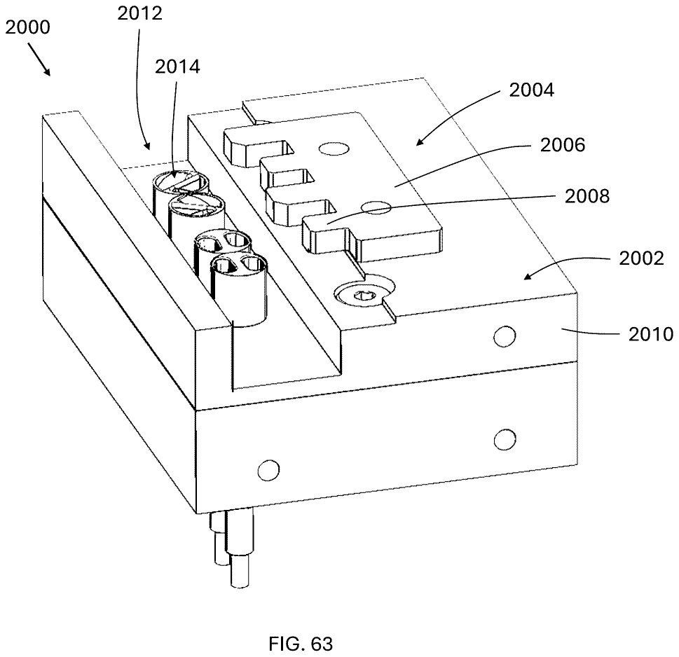

Regarding FIG. 63, a portion of a fastener applicator 2000 is provided that includes an anvil bed assembly 2002 and a fastener nest 2004. The fastener nest 2004 includes a comb 2006 with teeth 2008 that extend between loop portions of fasteners received in the anvil bed assembly 2002.

The anvil bed assembly 2002 includes an upper portion 2010 with anvils 2012 rotatably received therein. The anvils 2012 support lower plates of fasteners positioned in the anvil bed assembly 2002. The anvils 2012 have grooves 2014 that receive staple legs driven through a conveyor belt and into apertures of the fastener lower plates supported on the anvils 2012.

Once the staple legs have been advanced into the grooves 2014, the anvils 2012 are turned to perform a final bend operation on the staple legs.

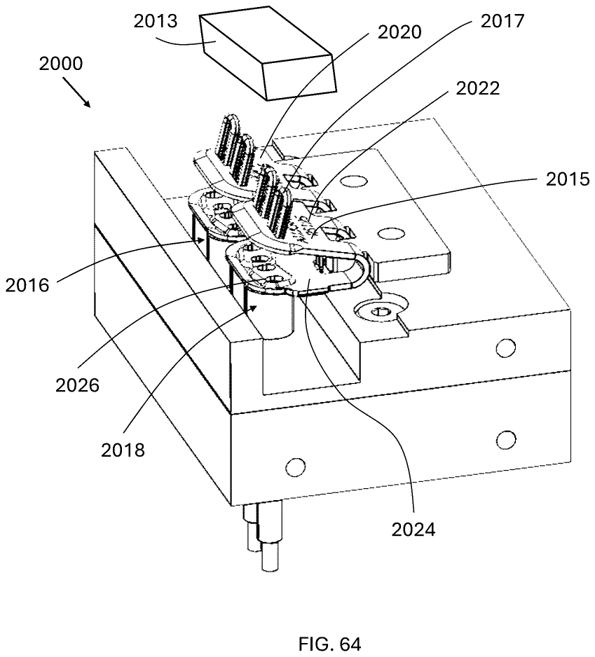

Regarding FIG. 64, the fastener applicator 2000 includes a head 2013 that is operable to clench upper plates 2015 of the fasteners 2020, 2022 onto the conveyor belt and drive staples 2017 of the fasteners 2020, 2022, through the apertures 2026 and into the grooves 2014 of the anvils 2016, 2018. The anvils 2012 include a first pair of anvils 2016 and a second pair of anvils 2018. The anvils 2016, 2018 have different groove configurations and are operated differently to bend staple legs.

Fasteners 2020, 2022 are shown in the anvil bed assembly 2002 with lower plates 2024 of the fasteners 2020, 2022 supported on the anvils 2016, 2018. As shown in FIG. 64, the lower plates 2024 of the fasteners 2020, 2022 have apertures 2026 that are positioned above the grooves of the anvils 2016, 2018.

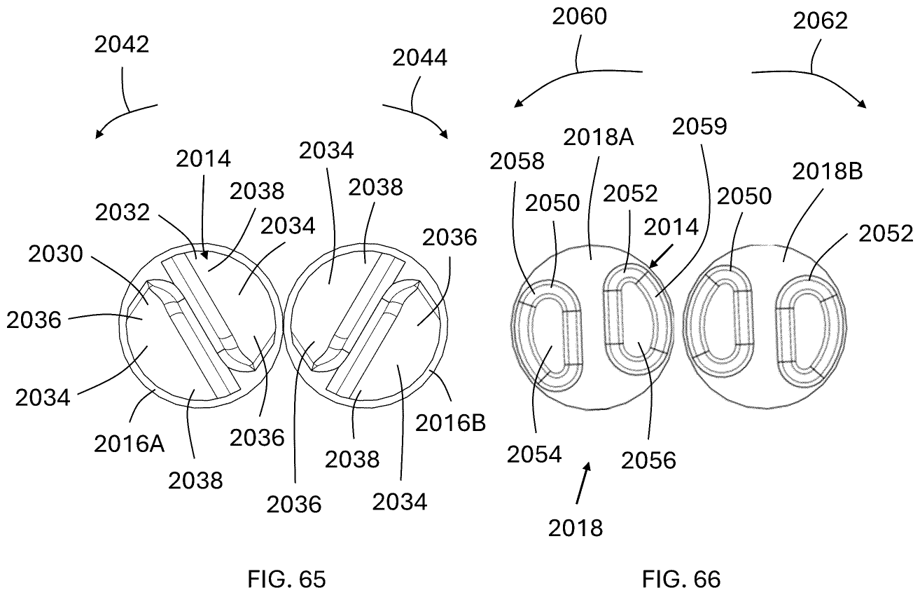

Regarding FIG. 65, the grooves of the anvils 2016 include grooves 2030, 2032 each having an inclined surface 2034 with a higher portion 2036 and a lower portion 2038. The leading ends of the legs of the staples 2017 are each driven into contact with the higher portion 2036 of the inclined surface 2034 one of the grooves 2030, 2032 and is redirected by the inclined surface 2034 toward the lower portion 2038 thereof which initially bends the staple leg. The anvils 2016A, 2016B are subsequently turned in directions 2042, 2044 to perform a final bending of the staple legs. The anvils 2016 perform a final bending of the staple legs via the leading ends of the staple legs being cammed upwardly (out of the page in FIG. 65) as the leading end travels from the lower portion 2038 toward the higher portion 2036 of the inclined surface 2034 due to the turning of the anvils 2016.

The anvils 2018 include grooves 2050, 2052. The grooves 2050, 2052 have a floor surface 2054, 2056 and a tapered side surface 2058, 2059 extending upward from the floor surface 2054, 2056. The grooves 2050, 2052 are configured to not bend the staple legs when the staple legs are advanced into the grooves 2050, 2052. Instead, the tapered side surfaces 2058, 2059 are configured to cammingly engage and bend the staple legs received in the grooves 2050, 2052 in response to turning of the anvils 2018A, 2018B in respective directions 2060, 2062 after the staple legs have been advanced into the grooves 2050, 2052.

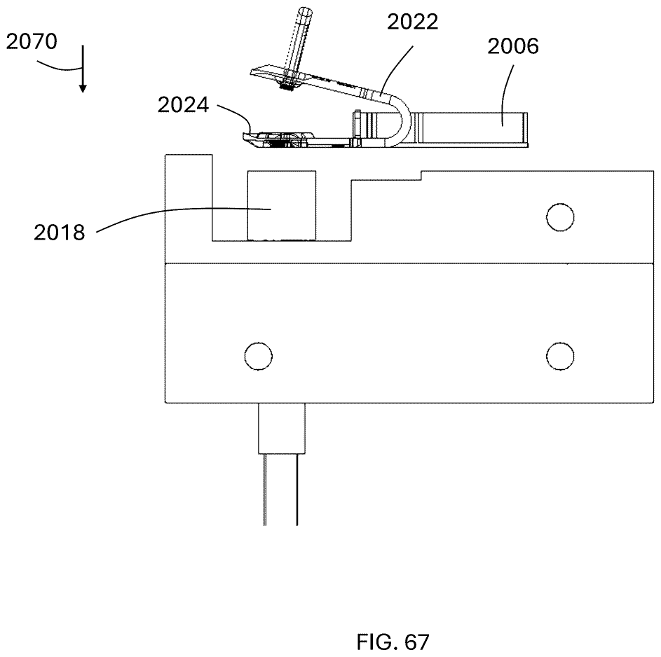

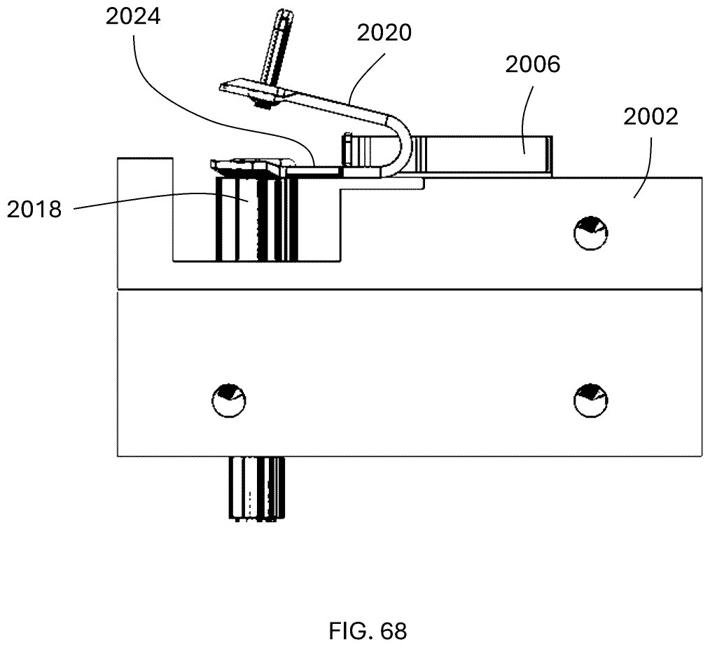

Regarding FIGS. 67 and 68, the user loads the fasteners 2020, 2022 onto the comb 2006 and the comb is lowered in direction 2070 to position the lower plates 2024 of the fasteners 2020, 2022 on the anvils 2016, 2018. In this manner, the anvils 2016, 2018 support the lower plates 2024 during the fastener clenching, staple driving, and staple bending operations.

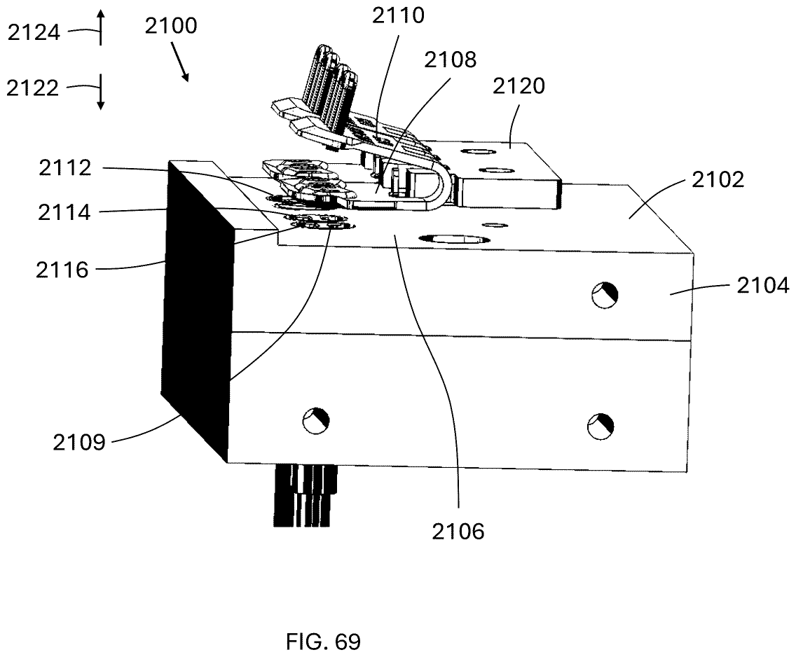

Regarding FIG. 69, a portion of a fastener applicator 2100 is provided that is similar in many respects to the fastener applicator 2000 discussed above. The fastener applicator 2100 includes an anvil bed assembly 2102 having an upper portion 2104 with an upper surface 2106 to support lower plates 2108 of fasteners 2110. The upper portion 2104 has openings 2109 that receive the pairs of rotatable anvils 2112 and 2114. In this manner, the anvils 2112, 2114 have upper ends 2116 that are flush with the upper surface 2106 of the upper portion 2104. In this manner, the anvils 2112, 2114 and the upper portion 2104 of the anvil bed assembly 2102 support the lower plates 2108 of the fasteners 2110 during the fastener clenching, staple driving, and staple bending operations. The fastener applicator 2100 further includes a comb 2120 that is movable in directions 2122, 2124 to facilitate movement of the fasteners 2110 relative to the anvil bed assembly 2102.

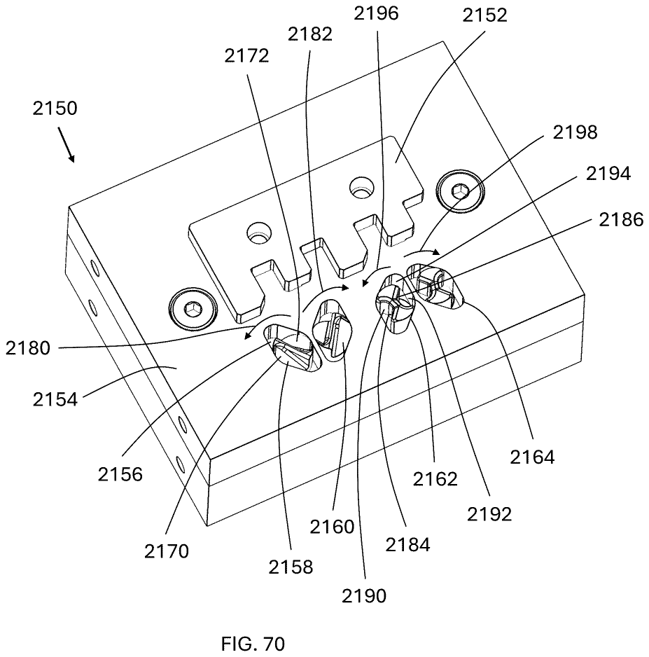

Regarding FIG. 70, a portion of a fastener applicator 2150 is provided that is similar in many respects to the fastener applicators discussed above. The fastener applicator 2150 includes a comb 2152 to retain fasteners and an anvil bed assembly 2154 having openings 2156 with anvils 2158, 2160, 2162, 2164 that are rotatably received therein. The anvils 2158, 2160 each have inclined surfaces 2170, 2172 that are contacted by the staple legs as the staple legs are driven through the apertures of the lower plate of the fastener to perform an initial bend of the staple legs. Next, the anvils 2158, 2160 are turned in directions 2180, 2182 to perform a final bending of the staple legs.

The anvils 2162, 2164 have tapered surfaces 2184, 2186 that cooperate with side walls 2194 of the anvil bed assembly 2154 to form openings 2190, 2192 that receive the staple legs. Once the staple legs have been driven into the openings 2190, 2192, the anvils 2162, 2164 are turned in directions 2196, 2198 to perform a final bending of the staple legs.

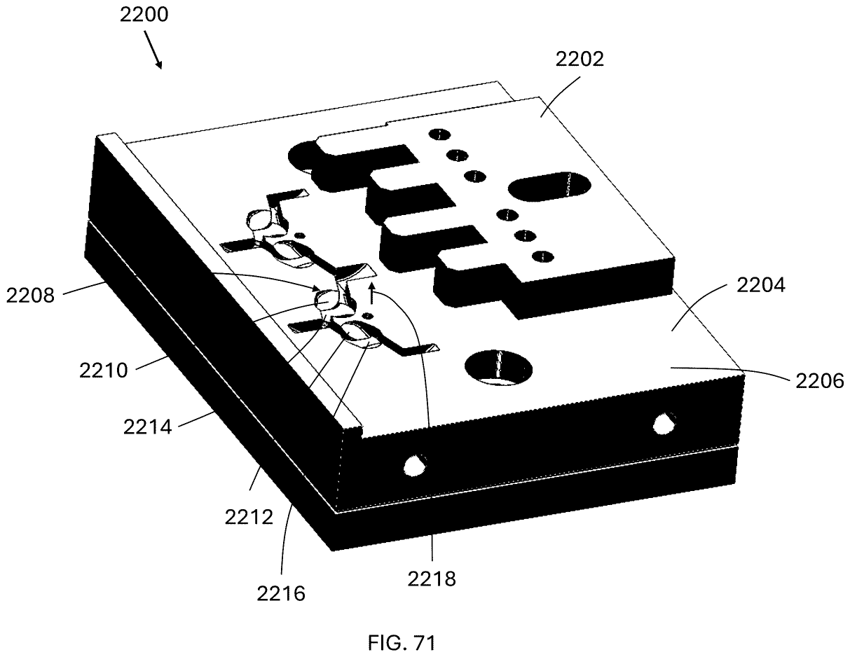

Regarding FIG. 71, a portion of another fastener applicator 2200 is provided. The fastener applicator 2200 that is similar to the fastener applicators discussed above. The fastener applicator 2200 includes a comb 2202 to locate fasteners in the fastener applicator 2200 and an anvil bed assembly 2204. The anvil bed assembly 2204 has an upper portion 2206 with grooves 2208 to receive staple legs and tapered surfaces 2210, 2212, 2216, 2019 that perform an initial bend of the staple legs as the staple legs are driven into the grooves 2208 during a fastener securing operation. Once the staples have been fully driven, the anvil bed assembly 2204 has plungers 2214 that are driven upwardly in direction 2218 to perform a final bending of the staple legs.

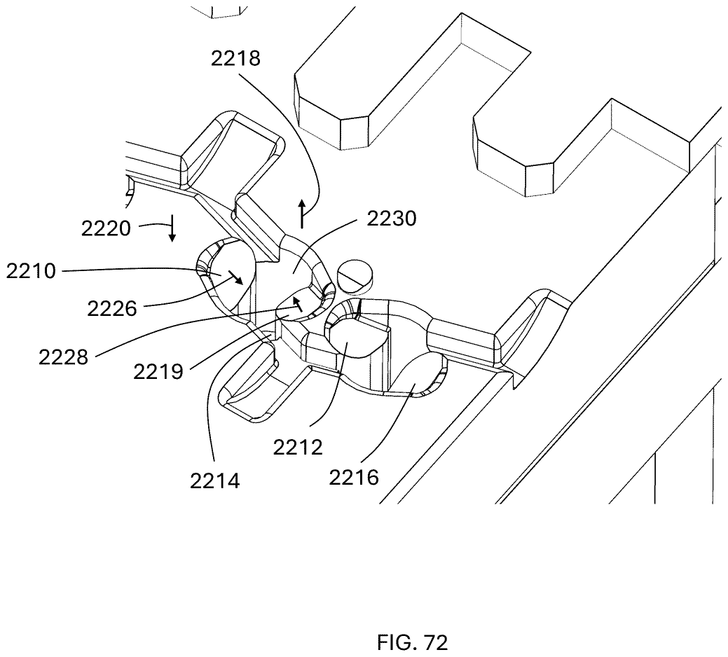

Regarding FIG. 72, the head of the fastener applicator 2200 drives the staple legs of one of the staples downward in direction 2220 and the tapered surfaces 2210 2219 redirect the staple legs in directions 2226, 2228 so that end portions of the staple legs extend in an opening 2230 above the final set plunger 2214. Once the staple legs have been fully driven, the fastener plunger 2214 is driven upwardly in direction 2218 to perform the final set or bend of the staple leg. The other leg of the staple is likewise initially bent by surfaces 2212, 2216 and finally bent by a plunger 2214 that shifts upwardly in direction 2218 between the surfaces 2212, 2216.

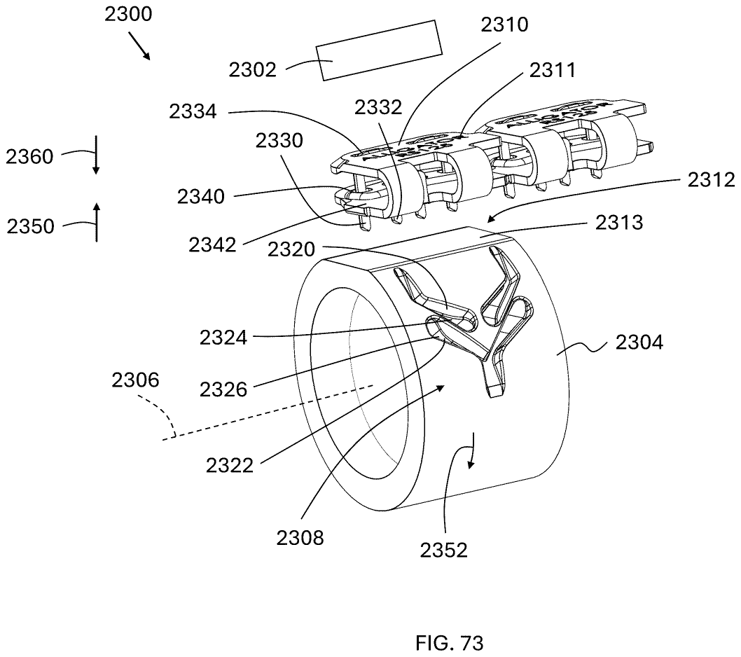

Regarding FIG. 73, portions of a fastener applicator 2300 are shown. The fastener applicator 2300 is similar to the fastener applicators discussed above and includes a head 2302 and an anvil 2304. The anvil 2304 is rotatable about a central axis 2306 to position either an initial bend portion 2308 of the anvil 2304 below the fastener 2310 or a final set portion 2312 below the fastener 2310. More specifically, the initial bend portion 2308 includes pairs of grooves 2320, 2322 having tapered surfaces 2324, 2326 that bend the legs 2330, 2332 of a staple 2334. More specifically, the anvil 2304 is turned to position the initial set portion 2308 below the fastener 2310 when the head 2302 is operated to clench an upper plate 2311 of the fastener 2310 onto a conveyor belt end, drive the staple legs 2330, 2332 through the conveyor belt end, and advance the staple legs 2330, 2332 through apertures 2340 of a lower plate 2342 of the fastener 2310. The staple legs 2330, 2332 emerge from the apertures 2340 of the lower plate 2342, enter the grooves 2320, 2322, and are initially bent by the tapered surfaces 2324 and 2326.

Next, the fastener applicator 2300 lifts the head 2302 and fastener 2310 in direction 2350 and turns the anvil 2304 in direction 2352 about the axis 2306 to position the final set portion 2312 below the fastener 2310 as shown in FIG. 73. The fastener 2310 is then positioned onto a flat surface 2313 of the anvil 2304 and the head 2302 is shifted downward in direction 2360 to perform a final bend of the staple legs 2330, 2332.

Regarding FIG. 74, a fastener applicator 2400 is shown that is similar in many respects to the fastener applicators discussed above. The fastener applicator 2400 includes a head 2402 with a fastener nest 2404 and a staple pusher 2406. The fastener nest 2404 has a lip 2408 that fits under an upper plate 2410 of fasteners 2412 to retain the fasteners 2412 in the fastener nest 2404.

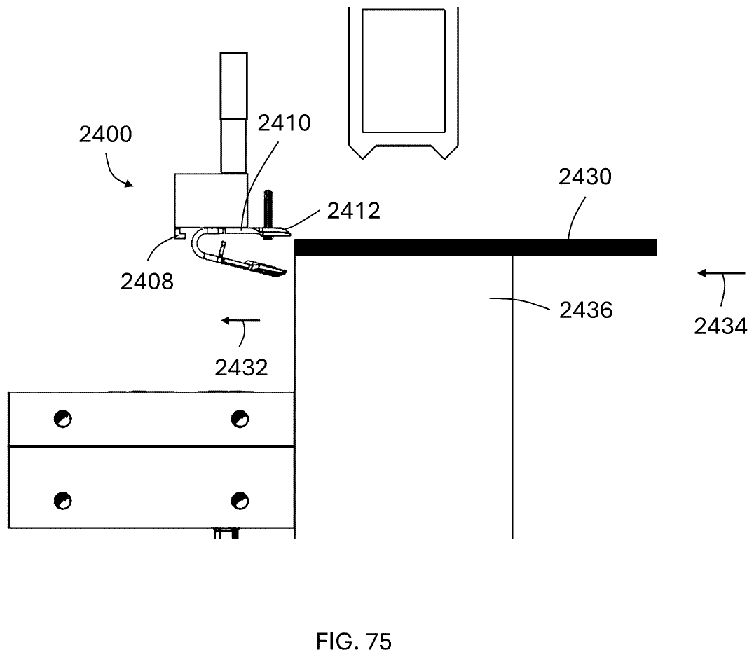

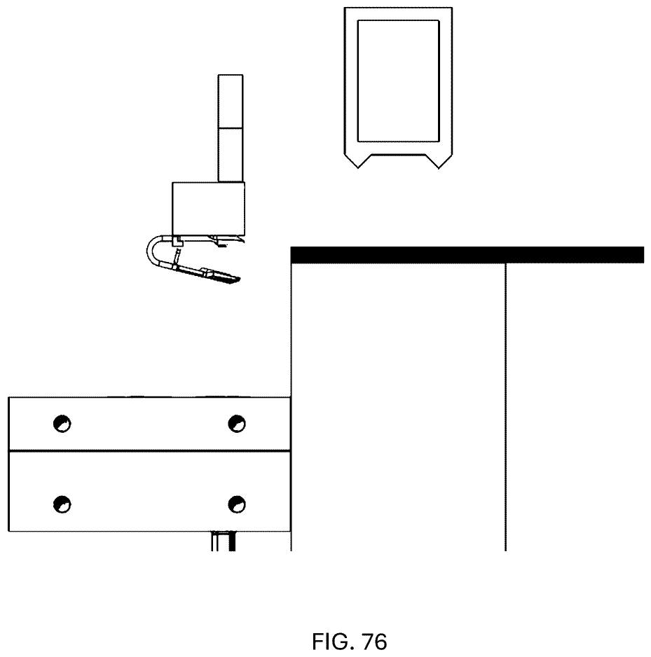

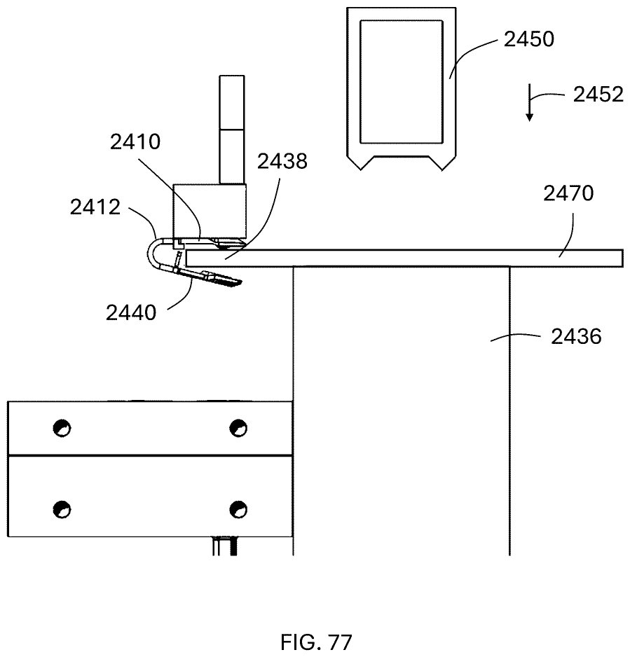

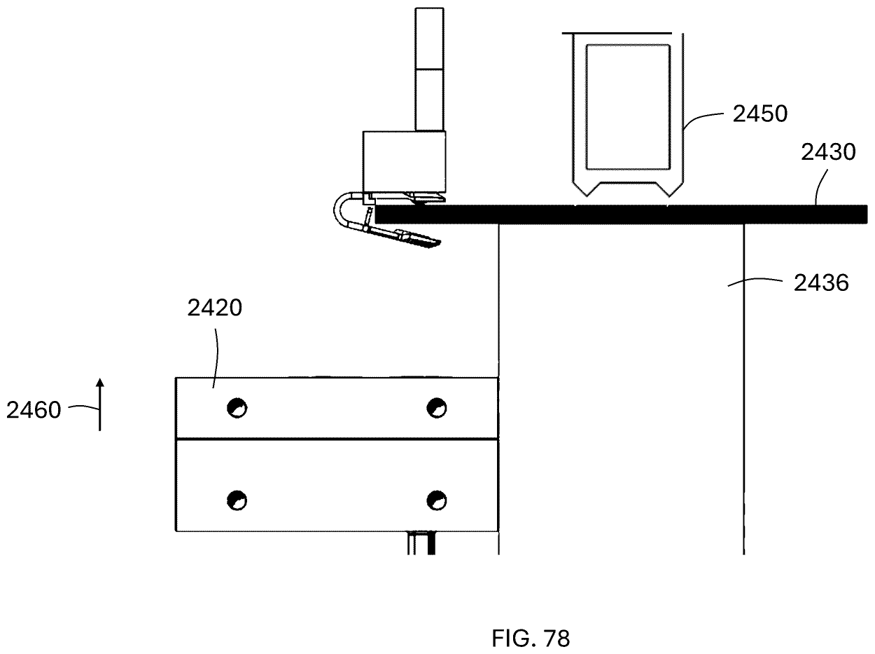

The fastener applicator 2400 further includes an anvil bed assembly 2420 having anvils 2422, 2424, 2426, 2428 rotatably received in an opening 2439 of the anvil bed assembly 2420. Regarding FIGS. 75-82, the method of securing the fasteners 2412 to a conveyor belt end 2430 is shown. Regarding FIGS. 75 and 76, the fastener 2412 is loaded into the fastener nest 2404 by shifting the upper plate 2410 thereof in direction 2432 into engagement with the lip 2408. The conveyor belt end 2430 is shifted in direction 2434 along a belt support 2436 to position a portion 2438 (see FIG. 77) of the conveyor belt end 2430 between the upper plate 2410 and a lower plate 2440 of the fastener 2412. Regarding FIGS. 77 and 78, the fastener applicator 2400 includes a clamp member 2450 that is lowered in direction 2452 to secure the conveyor belt end 2430 between the clamp member 2450 and a belt support 2436.

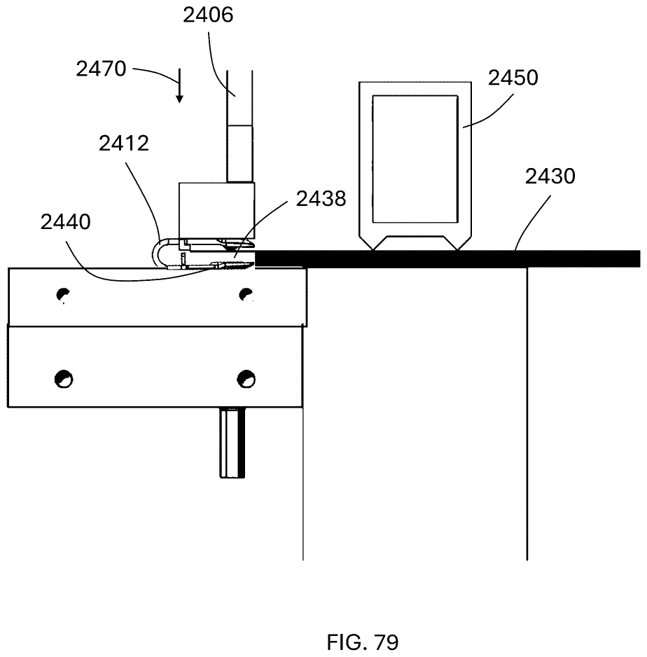

Regarding FIGS. 78-79, the anvil bed assembly 2420 is shifted upwardly in direction 2460 causing the anvil bed assembly 2420 to clench the lower plate 2440 of the fastener 2412 onto the conveyor belt end portion 2438.

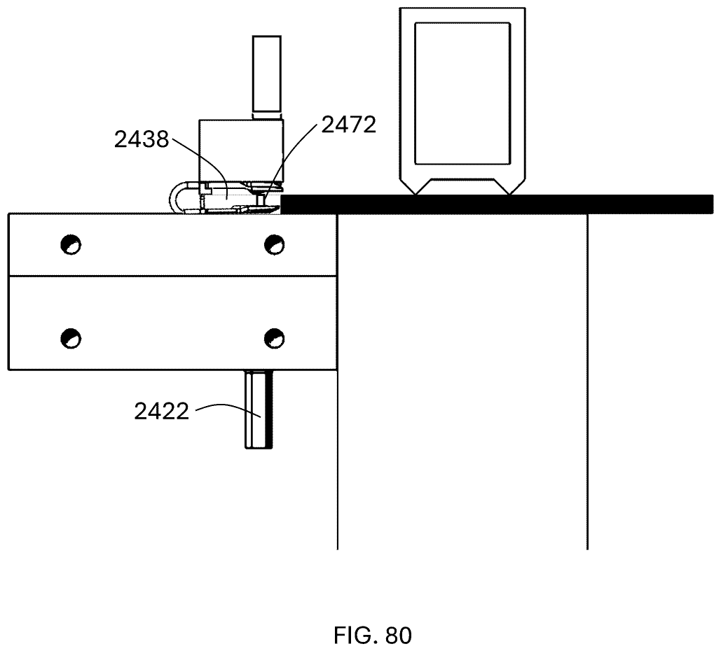

Regarding FIGS. 79-80, the staple pusher 2406 is shifted downwardly in direction 2470 to drive the staple legs 2472 through the conveyor belt end portion 2438 and into grooves 2474, 2476 (see FIG. 74) of the anvils 2422, 2424. The anvils 2422, 2424 have tapered surfaces 2479 that initially bend the staple legs 2472 as the staple legs 2472 are driven into the grooves 2474, 2476.

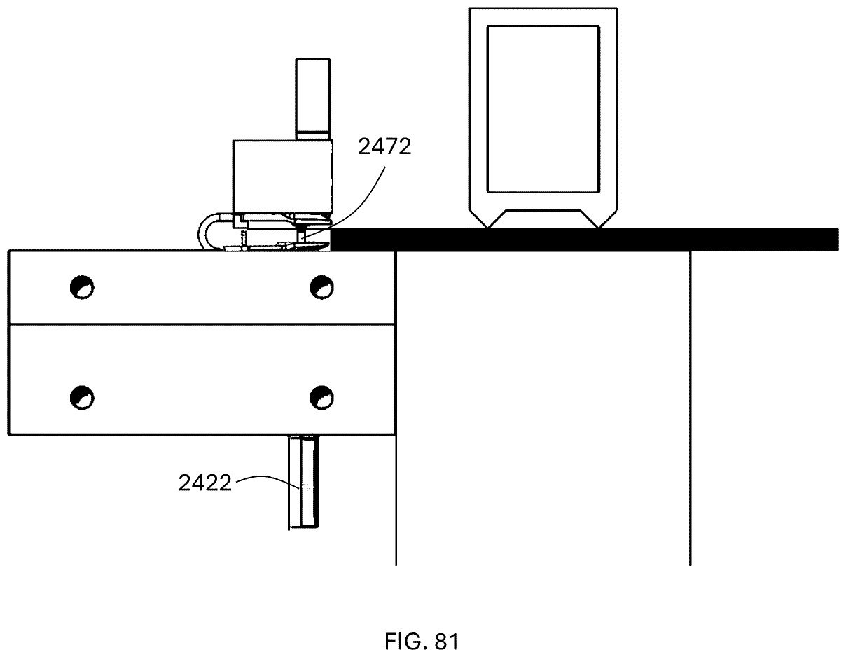

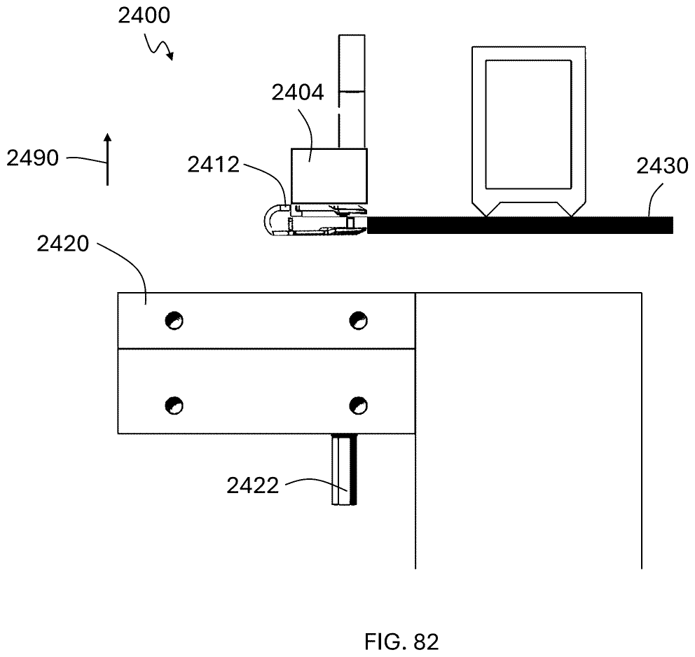

Regarding FIGS. 81 and 82, the anvils 2422, 2424 are then turned in directions 2480, 2482 (see FIG. 74) to perform a final bend of the staple legs 2472. The anvils 2426, 2428 may have grooves and surfaces that resemble anvils 2018, except that the grooves 2427 (see FIG. 74) are open on their sides.

Regarding FIG. 82, once the fastener 2412 has been secured to the conveyor belt end 2430, the fastener nest 2404 is shifted upward in direction 2490 with the conveyor belt end 2430 to position the fastener 2412 and conveyor belt end 2430 in clearance with the anvil bed assembly 2420. Next, the upper plate 2410 of the fastener 2412 is disengaged from the lip 2408 of the fastener nest 2404. The conveyor belt end 2430 and fastener 2412 secured thereto may be then be removed from the fastener applicator 2400.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims. For example, while the fastener applicator 10 of FIG. 1A is shown being operated by linear actuators 52, 54, 56, 58, the fastener applicator 10 may instead be operated via one or more levers and/or cam members that are driven by the user moving one or more handles of the fastener applicator 10. As another example, the fastener applicators disclosed herein may be used with conveyor belt fasteners having attachment members besides staples, such as rivets or bolts.

1. An applicator for securing fasteners to a conveyor belt, the applicator comprising:
a fastener nest to receive a fastener and a conveyor belt disposed between upper and lower plates of the fastener;
a head configured to be operable to move the fastener upper plate toward the conveyor belt and drive legs of a staple of the fastener downwardly through apertures of the fastener upper plate, through the conveyor belt, through apertures of the fastener lower plate, and downwardly from the apertures of the fastener lower plate;
a rotatable anvil including an initial bend portion and a final bend portion, the rotatable anvil having a first rotary position wherein the initial bend portion of the anvil is positioned below the lower plate of the fastener, the initial bend portion of the anvil configured to partially bend the staple legs as the staple legs are driven downwardly from the apertures of the lower plate of the fastener by the head;
the anvil being rotatable relative to the fastener nest from the first rotary position to a second rotary position wherein the final bend portion of the anvil is positioned below the partially bent staple legs;
the fastener nest and anvil are configured to be movable relative to one another to permit the fastener nest and anvil to move apart and provide clearance for the anvil from the partially bent staple legs and permit the anvil to rotate from the first rotary position to the second rotary position;
the fastener nest and anvil are configured to be movable relative to one another to permit the fastener nest and anvil to move together and position the partially bent staple legs of the fastener on the final bend portion of the anvil; and
the head is configured to be operable to drive the staple legs and press the partially bent staple legs against the final bend portion of the anvil to secure the staple legs to the lower plate of the fastener.

2. The applicator of claim 1 wherein the fastener nest has a lowered position wherein the fastener nest positions the lower plate of the fastener proximate the anvil; and
wherein the fastener nest has a raised position wherein the fastener nest raises the fastener away from the anvil to provide clearance for the anvil to rotate from the first rotary position to the second rotary position.

3. The applicator of claim 1 wherein the anvil includes a first recess associated with the initial bend portion and a second recess associated with the final bend portion; and
wherein the fastener nest includes a locating member configured to engage the first recess with the anvil in the first rotary position and to engage the second recess with the anvil in the second rotary position to align the staple legs of the fastener in the fastener nest with either the initial bend portion or the final bend portion of the anvil.

4. The applicator of claim 1 wherein the head is operable to shift upwardly away from the anvil to permit the anvil and fastener nest to move apart and provide clearance for the anvil from the partially bent staple legs and permit the anvil to rotate from the first rotary position to the second rotary position.

5. The applicator of claim 1 wherein the rotatable anvil is rotatable from the first rotary position to the second rotary position around a vertical axis.

6. The applicator of claim 1 further comprising an anvil bed with the anvil rotatably mounted therein, the anvil bed configured to inhibit fore-and-aft movement of the anvil toward or away from the head during rotation of the anvil from the first rotary position to the second rotary position.

7. The applicator of claim 1 wherein the rotatable anvil has a cylindrical head; and
wherein the initial bend portion and the final bend portion of the anvil are on opposite halves of the cylindrical head.

8. The applicator of claim 1 wherein the rotatable anvil includes a cam path; and
an anvil drive member engaged in the cam path of the anvil, the anvil drive member movable relative to the anvil to cause the anvil to rotate from the first rotary position to the second rotary position.

9. The applicator of claim 8 wherein the anvil is rotatable from the first rotary position to the second rotary position around a vertical axis; and
wherein the anvil drive member is movable up and down along the vertical axis relative to the anvil to cause the anvil to rotate between the first rotary position and the second rotary position.

10. The applicator of claim 1 further comprising an anvil drive member, wherein the anvil and the anvil drive member are configured to have a camming engagement therebetween that permits movement of the anvil drive member to cause rotation of the anvil;
wherein a first movement of the anvil drive member causes rotation of the anvil from the first rotary position to the second rotary position; and
wherein a second movement of the anvil drive member causes rotation of the anvil from the second rotary position to the first rotary position.

11. The applicator of claim 10 wherein the first movement of the anvil drive member comprises a first up-and-down movement of the anvil drive member relative to the anvil along one side of the anvil; and
wherein the second movement of the anvil drive member comprises a second up-and-down movement of the anvil drive member relative to the anvil along another side of the anvil.

12. The applicator of claim 1 wherein the fastener nest includes a fastener nest member to support the lower plate of the fastener and a fastener retainer movable from an open position that permits the lower plate of the fastener to be positioned on the fastener nest member to a closed position wherein the fastener retainer engages the upper plate of the fastener and secures the fastener in the fastener nest.

13. The applicator of claim 12 wherein the fastener nest includes a resilient member configured to bias the fastener retainer toward the closed position and keep the fastener retainer engaged with the upper plate of the fastener.

14. The applicator of claim 12 wherein the fastener retainer is pivotal relative to the fastener nest member and includes a retainer member having stepped surfaces configured to engage differently sized fasteners in the fastener nest.

15. The applicator of claim 1 wherein the head includes:
a plunger configured to engage the upper plate of the fastener and move the upper plate of the fastener toward the conveyor belt;
a staple pusher configured to engage the staple; and
a linear slide connection between the plunger and the staple pusher configured to permit the staple pusher to shift linearly downwardly along the plunger when the plunger is engaged with the upper plate of the fastener and the staple pusher drives the legs of the staple downwardly through the conveyor belt and out of the apertures of the lower plate of the fastener.

16. The applicator of claim 1 wherein the anvil comprises a plurality of anvils.

17. The applicator of claim 16 wherein the anvils are rotatable simultaneously from the first rotary position of the anvils to the second rotary position of the anvils.

18. The applicator of claim 16 further comprising an anvil bed having openings that each receive one of the anvils; and
wherein the anvil bed includes a channel connecting the openings and an air inlet opening on a lateral side of the anvil bed that is in communication with the channel, the air inlet opening permitting air to be directed into the air inlet opening and the channel to remove debris from the openings.

19. The applicator of claim 1 wherein the initial bend portion of the anvil includes grooves configured to bend the staple legs as the staple legs are driven downwardly from the fastener lower plate apertures by the head; and
wherein the final bend portion of the anvil includes a flat surface.

20. The applicator of claim 1 wherein the anvil has an anvil head with a unitary, one piece construction, the anvil head including the initial bend portion and the final bend portion.

21. The applicator of claim 1 further comprising a linkage operatively connected to the head to cause movement of the head in response to movement of the linkage;
a cam drive assembly including an anvil drive member engaged with a cam path of the anvil and configured to cause rotation of the anvil between the first and second rotary positions in response to up-and-down movement of the anvil drive member relative to the anvil;
a lift assembly configured to shift the cam drive assembly up-and-down; and
an actuator operatively connected to the linkage and the lift assembly, the actuator configured to drive the linkage and lift assembly and operate the head and anvil to secure the fastener to the conveyor belt.

22. The applicator of claim 1 wherein the initial bend portion of the anvil comprises grooves configured to bend the staple legs toward one another as the staples are driven downwardly from the apertures of the fastener lower plate by the head.

23. A method of securing a fastener to a conveyor belt using an applicator, the method comprising:
receiving the fastener in a fastener nest of the applicator;
moving, via a head of the applicator, an upper plate of the fastener toward a conveyor belt disposed between the upper plate and a lower plate of the fastener;
driving, via the head of the applicator, legs of a staple of the fastener through apertures of the upper plate of the fastener, through the conveyor belt, through apertures of the lower plate, and against an initial bend portion of an anvil of the applicator positioned below the lower plate of the fastener to partially bend the legs;
moving the fastener nest and anvil relative to one another to provide clearance between the anvil and the partially bent staple legs;
rotating the anvil to position a final bend portion of the anvil below the partially bent staple legs;
moving the fastener nest and anvil relative to one another to position the partially bent staple legs on the final bend portion of the anvil; and
pressing, via the head of the applicator, the partially bent staple legs against the final bend portion of the anvil to secure the staple legs to the lower plate of the fastener.

24. The method of claim 23 wherein moving the upper plate of the fastener toward the conveyor belt comprises engaging a plunger of the head of the applicator with the upper plate of the fastener and moving the plunger toward the conveyor belt.

25. The method of claim 24 wherein driving the legs of the staple include engaging a staple pusher of the head of the applicator with a crown of the staple and shifting the staple pusher relative to the plunger and toward the upper plate.

26. The method of claim 23 wherein driving the legs of the staple against the initial bend portion of the anvil and partially bending the staple legs includes advancing leading end portions of the staple legs against tapered surfaces of grooves of the initial bend portion of the anvil.

27. The method of claim 23 wherein rotating the anvil comprises rotating the anvil around a vertical axis.

28. The method of claim 23 wherein rotating the anvil comprises rotating the anvil 180 degrees.

29. The method of claim 23 further comprising raising the fastener nest and fastener received therein away from the anvil after pressing the partially bent staple legs against the final bend portion of the anvil; and
rotating the anvil to move the final bend portion away from the fastener lower plate and position the initial bend portion below the fastener lower plate.

30. The method of claim 23 wherein pressing the partially bent legs against the final bend portion of the anvil includes driving a crown of the staple with the head of the applicator to urge the partially bent legs of the staple against the final bend portion of the anvil.

31. The method of claim 23 wherein the staple comprises a first staple and a second staple of the fastener and the anvil comprises a first anvil and a second anvil;
wherein driving the legs of the staple comprises driving a first pair of legs of the first staple against the initial bend portion of the first anvil and driving a second pair of legs of the second staple against the initial bend portion of the second anvil;
wherein rotating the anvil comprises rotating the first and second anvils; and
wherein pressing the partially bent legs comprises pressing the first partially bent legs of the first staple against the final bend portion of the first anvil and pressing the second partially bent legs of the second staple against the final bend portion of the second anvil.

32-42. (canceled)
